(19) United States
(12) Patent Application Publication
(10) Pub. No.: US 2024/0182191 A1
(43) Pub. Date: Jun. 6, 2024

(54) DELIVERY DRONE, DELIVERY PORT AND AUTOMATED DELIVERY SYSTEM

(71) Applicant: URBX, Inc., Boston, MA (US)

(72) Inventors: Lincoln Cavalieri, Lynnfield, MA (US); Adam Looker, London (CA); Paul Sandin, Nashua, NH (US)

(21) Appl. No.: 18/553,327

(22) PCT Filed: Apr. 1, 2022
(86) PCT No.: PCT/US2022/023073

§ 371 Date: Sep. 29, 2023

Related U.S. Application Data
(60) Provisional application No. 63/169,860, filed on Apr. 1, 2021.

(51) Int. Cl. B64U 10/14; B64U 20/87; B64U 30/299; B64U 50/19; B64U 70/99; B64U 80/25; B64U 80/40; B64U 101/64

(52) U.S. Cl. CPC B64U 10/14; B64U 20/87; B64U 30/299; B64U 50/19; B64U 70/99; B64U 80/25; B64U 80/40; B64U 2101/64

(57) ABSTRACT

A delivery drone includes an airframe, a drive module joined to the airframe, a storage module joined the drive module and a plurality of motors joined to the airframe. The storage module includes a housing defining an internal cavity in which a parcel may be situated. The delivery drone is selectively navigable between and dockable with a logistics tower and a drone port mounted to a residential or commercial structure. A drone loader is situated in a secondary vertical shaft of the logistics tower and includes a plurality of drone docks, each drone dock being engageable with a delivery drone. The logistics tower includes a plurality of tower drone ports through which the delivery drones traverse to access the elevator shafts and the secondary vertical shafts of the logistics tower.

### CROSS-REFERENCE TO RELATED APPLICATIONS

This application is related to U.S. Provisional Patent Application Ser. No. 63/169,860, filed on Apr. 1, 2021, and titled “Delivery Drone, Drone Port And Automated Delivery System”, the disclosure of which is hereby incorporated by reference and on which priority is hereby claimed.

This application is related to U.S. Provisional Application Ser. No. 62/831,448, filed on Apr. 9, 2019 and titled “Logistics Tower”, U.S. Provisional Application Ser. No. 62/849,703, filed on May 17, 2019 and titled “Logistics Tower”, U.S. Provisional Application Ser. No. 62/865,844, filed on Jun. 24, 2019 and titled “Logistics Tower And Loading System”, and PCT Patent Application Serial No. PCT/US2020/02756, filed on Apr. 9, 2020 and titled “Logistics Tower”, the disclosure of each of which is incorporated herein by reference.

### BACKGROUND OF THE INVENTION

### Field of the Invention

The present invention generally relates to parcel delivery and storage systems, and more particularly relates to autonomous and semi-autonomous drone parcel delivery and storage systems. Even more specifically, the present invention relates to delivery drones and automated delivery systems that are particularly adapted to transport goods to and from logistic storage units.

### Description of the Prior Art

As cities and metro areas are becoming more populated, the need for last mile logistics services is becoming even more necessary. One of the main challenges is fitting enough items in a tightly confined area. With these footprint constraints, an innovative solution is necessary. The logistics tower is an essential piece in providing enough stock-keeping units (SKUs) in the smallest amount of space, with the average tower being around 900 square feet and 100 feet tall.

Some storage units utilize elevator systems that slide back and forth on a track, retrieving bins from two sides. The setback with this approach is the stability of the storage unit beyond certain heights. More specially, elevators that slide back and forth on a track in a horizontal plane to retrieve bins sway or could cause the storage unit to sway and become unstable. To limit the swaying effect, the velocity at which the elevators travel is substantially limited (e.g., slow) when operating above certain heights. Accordingly, such storage units can be slow and unstable.

Some storage units utilize single bot bin retrieval systems using rack and pinion through multiple columns. The setback with this approach is that the time to retrieve bins significantly increases as the bin leaves the column with the bin thus slowing the retrieval of another bin in the column. Energy consumed by a single bot to traverse high heights makes single bot applications unsustainable. Having a dedicated elevator allows for continuous power to the winch system. It also allows for the elevator to be optimized for high speed vertical travel, reaching rapid speeds at high heights. Optimization of both the elevator and shuttle systems for max speed on their respective Z and Y plans yields extraordinarily bin to pick station times. In markets like grocery, fast bin retrieval time is critical.

Loading and unloading storage units often is time consuming. Truck deliveries to stores and storage units happen on a daily basis to restock items that are low and need to be replenished. One of the main challenges is having a large enough space to unload the items that need restocking in dense urban areas. There is also a human cost of moving hundreds of boxes over a sustained period of time both physically and economically. There have been some solutions to address this burden, notably the dolly and ramp system, which are common on many trucks, but is still time consuming, costly and strenuous on the person unloading the goods. With this understanding, an innovative solution is necessary to streamline the loading and unloading process.

Furthermore, entertainment, goods and services are now purchasable on-demand with a click of a button. As a result, consumers have come to expect the goods they purchase online to arrive faster than ever. Certain merchants have normalized the idea of two-day delivery and, as a result, consumers are now conditioned to expect that two-day delivery, as well as overnight and same day delivery will be available for most, if not all purchases, they make online. Delivery speed has become the ultimate arbiter of e-commerce success. However, small businesses often lack to ability to provide cost effective expedited shipping as access to intricate fulfillment centers and courier systems are limited.

Consumers also often demand to know the exact location of their parcel in transit. For example, if perishable goods are being delivered, consumers must coordinate their schedule with the estimated time of delivery so that they can take possession of the goods before they spoil. Additionally, expensive goods, such as electronics and jewelry, are often delivered and left out in front of a residence making them susceptible to theft if not promptly taken into possession by the paying consumer. However, small businesses often lack the ability to provide accurate and detailed product tracking.

Accordingly, to compete with larger merchants, small businesses often find it necessary to contract with fulfillment vendors to expedite and track the delivery of purchased goods to consumers, which often comes at great cost. Even order fulfillment vendors experience high costs when processing and undertaking expedited shipping orders, some of which can be attributed to the substantial amount of human interaction necessary to process, package and deliver same day orders. The high cost of expedited shipping is also, at least in part, passed on to the consumer.

Accordingly, there is a need for parcel storage and loading systems that are fast and stable, while maximizing storage capacity. There is also a need to provide cost efficient, secure and reliable expedited delivery services of ordered items.

### OBJECTS AND SUMMARY OF THE INVENTION

It is an object of the present invention to provide a delivery drone for transporting goods between locations.

In accordance with one form of the present invention, a delivery drone includes an airframe, a drive module joined to the airframe and at least one storage module joined to one of the airframe and the drive module. The storage module includes a housing defining an internal cavity in which a parcel may be situated and a drawer that is received within the internal cavity and is extendible and removable therefrom. At least one motor having a rotor operatively coupled thereto is joined to the airframe, the at least one motor being controllable by drive circuitry and a computer. The airframe includes an outer frame, a central hub and a plurality of support arms extending outwardly from the central hub to the outer frame. A rotor guard that covers and protects the rotor is formed on a top side of the airframe. A docking hub having a camera array is situated on the central hub and is engageable with a retention device situated on a drone dock.

It is another object of the present invention to provide a drone port that is mounted to a residential or commercial structure and that is accessible by a delivery drone.

In accordance with one form of the present invention, a drone port includes a drone docking platform, a delivery compartment and a deliver shaft interconnected therebetween. The delivery shaft is generally hollow and includes a parcel lift system situated therein. The parcel lift system includes a parcel retrieval platform and an actuator operatively coupled thereto that effects movement of the parcel retrieval platform in the internal cavity of the delivery shaft between the docking platform and the delivery compartment. The drone docking platform includes a top section and a bottom section that are separated from one another and define a space therebetween into which a delivery drone may travel and dock.

It is still another object of the present invention to provide a tower drone port that facilitates entry of one or more delivery drones into a logistics tower.

In accordance with one form of the present invention, a tower drone port includes a funnel shaped main body and a tower drone port support joined thereto. The tower drone port support includes a shaft that is in alignment with an elevator shaft in the logistics tower such that the shaft of the tower drone port support is traversable by a robotic bin handler situated in the elevator shaft.

It is a further object of the present invention to provide a delivery drone loader that facilities the loading of delivery drones into a logistics tower.

In accordance with one form of the present invention, a delivery drone loader includes a loading belt operatively coupled to a motorized drum and a pulley. A plurality of drone dock ports are pivotally coupled to the loading belt. The drone dock includes a magnetic retention device that is engageable with the docking magnet of a delivery drone. The drone dock also includes a charge connector that is in electrical communication with a charging connector situated on the delivery drone when the delivery drone is engaged with the drone dock port.

It is yet a further object of the present invention to provide a logistics tower that is accessible by a delivery drone.

In accordance with one form of the present invention, a logistics tower includes at least one vertical storage cell column and at least one vertical retrieval system. The vertical storage cell column comprises a plurality of storage cells and storage cell modules containing storage bins. The vertical retrieval system includes a winch and a robotic bin handler that selectively traverses the vertical storage cell column and selectively loads and unloads storage bins therefrom. The vertical retrieval system retrieves and delivers storage bins from a horizontal shuttle system that comprises a rail system and one or more robotic flatbed shuttles. The flatbed shuttles transport storage bins to one or more delivery points. The logistics tower includes a drone tower port mounted thereto that facilitates the entry of one or more delivery drones into the logistics tower.

It is still a further object of the present invention to provide a delivery drone system for transporting goods between locations.

In accordance with one form of the present invention, a delivery drone system includes a delivery drone, a drone port mounted to a residential or commercial structure and a logistics tower. The delivery drone is navigable between and dockable with the at least one drone port and the at least one logistics tower, and transports goods to and from the logistics tower and the at least one drone port.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a top, front perspective view of a logistics tower formed in accordance with the present invention, with a cutaway section showing the vertical storage cell columns situated therein.

FIG. 2 is a front perspective view of the logistics tower formed in accordance with the present invention, showing the storage modules and the storage cells of a vertical storage cell column.

FIG. 3 is a right perspective view of the logistics tower formed in accordance with the present invention, showing the storage modules and the storage cells of a vertical storage cell column.

FIG. 4 is a top, right perspective view of the logistics tower formed in accordance with the present invention, with a cutaway section showing a vertical storage cell column situated therein and a robotic bin handler.

FIGS. 5A-5D and 5E are a sequence of top, front perspective views and a bottom, front perspective view, respectively, of a storage bin being retrieved from a vertical storage cell column by a robotic bin handler.

FIG. 6 is a cutaway, front elevational view of the logistics tower formed in accordance with the present invention.

FIG. 7 is an enlarged cutaway, front elevational view of the logistics tower formed in accordance with the present invention.

FIG. 8 is a cutaway, front perspective view of the logistics tower formed in accordance with the present invention.

FIG. 9 is a cutaway, top plan view of the logistics tower formed in accordance with the present invention, showing the arrangement of a plurality of vertical storage cell columns therein.

FIG. 10 is another enlarged cutaway, front perspective view of the logistics tower formed in accordance with the present invention, showing the winches of the vertical retrieval system.

FIG. 11 is an enlarged cutaway, top plan view of the logistics tower formed in accordance with the present invention, showing the winches of the vertical retrieval system.

FIG. 12 is another cutaway, top plan view of the logistics tower formed in accordance with the present invention, showing the winches of the vertical retrieval system.

FIG. 13 is a front perspective view of the robotic bin handler of the logistics tower formed in accordance with the present invention.

FIG. 14 is a front elevational view of the robotic bin handler of the logistics tower formed in accordance with the present invention.

FIG. 15 is an enlarged, front elevational view of the robotic bin handler of the logistics tower formed in accordance with the present invention.

FIG. 16 is an enlarged, front perspective view of the robotic bin handler of the logistics tower formed in accordance with the present invention, showing the rail slide thereof.

FIG. 17 is another enlarged, front perspective view of the robotic bin handler of the logistics tower formed in accordance with the present invention, showing the rail slide thereof.

FIG. 18 is an enlarged, front perspective view of the robotic bin handler of the logistics tower formed in accordance with the present invention, showing the rail slide engaged with the receptacle in the storage bin.

FIG. 19 is a front perspective view of the robotic bin handler of the logistics tower formed in accordance with the present invention, showing the robotic bin handler placing a storage bin on a robotic flatbed shuttle.

FIG. 20 is a front perspective view of the robotic flatbed shuttle and horizontal shuttle grid of the logistics tower formed in accordance with the present invention.

FIG. 21 is an enlarged, cutaway right perspective view of the logistics tower formed in accordance with the present invention, showing the delivery bay thereof.

FIG. 22 is an enlarged, cutaway right perspective view of the logistics tower formed in accordance with the present invention, showing the parcel transit system thereof.

FIG. 23 is a front perspective view of the logistics tower formed in accordance with the present invention, showing the customer center thereof.

FIG. 24 is an enlarged, front perspective view of the logistics tower formed in accordance with the present invention, showing the customer center thereof.

FIG. 25 is another enlarged, front perspective view of the logistics tower formed in accordance with the present invention, showing the customer center thereof.

FIG. 26 is a front perspective view of the logistics tower formed in accordance with the present invention, with a cutaway section showing the customer center thereof.

FIG. 27 is an enlarged, front perspective view of the interior of the customer center of the logistics tower formed in accordance with the present invention.

FIG. 28 is a right perspective view of the logistics tower formed in accordance with the present invention, showing the parcel transit system thereof.

FIG. 29 is an enlarged, right perspective view of the logistics tower formed in accordance with the present invention, showing the robot pickup area.

FIG. 30 is an enlarged, front perspective view of the logistics tower formed in accordance with the present invention, showing the robot pickup area.

FIG. 31 is a cutaway, rear perspective view of the logistics tower formed in accordance with the present invention.

FIG. 32 is a right, top perspective view of the logistics tower formed in accordance with the present invention.

FIG. 33 is a block diagram of a pickup station of the logistics tower formed in accordance with the present invention.

FIG. 34 is a right, front perspective view, a right, plan view, a front plan view and a top plan view of an exemplary logistics tower formed in accordance with the present invention, showing the relative dimensions thereof.

FIG. 35 is an enlarged, cutaway front perspective view of the logistics tower formed in accordance with the present invention.

FIG. 36 is an enlarged, right perspective view of the logistics tower formed in accordance with the present invention, showing the elevator lift.

FIG. 37 is a front perspective view of the logistics tower formed in accordance with the present invention, showing the vertical storage cell of the vertical storage cell column.

FIG. 38 is a top perspective view of the logistics tower formed in accordance with the present invention, with a cutaway section showing the vertical storage cells of the vertical storage cell column.

FIG. 39 is an enlarged top perspective view of the logistics tower formed in accordance with the present invention, with a cutaway section showing the vertical storage cells of the vertical storage cell column.

FIG. 40 is an enlarged front perspective view of the logistics tower formed in accordance with the present invention, with a cutaway section showing the vertical storage cells of the vertical storage cell column.

FIG. 41 is a side perspective view of the logistics tower formed in accordance with the present invention, with a cutaway section showing the vertical storage cells of the vertical storage cell column.

FIG. 42 is an enlarged top perspective view of the logistics tower formed in accordance with the present invention, with a cutaway section showing the vertical storage cells of the vertical storage cell column.

FIG. 43 is another cutaway, top plan view of the logistics tower formed in accordance with the present invention, showing the arrangement of a plurality of vertical storage cell columns therein.

FIG. 44 is yet another a cutaway, top plan view of the logistics tower formed in accordance with the present invention, showing the arrangement of a plurality of vertical storage cell columns therein.

FIG. 45 is a cutaway, front perspective view of the logistics tower formed in accordance with the present invention, showing the vertical storage cell of the vertical storage cell column.

FIG. 46 is another cutaway, front perspective view of the logistics tower formed in accordance with the present invention, showing the temperature control system thereof.

FIG. 47 is a front perspective view of the cooling column of the temperature control system of the logistics tower formed in accordance with the present invention.

FIG. 48 is a front perspective view of the vertical retrieval system formed in accordance with the present invention.

FIG. 49 is a partial cutaway, front perspective view of the vertical retrieval system formed in accordance with the present invention.

FIG. 50 is a partial cutaway, front perspective view of the vertical retrieval system formed in accordance with the present invention.

FIG. 51 is cutaway, front perspective view of the logistics tower formed in accordance with the present invention, showing the winch being lowered through the elevator shaft.

FIG. 52 is another cutaway, front perspective view of the logistics tower formed in accordance with the present invention, showing the vertical storage cell of the vertical storage cell column.

FIG. 53 is a top perspective view of the carriage assembly of the logistics tower formed accordance with the present invention, showing the carriage assembly in a retracted state.

FIG. 54 is a top perspective view of the carriage assembly of the logistics tower formed accordance with the present invention, showing the carriage assembly in a partially extended state.

FIG. 55 is a top perspective view of the carriage assembly of the logistics tower formed accordance with the present invention, showing the carriage assembly in an extended state.

FIG. 56 is a bottom perspective view of the carriage assembly of the logistics tower formed accordance with the present invention, showing the carriage assembly in an extended state.

FIG. 57 is another cutaway, front perspective view of the logistics tower formed in accordance with the present invention, showing the vertical retrieval system lowering a storage bin through the elevator shaft.

FIG. 58 is a top perspective view of the storage bin of the logistics tower formed in accordance with the present invention.

FIG. 59 is a cutaway, enlarged top perspective view of the logistics tower formed in accordance with the present invention, showing temperature control system.

FIG. 60 is a cutaway, top perspective view of the logistics tower formed in accordance with the present invention, showing temperature control system thereof.

FIG. 61 is top, rear perspective view of the robotic bin handler of the logistics tower formed in accordance with the present invention, showing the carriage assembly in an extended state.

FIG. 62 is bottom, rear perspective view of the robotic bin handler of the logistics tower formed in accordance with the present invention, showing the carriage assembly in a retracted state.

FIG. 63 is a top, rear perspective view of the robotic bin handler of the logistics tower formed in accordance with the present invention, showing the carriage assembly in a partially extended state.

FIG. 64 is a top, rear perspective view of the robotic bin handler of the logistics tower formed in accordance with the present invention, showing the carriage assembly in a retracted state.

FIG. 65 is a front perspective view of the robotic bin handler of the logistics tower formed in accordance with the present invention, showing the carriage assembly in a partially extended state.

FIG. 66 is a cutaway, front perspective view of the logistics tower formed in accordance with the present invention, showing the robotic bin handler coupled to a storage bin.

FIG. 67 is a cutaway, enlarged front perspective view of the logistics tower formed in accordance with the present invention, showing the secondary winch cables.

FIG. 68 is a front perspective view of a passive elevator of logistics tower formed in accordance with the present invention.

FIG. 69 is a front perspective view of an active elevator of logistics tower formed in accordance with the present invention.

FIG. 70 is a top perspective view of an alternative embodiment of the robotic bin handler of the logistics tower formed in accordance with the present invention, showing the rack and pinion gear drive.

FIG. 71 is an enlarged top perspective view of an alternative embodiment of the robotic bin handler of the logistics tower formed in accordance with the present invention, showing the rack and pinion gear drive.

FIG. 72 is a front perspective view of the delivery drone formed in accordance with the present invention.

FIG. 73 is a bottom perspective view of the delivery drone formed in accordance with the present invention, showing the doors of the drawer in an open state.

FIG. 74 is a top plan view of the delivery drone formed in accordance with the present invention.

FIG. 75 is a top perspective view of the delivery drone formed in accordance with the present invention.

FIG. 76 is a bottom perspective view of the delivery drone formed in accordance with the present invention.

FIG. 77 is a top perspective view of the drone port formed in accordance with the present invention, showing the drone port installed in a home.

FIG. 78 is a front perspective view of the drone port formed in accordance with the present invention.

FIG. 79 is a front, cross-sectional perspective view of the drone port formed in accordance with the present invention.

FIG. 80 is an enlarged, front cross-sectional perspective view of the drone docking platform formed in accordance with the present invention, showing the delivery drone situated therein.

FIG. 81 is another enlarged, front cross-sectional perspective view of the drone docking platform formed in accordance with the present invention.

FIG. 82 is another enlarged, front cross-sectional perspective view of the drone docking platform formed in accordance with the present invention.

FIG. 83 is another enlarged, front cross-sectional perspective view of the drone docking platform formed in accordance with the present invention.

FIG. 84 is a front perspective view of the tower drone port formed in accordance with the present invention.

FIG. 85 is a right perspective view of the tower drone port formed in accordance with the present invention.

FIG. 86 is a right perspective view of the tower drone port formed in accordance with the present invention, showing the tower drone port situated on the side of the logistics tower.

FIG. 87 is a bottom perspective view of the tower drone port formed in accordance with the present invention, showing the tower drone port situated on the top of the logistics tower.

FIG. 88 is a right, cutaway perspective view of the tower drone port formed in accordance with the present invention, showing the tower drone port situated on the top of the logistics tower.

FIG. 89 is a cutaway, right elevational view of the tower drone port formed in accordance with the present invention, showing the tower drone port situated on the top of the logistics tower.

FIG. 90 is an enlarged, front perspective view of the tower drone port formed in accordance with the present invention, showing the tower drone port situated on the top of the logistics tower.

FIG. 91 is top perspective view of the drone loader formed in accordance with the present invention.

FIG. 92 is top perspective view of the drone loader formed in accordance with the present invention, showing the drone loader situated in the logistics tower.

FIG. 93 is top perspective view of the drone dock formed in accordance with the present invention.

FIG. 94 is rear perspective view of the drone dock formed in accordance with the present invention.

FIG. 95 is bottom perspective view of the drone dock formed in accordance with the present invention.

FIG. 96 is front perspective view of the drone dock formed in accordance with the present invention, showing the delivery drone docked with the drone dock.

FIG. 97 is top perspective view of the drone ferry formed in accordance with the present invention, showing the delivery drone aligned with the drone ferry.

FIG. 98 is another top perspective view of the drone ferry formed in accordance with the present invention.

FIG. 99 is yet another top perspective view of the drone ferry formed in accordance with the present invention.

FIG. 100 is a bottom perspective view of the drone ferry formed in accordance with the present invention.

FIG. 101 is a cross sectional, perspective view of the drone ferry formed in accordance with the present invention, showing the delivery drone docked with the drone ferry.

FIG. 102 is a top perspective view of the drone ferry formed in accordance with the present invention, showing the drone ferry situated on the shuttle with the delivery drone docked therein.

FIG. 103 is a top perspective view of the loading dock formed in accordance with the present invention.

FIG. 104 is a partial cutaway, top perspective view of the loading dock formed in accordance with the present invention.

FIG. 105 is another partial cutaway, top perspective view of the loading dock formed in accordance with the present invention.

FIG. 106 is a partial cutaway, bottom perspective view of the loading dock formed in accordance with the present invention, showing the extensions and linear rails.

FIG. 107 is another partial cutaway, bottom perspective view of the loading dock formed in accordance with the present invention, showing the extensions and linear rails.

FIG. 108 is a top perspective view of the drone port formed in accordance with the present invention, showing the drone port installed on the side of a home.

FIG. 109 is a front perspective view of the vertical retrieval system formed in accordance with the present invention, showing a winch that utilizes a plurality of cables to selectively raise and lower the robotic bin handler.

### DETAILED DESCRIPTION OF THE PREFERRED EMBODIMENTS

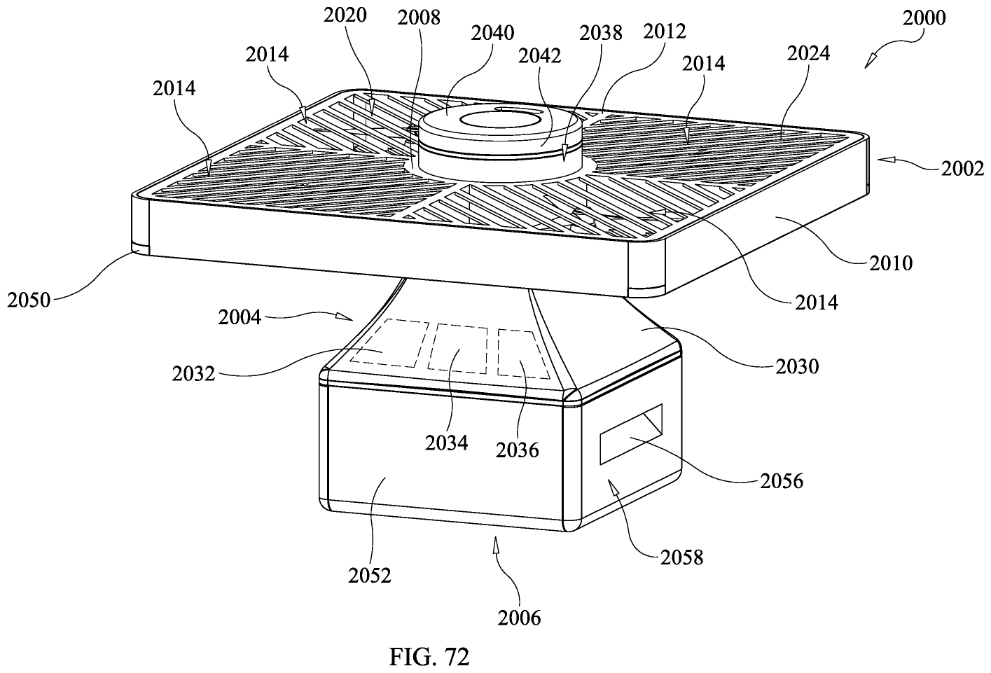

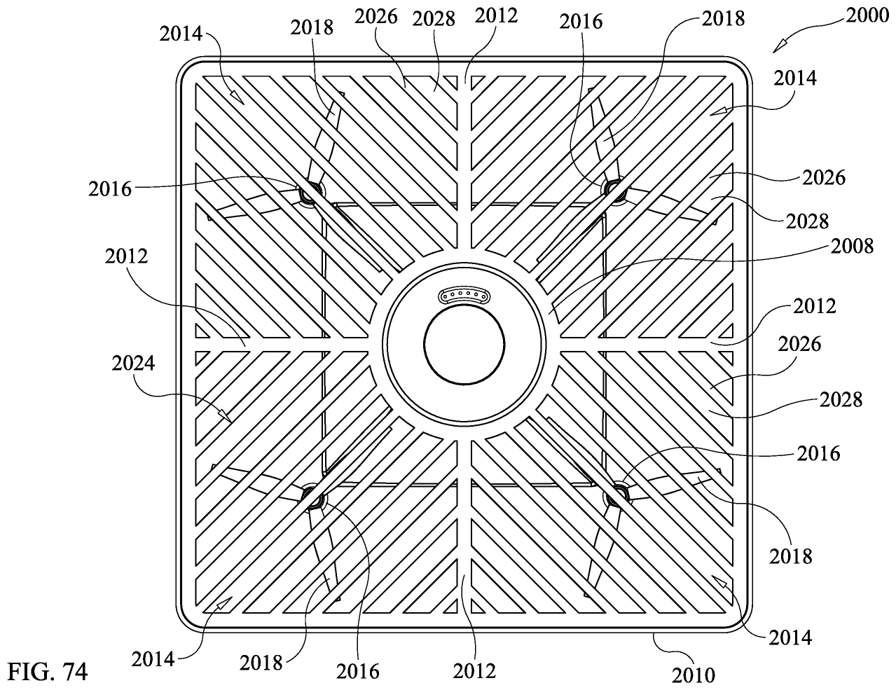

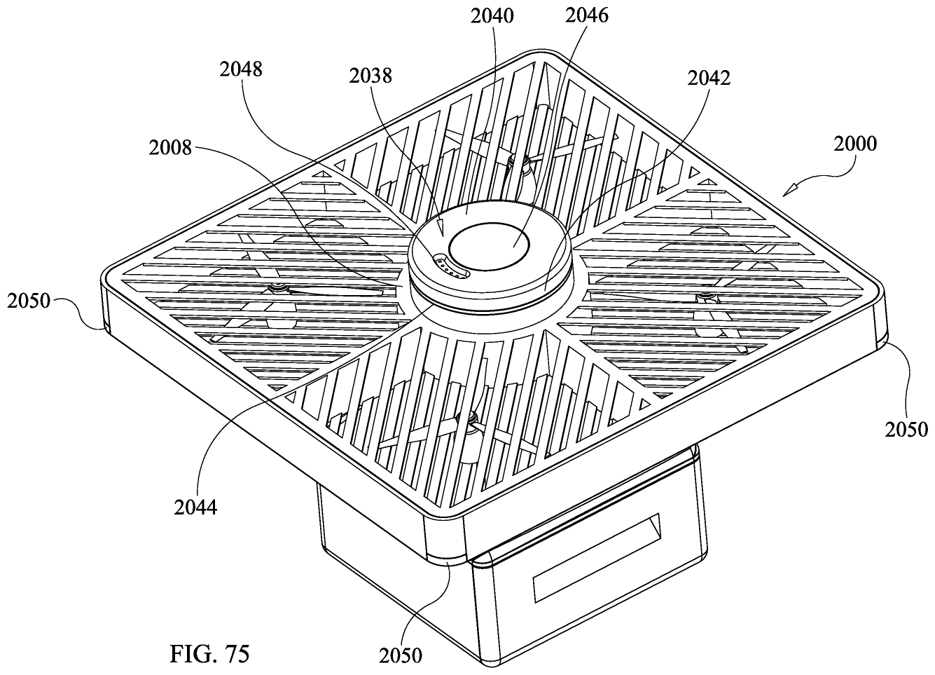

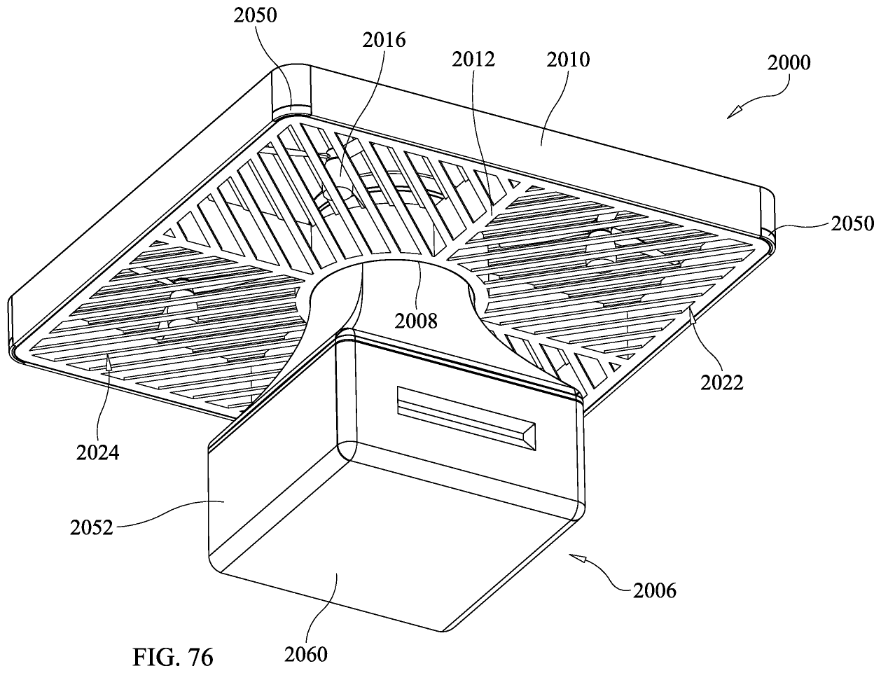

Initially referring to FIGS. 72-76 of the drawings, the delivery drone 2000 formed in accordance with the present invention includes an airframe 2002, drive module 2004 and at least one storage module 2006. As will be described in greater detail in the forthcoming paragraphs, the drive components of the delivery drone 2000 are situated on or in the drive module 2004 and the parcels (e.g., goods, items, packages, etc.) containing ordered items are stored in the storage module 2006.

In one form, the airframe 2002 includes a central hub 2008, a sidewall 2010 and a plurality of support arms 2012 that extend radially from the central hub 2008 to the sidewall 2010. The airframe 2002 preferably includes four support arms 2012 that, together with the sidewall 2010, define four motor compartments 2014. At least one motor 2016 and at least one rotor 2018 mechanically coupled thereto are situated in each of the engine compartments 2014.

The airframe 2002 further includes a top side 2020 and an oppositely disposed bottom side 2022. Preferably, one or both of the top side 2020 and the bottom side 2022 of the airframe 2002 include a rotor guard 2024. In a simple form, the rotor guard 2024 may comprise a plurality of segmented portions 2026 having openings 2028 therebetween that extend at least partially across the top side 2020 and/or the bottom side 2022 of the airframe 2002. The segmented portions 2026 partially cover the motor compartments 2014 and protect the motors 2016 and rotors 2018 situated therein while the openings 2028 allow sufficient airflow for the motors 2016 and rotors 2018 to drive the drone 2000. In one form, the motors 2016 may be mounted to the rotor guard 2024. In another form, the airframe 2002 may include additional support arms 2012 that extend between the hub 2008 and sidewall 2010, to which the motors 2016 are mounted.

The drive module 2004 preferable includes an outer housing 2030 defining an internal cavity. The drive components of the delivery drone 2000, which include at least one battery 2032, drive circuitry 2034 and at least one computer 2036, are at least partially situated within the internal cavity of the outer housing 2030. The motors 2016 are electrically coupled to the battery 2032 and the drive circuitry 2034, and the at least one computer 2036 is in electrical communication with the battery 2032, the drive circuitry 2034 and the motors 2016. The computer 2036 and drive circuitry 2034 control the motors 2016 and rotors 2018 coupled thereto to control the trajectory (e.g., the flight path) of the delivery drone 2002 along a particular route to a selected destination. The delivery drone 2002 further comprises a plurality of sensors, such as cameras, visual vector sensors, inertia sensors, heading sensors, pitch/yaw/roll sensors, global positioning system (“GPS”) sensors, gyroscopes, infrared sensors, etc., that may be used for determining a flight path as well as maintaining the delivery drone's trajectory along a particular flight path. The sensors may be mounted on or in the housing 2030, on the sidewall 2010 or affixed to portions of the airframe 2002, or on or within other portions of the delivery drone 2000, and are in electrical communication with one or more of the computer 2036 and the drive circuitry 2034.

The delivery drone 2000 may further include a communication interface and an antenna that are in electrical communication with the computer 2036. The communication interface and the antenna facilitate communication between the computer 2036 and an external computer network/server such that the delivery drone 2000 can receive commands and flight path orders therefrom. The delivery drone 2000 may also include light sources 2050 (e.g., indicator lights), such as LED fixtures or infrared spotlights, that are in electrical communication with the battery 2032 and the computer 2036. The light sources 2050 are selectively controllable by the computer 2036 and provide illumination, as well as indicate the status of the delivery drone 2000. The light sources 2050, are preferably situated on or in the sidewall 2010 of the delivery drone 2000.

The delivery drone 2000 further comprises a docking hub 2038 that extends outwardly from the central hub 2008. The docking hub 2038 includes a top surface 2040 and sidewall 2042 that define an internal cavity. A camera array 2044 is preferably situated on or in the sidewall 2042 of the docking hub 2038 and extends at least partially around the docking hub 2038. The camera array 2044 senses and detects obstructions in the path of travel of the delivery drone 2000 and can also be utilized for navigational purposes (e.g., detecting pitch/yaw/roll, heading, altitude, speed, etc.). More specifically, the camera array 2044 is in electrical communication with the computer 2036 situated within the housing 2030 of the drive module 2004. The computer 2036 is in electrical communication with the drive circuitry 2034. The computer 2036 analyzes signals generated by the camera array 2044 to detect the presence or absence of an obstruction in the path of the delivery drone 2000. If an obstruction is sensed, the computer 2036 can modify the speed and path of the delivery drone 2000 by signaling the drive circuitry 2034 to adjust the speed (e.g., rotations per minute (“RPMs”)) of one or more of the motors 2016 and/or the pitch of one of more of the rotors 2018, if adjustable pitch rotors are utilized. As will be described in greater detail in the forthcoming paragraphs, the camera array 2044 may also detect signals from guidance sensors or fiducial markers 2134 located on or in portions of the destination structure (e.g., a logistics tower 2 or a house drone port 2062) and include a vision guidance system.

The docking hub 2038 further includes a docking magnet 2046. As will be described in greater detail in the forthcoming paragraphs, the docking magnet 2046 is engageable with a mechanically actuatable magnet 2022 such as a Magswitch® or another mechanical permanent magnet on a drone docking port 2174. Additionally, the docking hub 2038 may include a charging connector 2048 that is in electrical communication with one or more of the at least one battery 2032 and the at least one computer 2036. As will also be explained in the forthcoming paragraphs, when the delivery drone 2000 docks with the drone docking port 2174 or a house drone port 2062, a corresponding connector situated thereon may be engaged with the charging connector 2048 to recharge the at least one battery 2032 of the delivery drone 2000. Preferably, the docking magnet 2046 and the charging connector 2048 are situated on the top surface 2040 of the docking hub 2038. It is also envisioned to be within the scope of the present invention to utilize an inductance charging system that is incorporated into the docking hub 2038 to provide charge to the battery 2032 of the delivery drone 2000.

The storage module 2006 of the delivery drone 2000 includes a housing 2052 defining an internal cavity or storage compartment 2054 for storing parcels. In one form, the storage compartment 2006 includes one or more slots 2056 into which at least one parcel or item may be inserted. The storage module 2006 preferable includes at least one drawer 2058 formed in the housing 2052 that is selectively extendable and retractable therefrom, or removable therefrom. For example, the drawer 2058 may be affixed to the storage module 2006 by one or more drawer slides 2059. In a simple form, the edges of the drawer 2058 may rest on one or more lips extending inwardly from the housing 2052 of the storage module 2006 into the internal cavity thereof. The drawer 2058 is at least partially contained within the internal cavity of the storage module 2006 and holds the parcels/items stored therein. When the delivery drone 2000 arrives at a particular destination, the drawer 2058 is extended or removed from the storage module 2006 to access the parcel stored therein. Preferably, the storage module 2006 and drawer 2058 are constructed to accommodate one or more parcels weighing up to five pounds and that is no more than 12 inches by 12 inches by 6 inches in dimension; however, the storage module 2006 and drawer 2058 may be constructed to accommodate heavy and larger parcels.

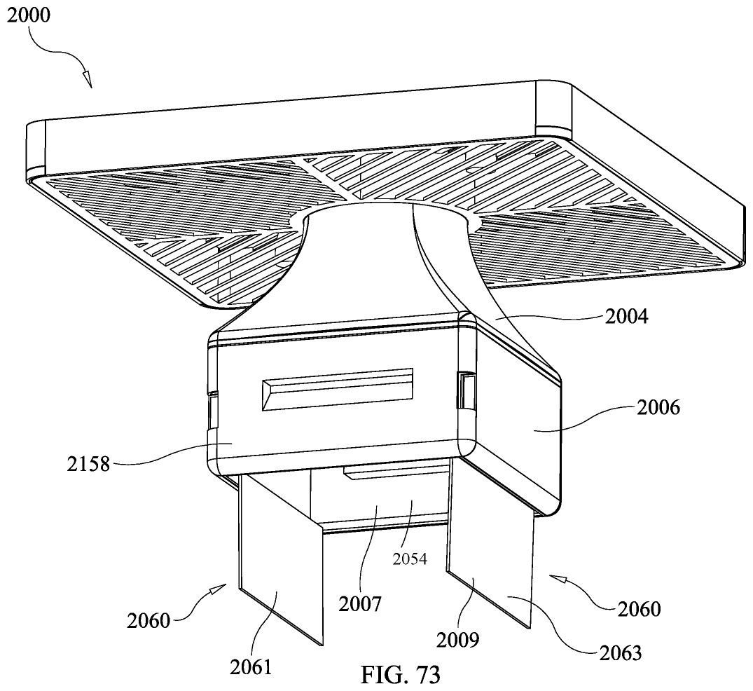

In another form, as shown in FIG. 73 of the drawings, the drawer 2058 forms the bottom side of the storage module 2006. More specifically, the housing 2052 of the storage module 2006 defines an open bottom side 2007. The drawer 2058, which is selectively extendable and retractable from the storage module 2006, includes a bottom side 2009. As can be seen in FIG. 73 of the drawings, when the drawer 2058 is situated within the storage module 2006, the bottom side 2009 of the drawer covers the open bottom side 2007 of the storage module 2006, thereby enclosing the storage module 2006 and parcel therein. The bottom side 2009 of the drawer further includes a door 2060. In one form, the door 2060 preferably forms the bottom of the drawer 2058 and is a sliding door that is reciprocatingly moveable between at least a first position and a second position, wherein the first position corresponds to a closed position and the second position corresponds to an open position. The door 2060 may be formed as one or a plurality of sliding members, each of which is reciprocatingly moveable. In a preferred form, the door 2060 comprises a first door section 2061 and a second door section 2063. A portion of the first door section 2061 and the second door section 2063 are hingedly connected to the drawer 2058 and coupled to one or more linear actuators. The first door section 2061 and the second door section 2063 are selectively opened and closed by the linear actuators. When the door 2060 is in the open position, parcels may be selectively moved to and from the storage module 2006 therethrough.

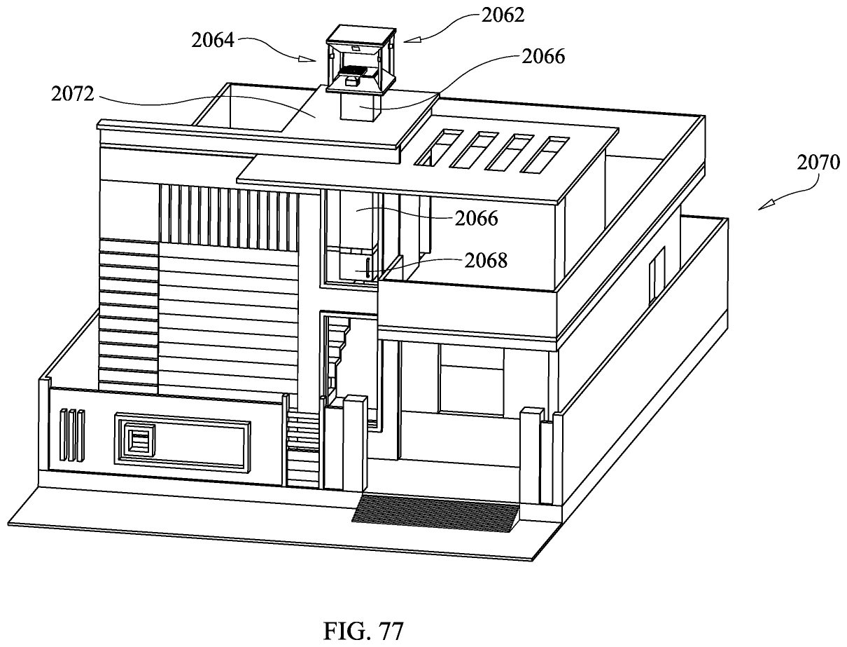

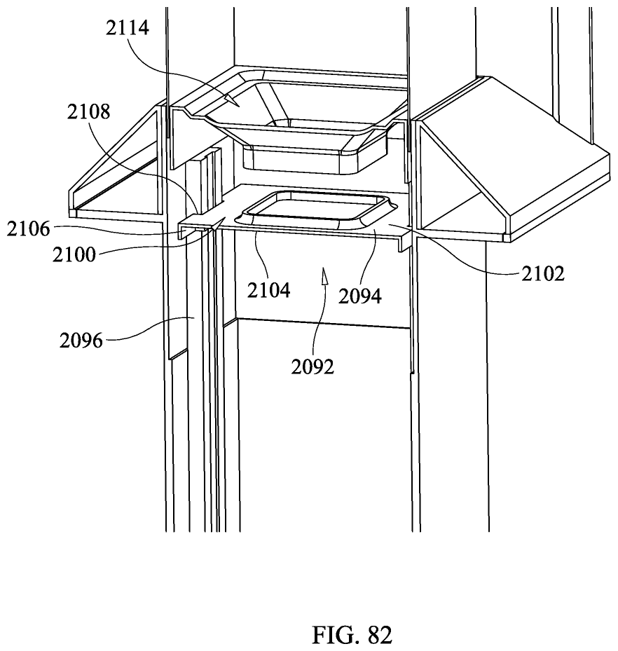

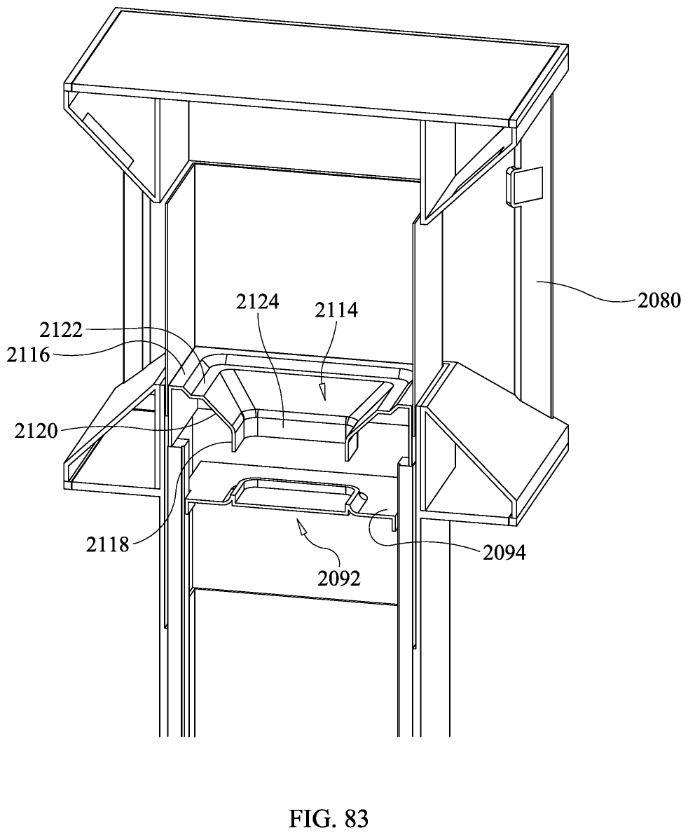

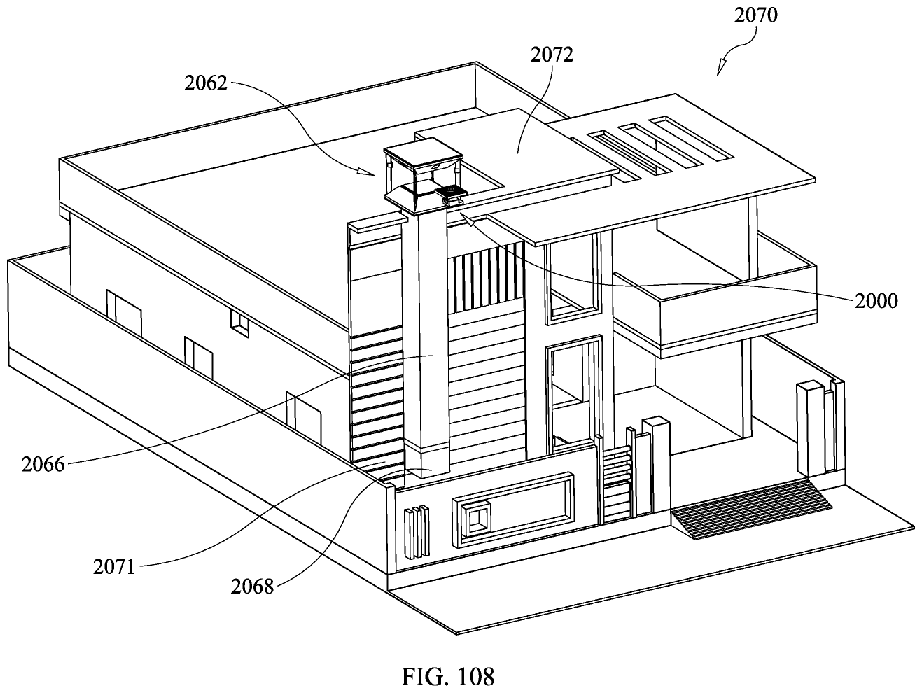

As can be seen in FIGS. 77-83 of the drawings, a drone port 2062 formed in accordance with the present invention includes a drone docking platform 2064, delivery shaft 2066 and at least one delivery compartment 2068, the delivery shaft 2066 extending between and interconnecting the drone docking platform 2064 and the delivery compartment 2068. As can be seen in FIGS. 77 and 108 of the drawings, the drone port 2062 is preferably mounted on a house 2070 or other structure (e.g., a residential or commercial structure) such that the drone docking platform 2064 is situated above the roof 2072 and accessible by the delivery drone 2000. The delivery shaft 2066 preferably extends through the roof 2072 and into the house 2070 so that the delivery compartment 2068 is accessible by a user while within the house 2070; however, it is also envisioned to be within the scope of the present invention to have the drone port 2062 be freestanding in a driveway, parking lot or on a lawn, sidewalk or fence, for example. The drone port 2062 can also be mounted to the side of a house 2070 and an opening can be formed through one of the walls/sides 2071 of the house 2070 to access the delivery compartment 2068. In another form, which could be used in a high rise building or apartment complex, the delivery shaft 2066 may extend through several floors and several delivery compartments 2068 may be interposed along the delivery shaft 2066 (e.g., one per floor) and be accessible by residents on the particular floor the compartment 2068 is situated on.

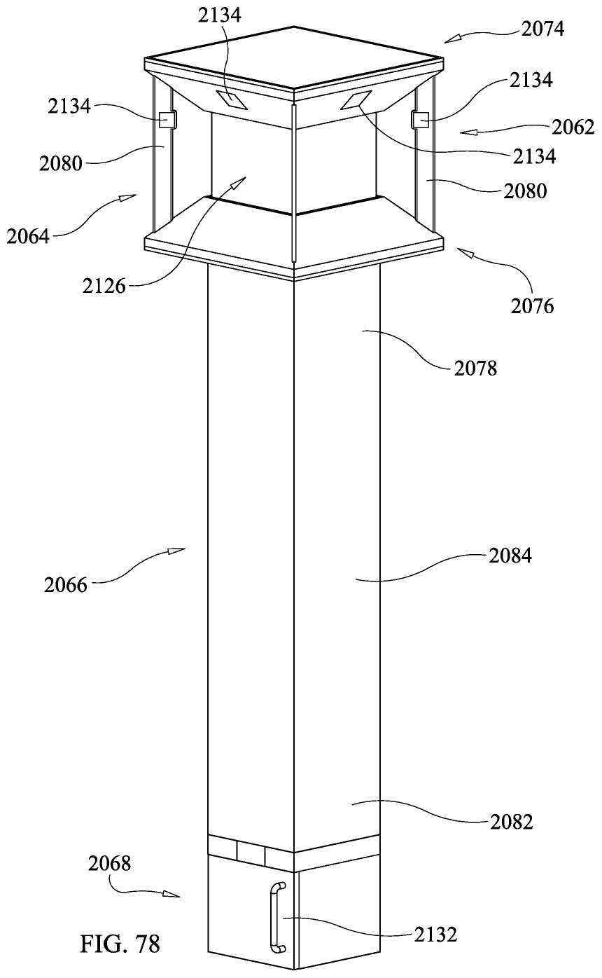

The delivery shaft 2066 preferably includes a top end 2078 and a bottom end 2082 disposed opposite the top end 2078. As will be explained in greater detail in the forthcoming paragraphs, the drone docking platform 2064 is situated at the top end 2078 of the delivery shaft 2066 and the delivery compartment 2068 is situated at the bottom end 2082 of the delivery shaft 2066. As can be seen in FIGS. 78-83 of the drawings, the delivery shaft 2066 includes a sidewall 2084 that extends between the top end 2078 and bottom end 2082 thereof and defines an internal cavity 2086 that extends along the axial length of the delivery shaft 2066. The sidewall 2084 of the delivery shaft 2066 includes an outer surface 2088 and an inner surface 2090.

The drone port 2062 may further comprise a parcel lift system 2092. The parcel lift system 2092 includes at least one actuator that is mechanically coupled to a parcel retrieval platform 2094 on which a parcel rests. The actuator selectively raises and lowers the parcel retrieval platform 2094 through the internal cavity 2086 of the delivery shaft 2066 to and from the delivery drone 2000 situated above the delivery shaft 2066 in the drone docking platform 2064. In one form, the parcel lift system 2092 comprises at least a first rail 2096 and a second rail 2098. More specifically, the first rail 2096 and the second rail 2098 are situated on opposite sides of the inner surface 2090 of the sidewall 2084 of the delivery shaft 2066 and extend at least partially between the top end 2078 and bottom end 2082 thereof. Preferably, the rails 2096, 2098 extend into the delivery compartment 2068 situated at the bottom end 2082 of the delivery shaft 2066. In one form, one or more linear actuators (not shown) are situated adjacent to each rail 2096, 2098 that include one or more arms that are engageable with the parcel retrieval platform 2094. For example, a linear actuator comprising a worm gearing may extend at least partially along the vertical length of the inner surface 2090. One portion of the linear actuator may be engaged with a portion of the support platform 2094 to drive the support platform 2094 up and down through the delivery shaft 2066. In another form, the rails 2096, 2098 are formed as linear actuators (e.g., motor/gearing, pneumatic, hydraulic, etc.) and each includes at least one tab or arm that is engageable with the parcel retrieval platform 2094 and drives the parcel retrieval platform 2094 engaged therewith up and down within the internal cavity 2096 of the delivery shaft 2066. In yet another form, the retrieval platform 2094 may be connected to a winch system comprising a cable, drum and motor that raises and lowers the platform 2094 within the internal cavity 2086 of the delivery shaft 2066.

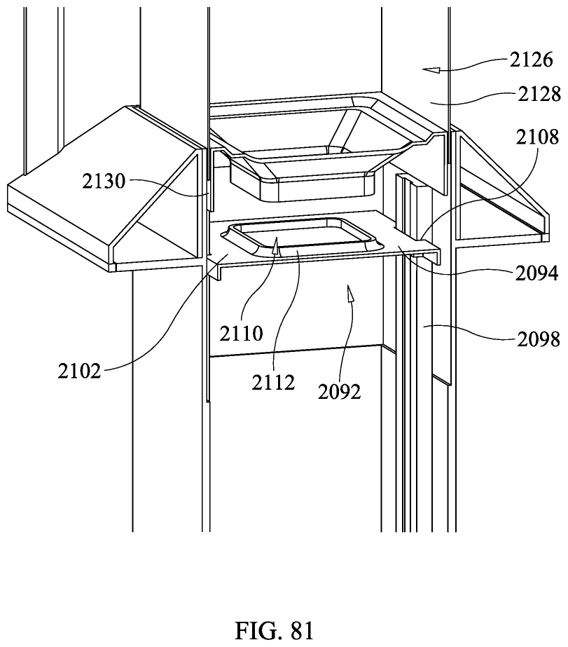

As can be seen in FIGS. 81-83 of the drawings, the parcel retrieval platform 2094 is generally formed as a planar member 2100 having a top surface 2102, a bottom surface 2104 situated opposite the top surface 2102 and a sidewall 2106 extending at least partially around the periphery of the planar member 2100. The planar member 2100 includes two indents 2108 situated on opposite sides thereof into each of which one of the rails 2096, 2098 is situated. The tabs of the rails (e.g., the linear actuators) engage the sidewall 2106 of the planar member 2100 or simply the bottom surface 2104 thereof. A parcel guide 2110 is situated on the top surface 2102 of the planar member. In one form, the parcel guide 2110 is formed as a flange having a sidewall 2112 that extends upwardly from the top surface 2102 of the planar member that is configured to at least partially receive a parcel from the delivery drone 2000. The parcel is situated within the parcel guide 2110 and the flange resists lateral slippage of the parcel on the parcel retrieval platform 2094 as it traverses the delivery shaft 2066.

The drone docking platform 2064 preferably includes a top section 2074 and an oppositely disposed bottom section 2076, the bottom section 2076 being situated on the top end 2078 of the delivery shaft 2066. The top section 2074 and the bottom section 2076 are separated from one another to create a space into which the delivery drone 2000 may travel and dock. The top section 2074 and the bottom section 2076 are interconnected by a plurality of support legs 2080.

A drone docking tray 2114 is situated in the bottom section 2076 of the drone docking platform 2064 and at least partially covers the internal cavity 2086 of the delivery shaft 2066 at the top end 2076 thereof. The drone docking tray 2114 preferably includes a top portion 2116, a bottom portion 2118 and a sidewall 2120 extending therebetween. The sidewall 2120 of the drone docking tray 2114 includes a lip 2122 extending inwardly therefrom at least partially around the periphery thereof in proximity to the top portion 2116. The sidewall 2120 of the drone docking tray 2114 defines an opening 2124 that extends between the top portion 2116 and bottom portion 2118 thereof, the opening 2124 being aligned with the parcel guide 2110 of the parcel retrieval platform 2094.

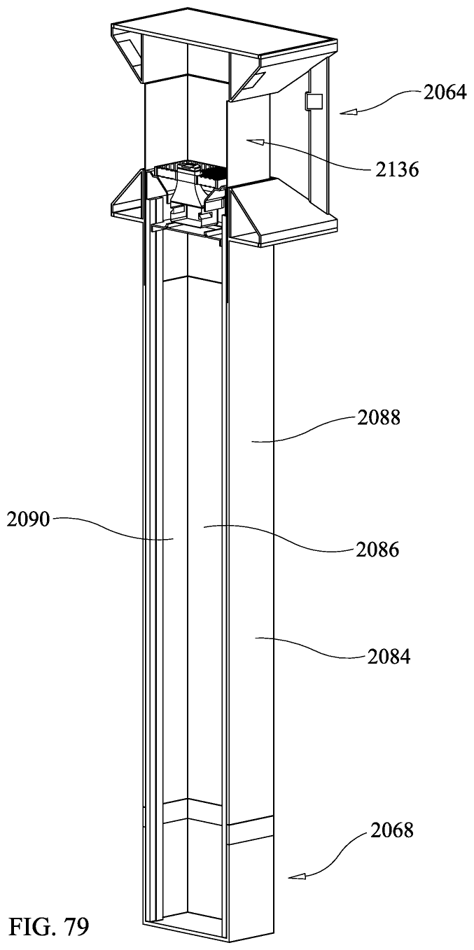

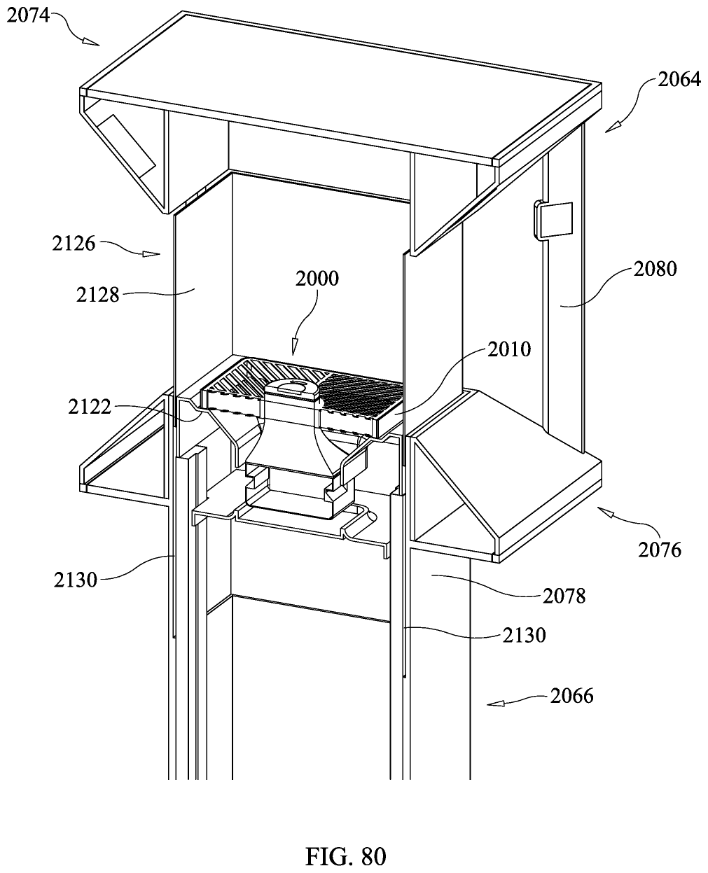

As can be seen in FIGS. 79 and 80 of the drawings, the delivery drone 2000 docks with the drone docking tray 2114 such that the sidewall 2010 of the airframe 2002 rests on the lip 2122 of the tray 2114. When the drone 2000 is docked with the docking tray 2114, the drive module 2004 and storage module 2006 extend into the opening 2124. As can be seen in FIG. 80 of the drawings, when the drone 2000 is docked with the docking tray 2114, at least a portion of the storage module 2006 extends outwardly from the bottom portion 2118 of the docking tray 2114 in proximity to the parcel retrieval platform 2094 (e.g., when the parcel retrieval platform 2094 is situated in proximity to the top end 2078 of the delivery shaft 2066).

The drone docking platform 2064 further includes a retractable enclosure 2126 that is selectively extendable between the bottom section 2076 and the top section 2074 of the drone docking platform 2064. More specifically, the retractable enclosure 2126 includes an open top end, an open bottom end and a sidewall 2128 extending therebetween. The sidewall 2128 of the retractable enclosure 2126 generally conforms to the shape of the sidewall 2084 of the delivery shaft 2066 and is, at least partially, selectively receivable within a slot 2130 formed in the sidewall 2084. The retractable enclosure 2126 is mechanically coupled to one or more linear actuators that drive the retractable enclosure 2126 between the retracted state and the extended state. When the retractable enclosure 2126 is in an extended state, as shown in FIG. 78 of the drawings, the top section 2074 and the bottom section 2076 of the drone docking platform 2064 form an enclosure that covers the top end 2078 of the delivery shaft 2066, in particular, the internal cavity 2086 thereof. Such an enclosure prevents rain, wind and snow from entering the delivery shaft 2066, as well as limits temperature fluctuations in the house or structure. One or more guidance sensors or fiducial markers 2134 are situated on portions of the drone docking platform 2064 to guide the drone 2000 therein so that the delivery drone 2000 can dock with drone docking tray 2114. The camera array 2044 of the drone 2000 senses the fiducial markers 2134 and causes the flight path to be adjusted based the sensed position of the markers 2134. In particular, the markers 2134 guide the drone into the drone docking platform 2064 such that the drone 2000 is situated over the docking tray 2114, thereby aligning the storage module 2006 of the delivery drone 2000 with the parcel retrieval platform 2094 and the internal cavity 2086 of the delivery shaft 2066.

The delivery compartment 2068 is preferably formed as cutout opening in the sidewall 2084 of the delivery shaft 2066. A door 2132 is hingedly connected to a portion of the sidewall 2084 of the delivery shaft 2066 and may be selectively opened and closed to access the internal cavity of the delivery shaft 2066 and the parcel retrieval platform 2094.

The drone port 2062 may further comprise a power system, a computer and a plurality of sensors. More specifically, the drone port 2062 may be electrically coupled to an AC power source and may further include a backup battery. The power system is in electrical communication with the electrical components of the drone port 2062 (e.g., the parcel lift system 2092, the retractable enclosure actuators, etc.) and provides power thereto. The computer controls the actuation of the parcel lift system 2092 and the movement of the retrieval platform 2094 and the retractable enclosure 2126.

The delivery compartment 2068 may further comprise security protocols that limit access to the shaft 2066 and to the parcel retrieval platform 2094. In a simple form, the door 2132 of the delivery compartment 2068 may include a remotely controlled or programmable lock. More specifically, a user may operate a portable electronic device having a user interface (e.g., a mobile telephone or computer) that is in network communication with a server that sends a signal to the lock to allow the door 2132 to be opened. The portable electronic device may include a mobile application that transmits an unlock or lock code to the server which communicates an unlock or lock signal to the computer of the drone port 2062. The users account is stored in the cloud and retrieved once a user wants to retrieve the parcel from the parcel retrieval platform 2094. The user also has a security key associated with delivery compartment 2068, such as an RFID tag, that is detected by a sensor situated on delivery compartment 2068.

In operation, the delivery drone 2000 transports parcels to and from a logistics tower 2 and one or more drone ports 2062, or between two or more drone ports 2062. For example, a plurality of delivery drones 2000 may be loaded with parcels at a logistics tower 2 and programmed with a set of delivery points. As will be described in greater detail in the forthcoming paragraphs, when a user submits an order over a network, the order is sent to the closest logistics tower 2. The vertical retrieval system 20 of the logistics tower 2 retrieves storage bins 16 from the vertical storage cell columns 418 containing the contents of the order. The storage bins 16 are lowered to shuttles 206 on the horizontal shuttle grid 200 of the horizontal shuttle system 202. The shuttles 206 traverse the horizontal shuttle grid 200 of the horizontal shuttle system 202 to an elevator 903, 904 situated at a respective loading dock 970. The delivery drone 2000 in situated on or in proximity to the loading dock 970 and the storage module 2006 thereof is loaded with the contents of the order (e.g., by human or by an articulated robotic arm 976).

Once the delivery drone 2000 is loaded with the ordered items, the delivery drone 2000 navigates autonomously or semi-autonomously through its environment along a flight path to a predetermined location (e.g., a delivery destination such as a drone port 2062). The delivery drone's 2 sensors (e.g., GPS sensors and camera array 2044) can detect that the delivery drone 2000 is within a specific location area. If the parcel is going to be deposited into a drone port 2062, the delivery drone 2000 uses onboard sensors, coupled with GPS and the guidance sensors or fiducial markers 2134 situated on portions of the drone docking platform 2064 to guide the drone 2000 therein so that the delivery drone 2000 can dock with drone docking tray 2114. Prior to, concurrently with or after the delivery drone 2000 has docked with the docking tray 2114, the parcel retrieval platform 2094 is driven towards the top end 2078 of the delivery shaft 2066 and is situated below the opening 2124 in the drone docking tray 2114. The delivery drone's door 2060, in particular, the first door section 2061 and the second door section 2063, hingedly open allowing the parcel contained in the storage module 2006 to exit the storage module 2006 and rest on the parcel retrieval platform 2094.

The parcel retrieval platform 2094 is then driven towards the delivery compartment 2068. When the parcel retrieval platform 2094 arrives at a designated delivery compartment 2068, the user opens the door 2132 to access the parcel retrieval platform 2094 and the parcel situated thereon. Concurrently therewith, before or after, the delivery drone door 2060 closes, the delivery drone 2000 undocks from the drone docking tray 2114 and exits the drone port 2062.

The drone port 2062 may also be utilized to load the delivery drone. For example, the drone port 2062 may also be installed at commercial establishments such as local stores or warehouses that wish to utilize the automated delivery system formed in accordance with the present invention. If a user purchases an item from a commercial seller (e.g., an item listed on a third-party order fulfillment service), the delivery drone 2000 formed in accordance with the present invention may be routed to the drone port 2062 of the commercial seller. The commercial seller opens door 2132 of the delivery compartment 2068 of the drone port 2062 and places the ordered item(s) on the parcel retrieval platform 2094. The drone 2000 enters the drone port 2062 and docks with the drone docking platform 2064, in particular, the drone delivery tray 2114 thereof, and opens its door 2060 (e.g., the first door section 2061 and the second door section 2063). The parcel retrieval platform 2094, with the parcel situated thereon, is driven towards the top end 2078 of the delivery shaft 2066 and situated below the opening 2124 of the drone docking tray 2114. The delivery drone's door 2060, in particular, the first door section 2061 and the second door section 2063 thereof, are driven to the closed position, thereby capturing the parcel from the parcel retrieval platform 2094 as the door sections 2061, 2063 move from the open position to the closed position. Thereafter, the delivery drone 2000 undocks from the drone docking tray 2114 and exits the drone port 2062 and follows a flight path to a destination (e.g., another drone port 2062 or a logistics tower 2).

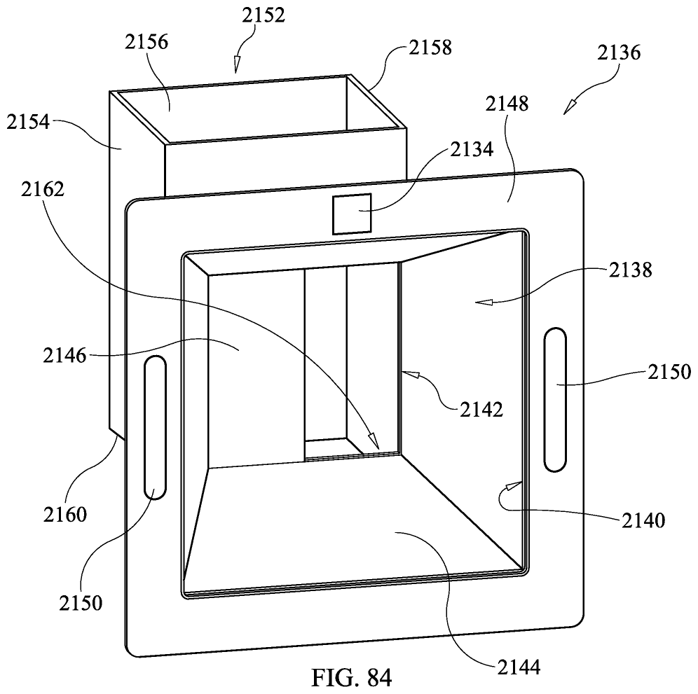

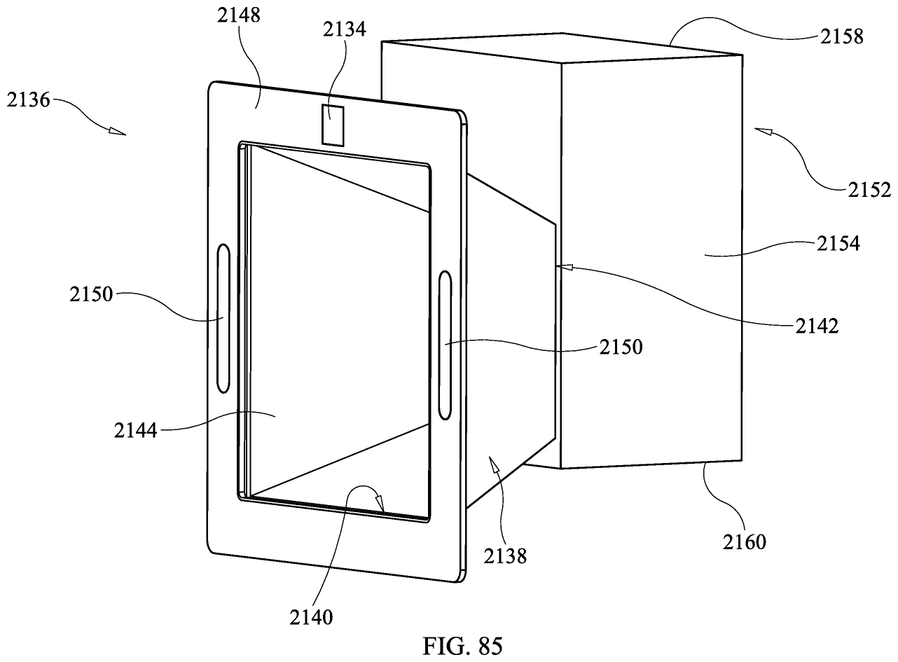

As described above, the delivery drone 2000 may transport parcels from a logistics tower 2, such as the logistics tower 2 described in the forthcoming pages. More specifically, the logistics tower 2 may include one or more tower drone ports 2136 that facilitate the entry of the delivery drones 2000 into the logistics tower 2. As shown in FIGS. 84 and 85 of the drawings, the tower drone port 2136 includes a funnel shaped main body 2138 having a first end 2140, an oppositely disposed second end 2142 and an opening 2144 extending between the first end 2140 and the second end 2142. The tower drone port 2136 further includes at least one door 2146 situated in proximity to the second end 2142 thereof that is selectively closable (e.g., via a linear actuator or other electro-mechanical actuator) to cover the opening 2144 in the funnel shaped main body 2138; however, it is also envisioned to be within the scope of the invention for the door 2146 to be situated in proximity to the first end 2140 of the funnel shaped main body 2138. A flange 2148 extends at least partially around the periphery of the first end 2140 of the funnel shaped main body 2138. One or more guidance sensors or fiducial markers 2134 are situated on portions of the tower drone port 2136, preferably on the flange 2148, to guide the delivery drone 2000 at least partially through the opening 2144. One or more flood lights 2150 are also situated on the flange 2148 to provide viability for the delivery drone 2000 on approach to the tower drone port 2136. The second end 2142 of the tower drone port 2136 may be coupled to a tower drone port support 2152. The tower drone port support 2152 includes a sidewall 2154 defining an internal cavity 2156, a top end 2158 and an open bottom end 2160 situated opposite the top end 2158. The tower drone port support 2152 further includes an opening 2162 in the sidewall 2154 that is aligned with the opening 2144 of the tower drone port 2136.

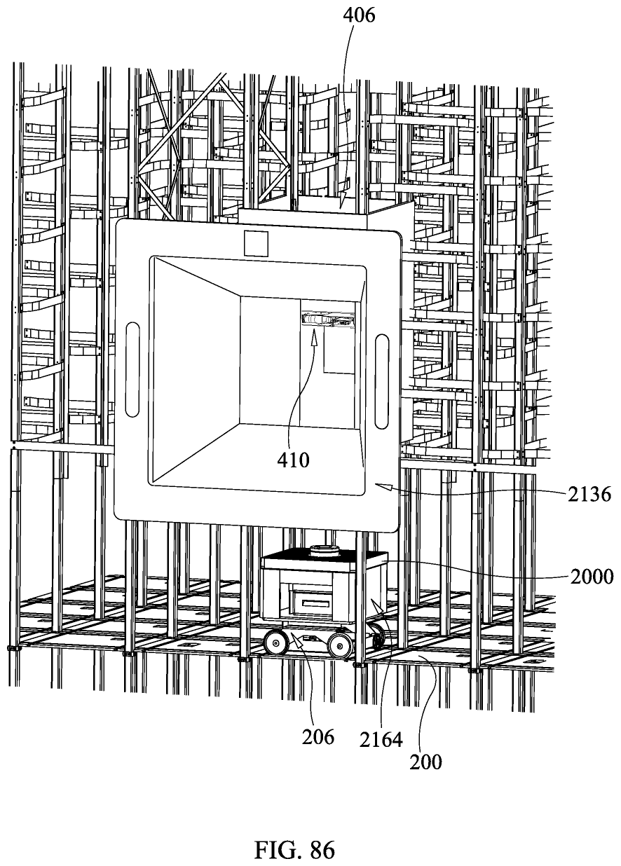

In one form, as shown in FIG. 86 of the drawings, the tower drone port 2136 is situated on the side of the logistics tower 2. In such a configuration, the tower drone port support 2152 is situated in the elevator shaft 406. The top end 2158 of the tower drone port support 2152 is also open so that the robotic bin handler 410 can traverse through internal cavity 2156 of the tower drone port support 2152 as it is moved up and down within the elevator shaft 406. The opening 2144 of the funnel shaped main body 2138 and the opening 2162 in the sidewall 2154 of the tower drone port support 2152 are aligned with an opening in the frame 402 of the logistics tower 2 at a particular storage level 405 such that the carriage 800 of the robotic bin handler 410 can be extended therethrough to engage the delivery drone 2000 situated within the tower drone port 2136. In particular, the airframe 2002 of the delivery drone 2000 may include a plurality of metal lugs, preferably steel lugs, that are engageable by complementary magnets 806 situated on carriage 800 of the robotic bin handler 410.

Once the delivery drone 2000 is engaged with the carriage 800 of the robotic bin handler 410, the carriage 800 and delivery drone 2000 engaged therewith are retracted so that they are situated underneath the robotic bin handler 410 and the vertical retrieval system 20 lowers the delivery drone 2000 to a drone ferry 2164 situated on a shuttle 206 on the horizontal shuttle grid 200. When the delivery drone 2000 is situated on the drone ferry 2164 on the shuttle 206, the carriage 800 of the robotic bin handler 410 is disengaged/decoupled from the delivery drone 2000, for example by redirecting the magnetic field of the magnets 806 on the carriage 800 or by deenergizing the magnets 806. The robotic bin handler 410 then moves upwardly away from the delivery drone 2000 and the shuttle 206 transports the delivery drone 2000 to a loading dock 970.

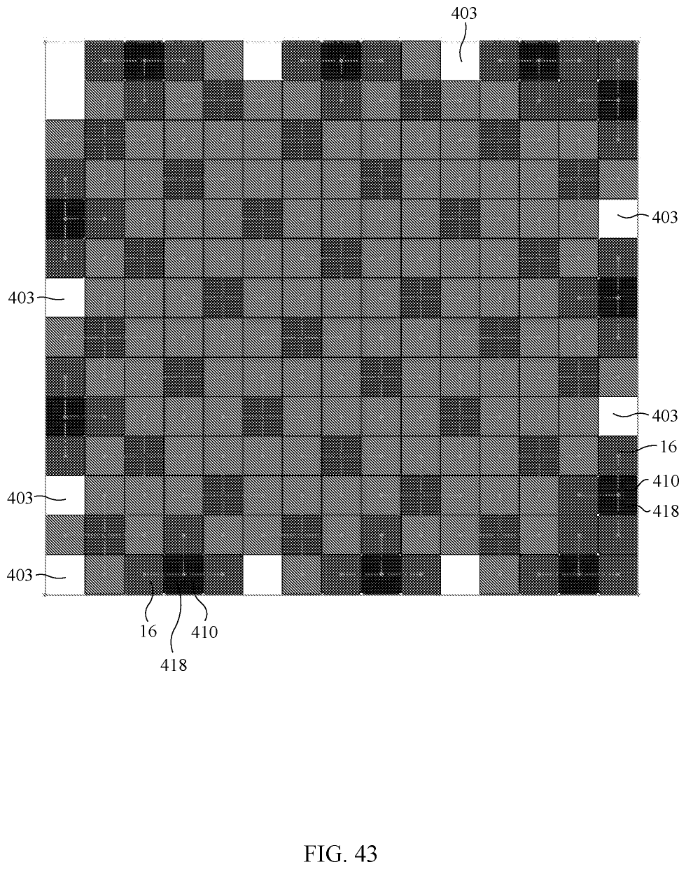

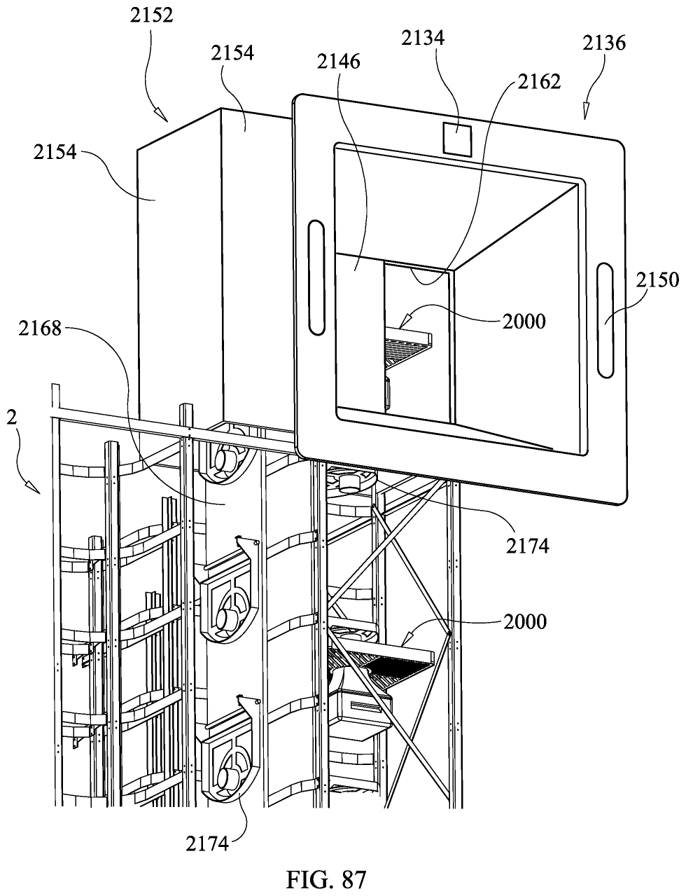

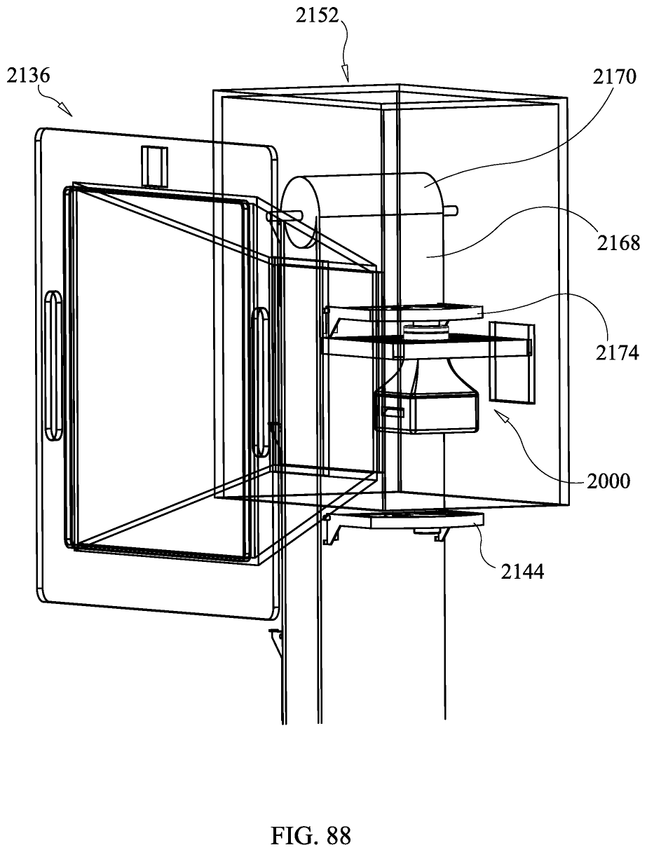

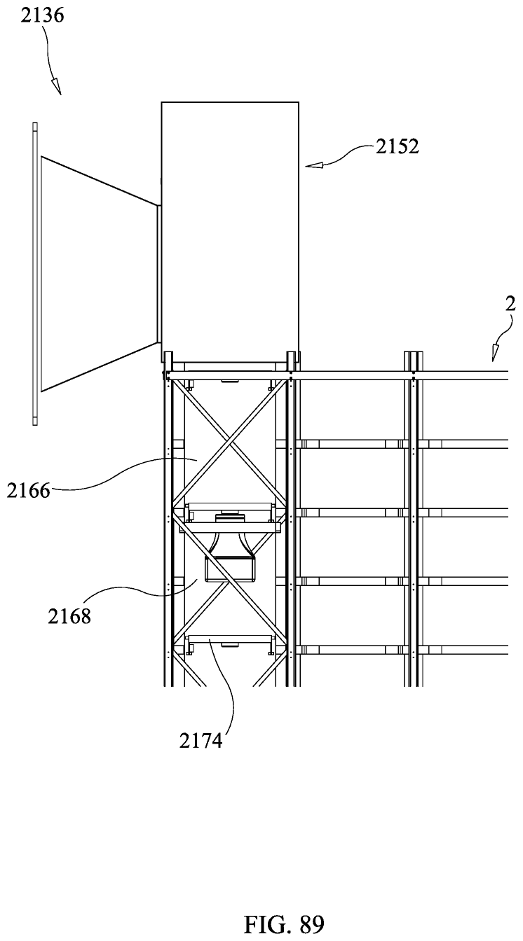

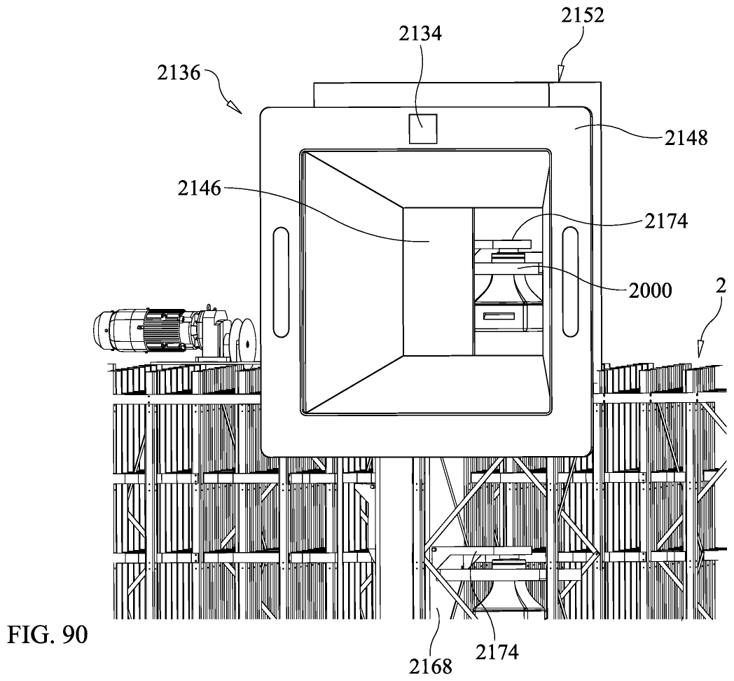

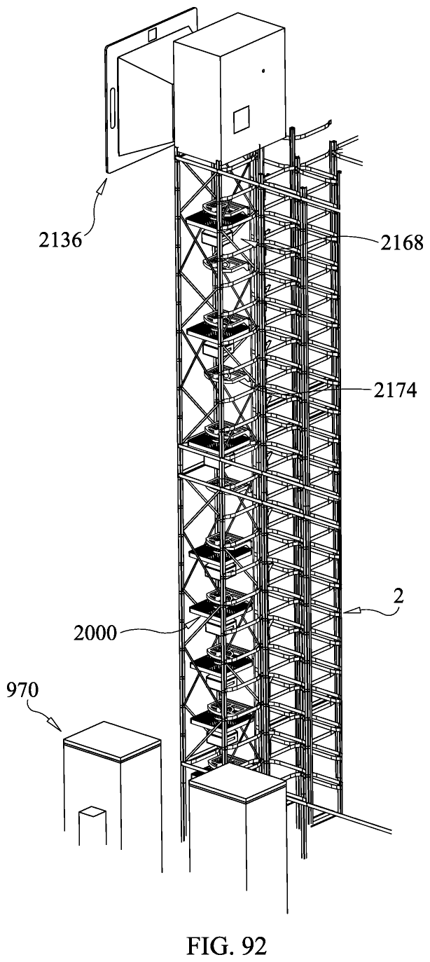

The tower drone port 2136 may also be situated on the top of the logistics tower 2, preferably, over one or more unusable columns or secondary vertical shafts 403, as shown in FIGS. 43 and 87-90 of the drawings. As can be seen in FIGS. 87 and 92 of the drawings, one or more delivery drone loaders 2166 may be situated at least partially within an unusable column 403 and extend at least partially between the tower drone port 2136 situated on the top of the logistics tower 2 and the horizontal shuttle grid 200. The top of the drone loader 2166 is preferably situated in the internal cavity 2156 of the tower drone port support 2152. The delivery drone loader 2166 includes a vertically oriented conveyor belt 2168 that is coupled to a pulley 2170 at one end and a motorized drum 2172 at an opposite end. One or more drone docks 2174 are pivotally coupled to the conveyor belt 2168.

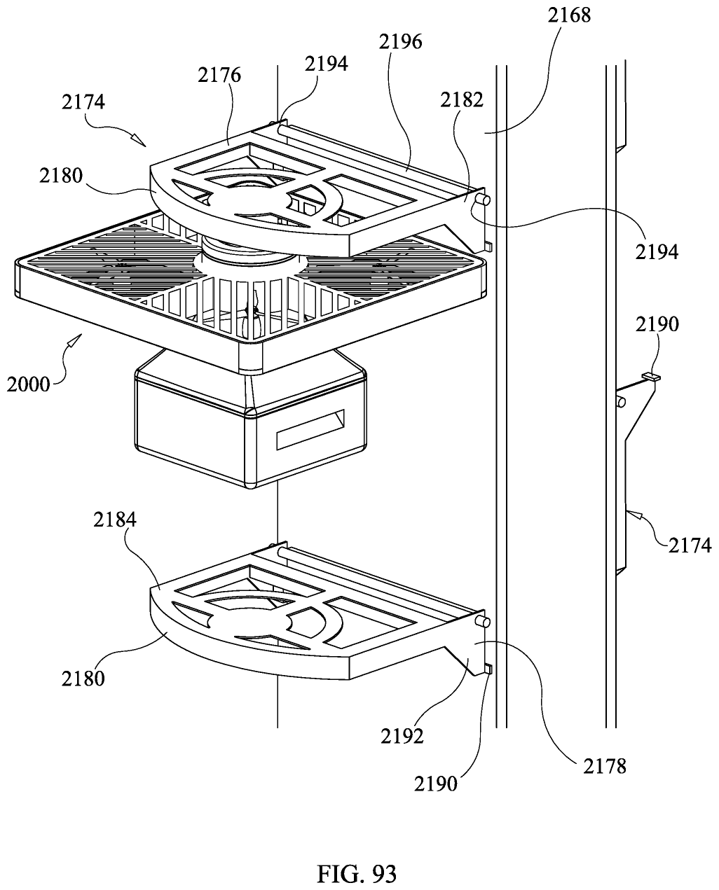

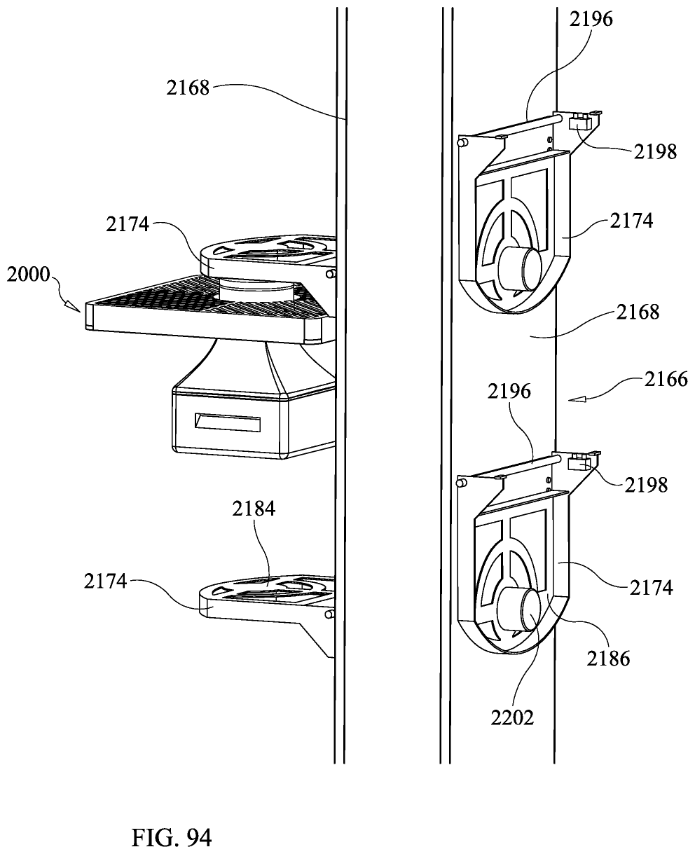

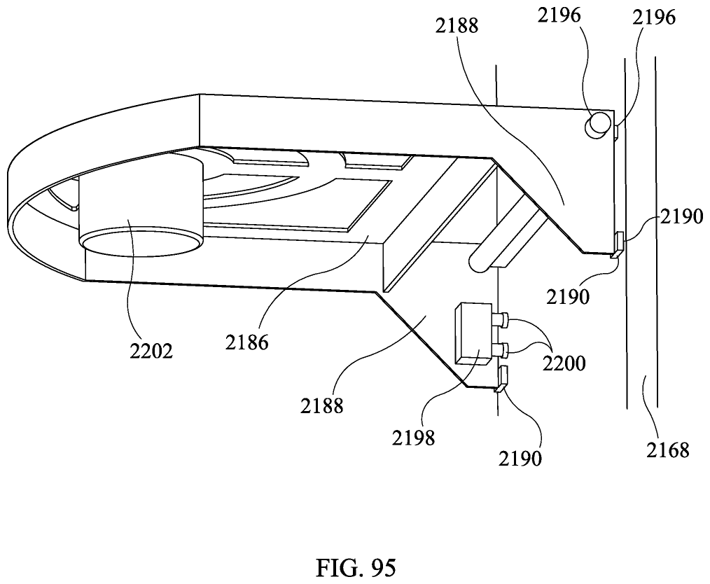

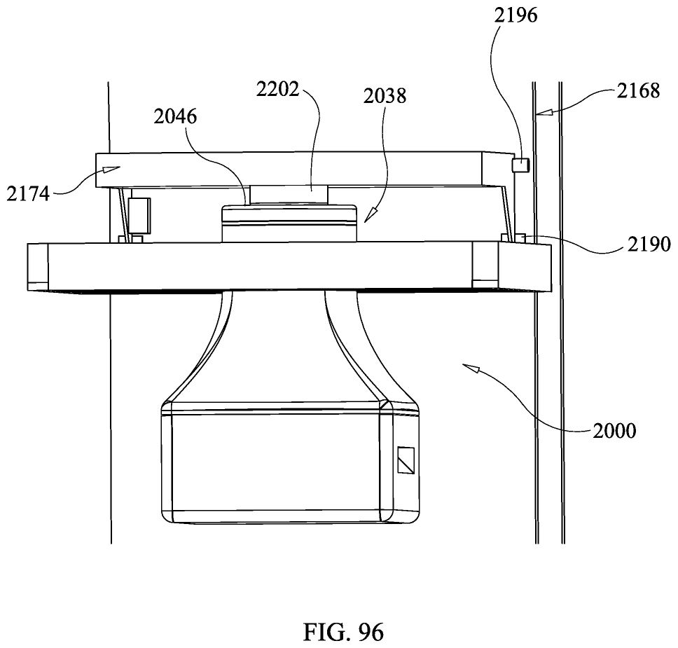

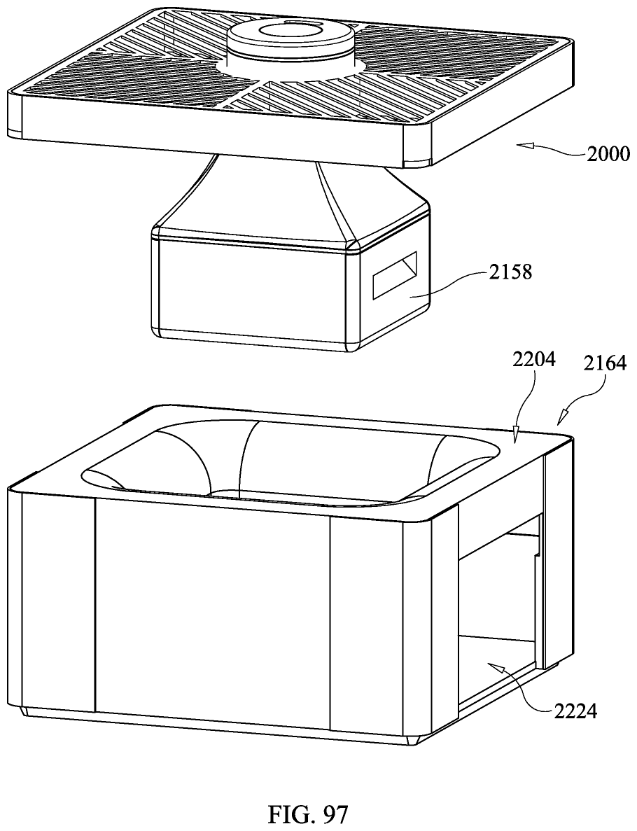

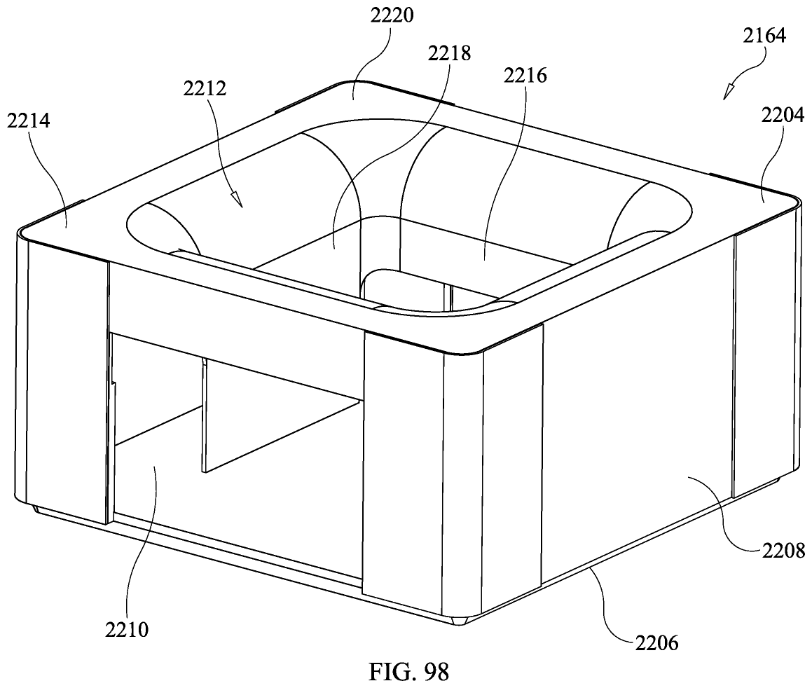

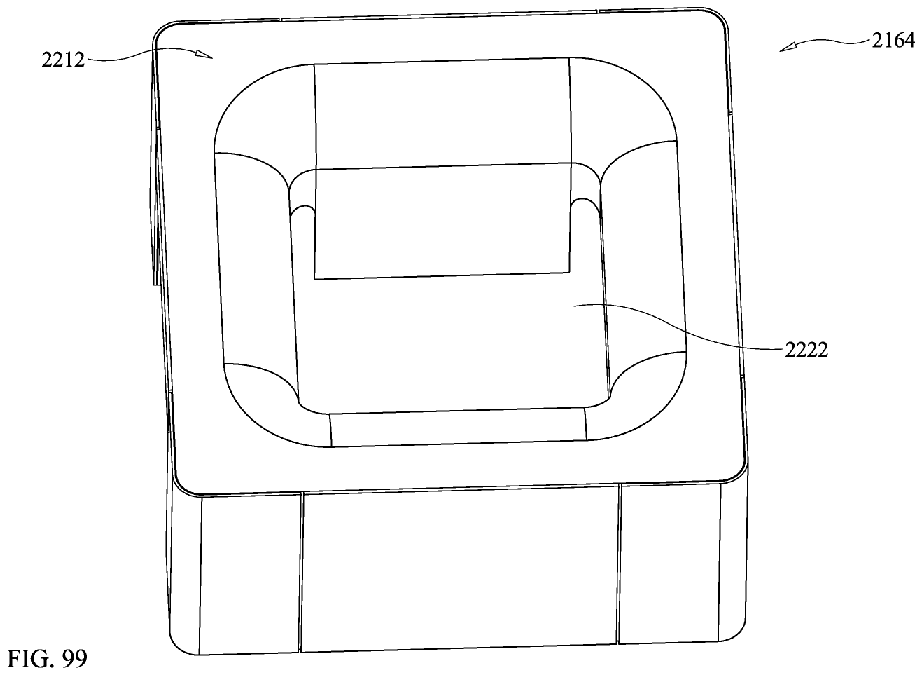

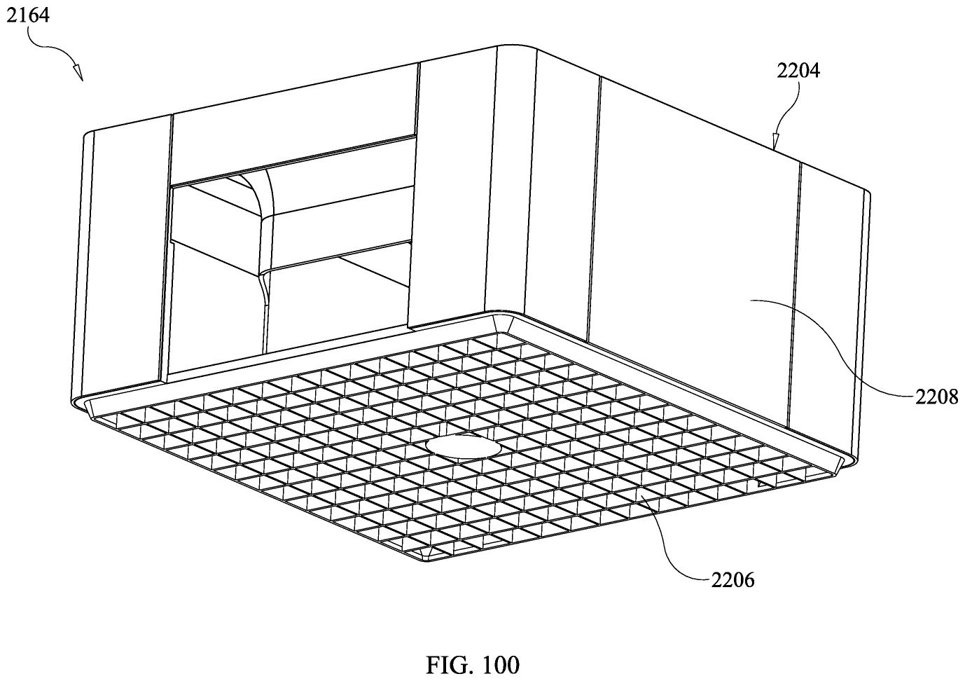

More specifically, as can be seen in FIGS. 93-95 of the drawings, the drone dock 2174 includes a main body 2176 having a first end 2178, an oppositely disposed second end 2180, a sidewall 2182 extending at least partially between the first end 2178 and the second end 2180, a top surface 2184 and a bottom surface 2186 situated opposite the top surface 2184. One or more support legs 2188 extend outwardly from the sidewall 2182. A brace 2190 is situated at a free end 2192 of the support leg 2188. The sidewall 2182 further includes a pair of diametrically opposed holes 2194 that are situated on opposite lateral sides of the main body 2176. The diametrically opposed holes 2194 receive a mounting pin 2196 that is affixed to the conveyor belt 2168, thereby pivotally or hingedly coupling the main body 2176 of the drone dock 2174 to the conveyor belt 2168.

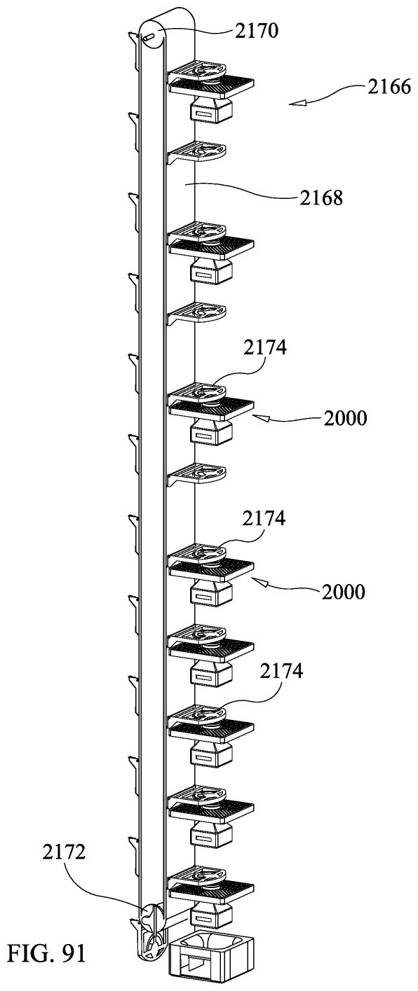

As can be seen in FIG. 91 of the drawings, as the conveyor belt is driven by the motorized drum 2172, for example in a clockwise direction, gravity causes the drone docks 2174 moving in the downward direction (e.g., towards the horizontal shuttle grid 200) to be in a horizontal orientation. More specifically, the pivotal or hinged connection between the main body 2176 and the mounting pin 2196 causes the drone docks 2174 moving in an upward direction (e.g., away from the shuttle grid 200) to flip from a vertical orientation to a horizontal orientation as they pass over pulley 2170 and start moving in the downward direction (e.g., towards the horizontal shuttle grid 200). After the drone docks 2174 pass over pulley 2170, gravity, in combination with the support legs 2188 and brace 2190 attached thereto, which are in contact with the conveyor belt 2168 as the drone docks 2174 move down toward the shuttle grid 200, maintain the drone docks 2174 in the horizontal orientation. As the drone docks 2174 approach the motorized drum 2172, the pivotal or hinged connection between the main body 2176 and the mounting pin 2196, in combination with gravity, causes the drone docks 2174 to flip from the horizontal orientation to the vertical orientation. The drone docks 2174 remain in the vertical orientation as they move upward (e.g., away from the horizontal shuttle grid 200) until they reach pulley 2170, at which point they are again flipped to the horizontal orientation. Pivoting the drone docks 2174 to the vertical orientation allows the drone loader 2166 to be more compact and take up less space in the logistics tower 2.

The drone dock 2174 may further include one or more bumpers 2198 that are mounted to the support legs 2188. Each bumper 2198 preferably includes one or more cushions 2200 that extend outwardly therefrom. As the drone dock 2174 flips from the vertical orientation to the horizontal orientation, the cushions 2200 extending from the bumper 2198 contact the conveyor belt 2168 before the braces 2190 affixed to the legs 2188, thereby decreasing any shock load on the drone dock 2174 caused by reorientation.

A switchable magnetic retention device 2202, such as a mechanically actuatable magnet (e.g., a Magswitch®) is mounted to the main body 2176 of the drone dock 2174 and extends outwardly from the bottom surface 2186 thereof. As will be explained in greater detail in the forthcoming paragraphs, the switchable magnetic retention device 2202 is selectively engageable with the docking magnet 2046 of the docking hub 2038 of the delivery drone 2000. A charge connector or inductance charging device may be situated on the switchable magnetic retention device 2202, or adjacent thereto, and engages the charging connector 2048 situated on the delivery drone's docking hub 2038 to recharge the at least one battery 2032 of the delivery drone 2000 as the drone is docked with the drone dock 2174, and as the delivery drone 2000 is moved downwardly towards the shuttle grid 200 by the conveyor belt 2168. The switchable magnetic retention device 2202 and the charge connector may be in electrical communication with the electric power system and computer systems of the logistics tower 2 via conductors embedded in the conveyor belt 2168 or the like.

As can be seen in FIGS. 87, 88 and 90 of the drawings, the delivery drone 2000 guides itself into the tower drone port 2136 situated at the top of the logistics tower 2 and enters the internal cavity 2156 of the tower drone port support 2152. The conveyor belt 2168 drives a drone dock 2174 over pulley 2170 and the drone dock 2174 is reoriented into the horizontal position. The switchable magnetic retention device 2202 is actuated and engages the docking magnet 2046 of the docking hub 2038 of the delivery drone 2000, thereby coupling the delivery drone 2000 to the drone dock 2174. The conveyor belt 2168 continues to lower the drone dock 2174 and delivery drone 2000 coupled thereto down towards the horizontal shuttle grid 200.

A shuttle 206 having a drone ferry 2164 situated thereon traverses the horizontal shuttle grid 200 and positions itself below the delivery drone 2000 coupled to the drone dock 2174. The conveyor belt 2168 lowers the delivery drone 2000 into the drone ferry 2164 by moving the drone dock 2174 coupled thereto down. When the delivery drone 2000 is situated on the drone ferry 2164 on the shuttle 206, the magnetic retention device 2202 is deactivated and the drone 2000 is decoupled from the drone dock 2174. The shuttle 206 then transports the delivery drone 2000 to a loading dock 970. The conveyor belt 2168 then drives the drone dock 2174 around the motorized drum 2172 and the drone dock 2174 is reoriented into the vertical position as it moves upward (e.g., away from the horizontal shuttle grid 200 and towards the drone port 2136 situated on the top of the logistics tower 2).

The shuttles 206 may also load delivery drones 2000 on the drone loader 2166 in a similar, but reverse manner. For example, the shuttle 206 may transport a delivery drone 2000 situated on the drone ferry 2164 to a location below a drone dock 2174 on the conveyor belt 2168. The switchable magnetic retention device 2202 is actuated and engages the docking magnet 2046 of the docking hub 2038 of the delivery drone 2000, thereby coupling the delivery drone 2000 to the drone dock 2174. The motorized drum 2172 then drives the conveyor belt 2168 in the opposite direction (e.g., in a counterclockwise direction) and the delivery drone 2000 is withdrawn from the drone ferry 2164 on the shuttle 206 and is moved upward (e.g., away from the horizontal shuttle grid 200 and towards the drone port 2136 situated on the top of the logistics tower 2). When the delivery drone 2000 is situated at the top of the drone loader 2166, the magnetic retention device 2202 is deactivated, decoupling the delivery drone 2000 from the drone dock 2174, and the delivery drone 2000 exits the drone port 2136 along a flightpath to another destination.

Similarly, the robotic bin handler 410 of the vertical retrieval system 20 may retrieve a delivery drone 2000 from a drone ferry 2164 situated on a shuttle 206 positioned under the robotic bin handler 410. More specifically, the carriage 800 then engages the drone 2000 and the winch 265 moves the robotic bin handler 410 and delivery drone 2000 coupled thereto upward (e.g., away from the horizontal shuttle grid 2000) to the drone port 2136 situated on the side of the logistics tower 2. The carriage 800 is then extended through the opening in the frame 402 of the logistics tower 2 into the tower drone port 2136. The carriage 800 is then decoupled from the delivery drone 2000 and the delivery drone 2000 exits the drone port 2136 and follows a flightpath to another destination. The drone receptacle 2212 may be formed as an integral part of the drone ferry 2164 or as a separate component that is joined to the drone ferry 2164.

As can be seen in Figured 97-102 of the drawings, the drone ferry 2164 includes a top end 2204, a closed bottom end 2206 and a sidewall 2208 extending therebetween, the top end 2204, the sidewall 2208 and the bottom end 2206 defining an internal cavity 2210 or compartment into which at least a portion of the delivery drone 2000 is received. A drone receptacle 2212 is situated in proximity to the top end 2204 and extends at least partially into the internal cavity 2210 of the drone ferry 2164. The drone receptacle 2212 is similar in structure and function to the drone docking tray 2114.

More specifically, the drone receptacle 2212 at least partially covers the internal cavity 2210 of the drone ferry 2164. The drone receptacle 2212 preferably includes a top portion 2214 and a bottom portion 2216 and a sidewall 2218 extending therebetween. The sidewall 2218 of the drone receptacle 2212 includes a lip 2220 extending inwardly therefrom at least partially around the periphery thereof in proximity to the top portion 2214. At least a portion of the sidewall 2218 is preferably tapered to guide the delivery drone 2000 into the drone ferry 2164 and securely retain the drone 2000 in place. The sidewall 2218 of the drone receptacle 2212 defines an opening 2222 that extends between the top portion 2114 and the bottom portion 2216 thereof, the opening 2222 being in communication with the internal cavity 2210 of the drone ferry 2164.

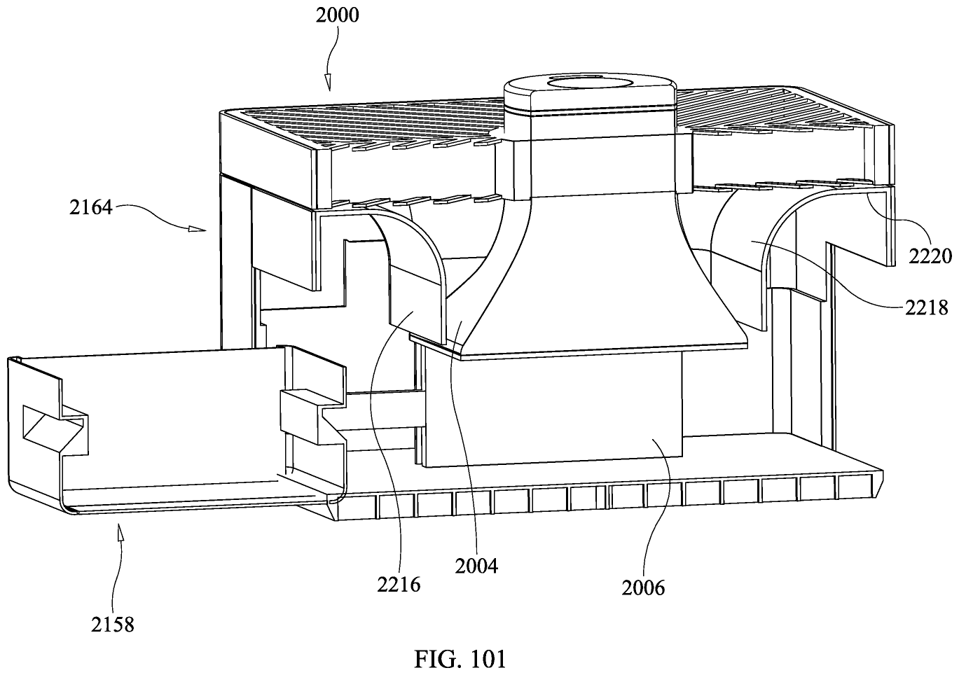

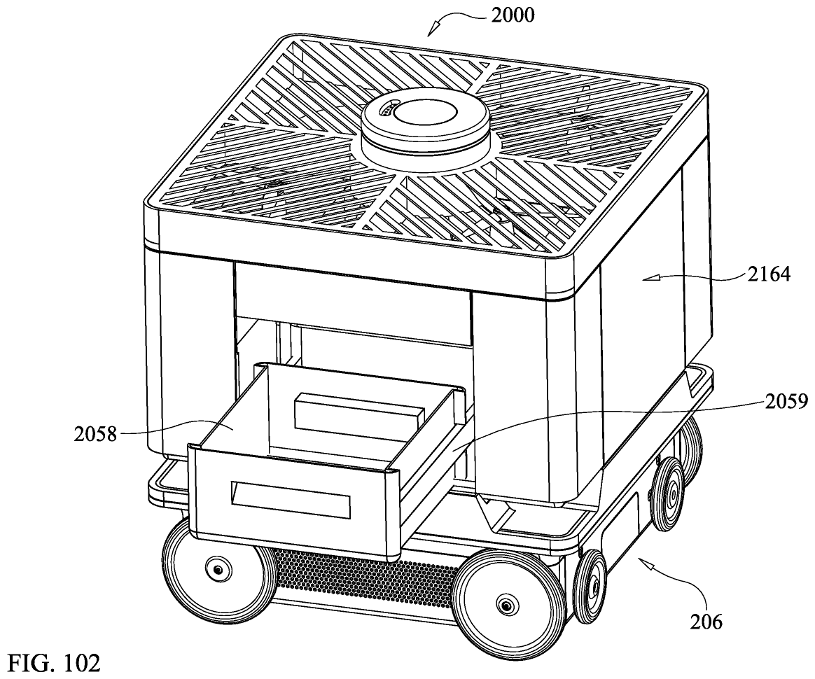

As can be seen in FIG. 91 of the drawings, the delivery drone 2000 is lowered onto the drone ferry 2164, for example, by the conveyor belt 2168 or the robotic bin hander 410, and docks with the drone receptacle 2212 such that the sidewall 2010 of the airframe 2002 rests on the lip 2220 of the receptacle 2212. When the drone 2000 is docked with the drone receptacle 2212, the drive module 2004 and storage module 2006 extend into the opening 2222. As can be seen in FIG. 101 of the drawings, when the drone 2000 is docked with the receptacle 2212, at least a portion of the storage module 2006 extends outwardly from the bottom portion 2216 of the receptacle 2212 and into the internal cavity 2210 of the drone ferry 2164. Preferably, the receptacle 2212 is formed so that the drawer 2158 of the storage module 2006 is situated below the bottom portion 2216 of the receptacle 2212 when the drone 2000 is docked therewith.

The sidewall 2208 of the drone ferry preferably includes one or more storage compartment access ports 2224, each of which is formed as an opening through the sidewall 2208 that extends into the internal cavity 2210 of the drone ferry 2164. The storage compartment access port is situated on the sidewall 2158 so that it is aligned with the drawer 2158 of the delivery drone 2000 when the drone 2000 is docked with the receptacle 2212. When the drone 2000 is docked with the receptacle 2212, a user or articulated robotic arm 976 may reach through the storage compartment access port 2224 and withdraw the drawer 2158 at least partially from the storage module 2006 of the delivery drone 2000 to add items/parcels. After the drawer 2158 is loaded, the user or articulated robotic arm 976 pushes the drawer 2158 back into the storage module 2006 of the delivery drone 2000. The sidewall 2208 may include multiple storage compartment access ports that are situated on the sidewall 2158 such that they are aligned with a delivery drone 2000 that has multiple drawers 2158 in the storage compartment 2006. The storage compartment access port 2224 provides a safe way to access the delivery drone 2000 on the drone ferry 2164, without needing to interact with the top of the delivery drone 2000. This leads to a safe loading environment for the user or articulated robotic arm 976 loading the delivery drone 2000.

As described above, the drone ferry 2164 is situated on the shuttle 206 and transported by the shuttle 206 on the horizontal shuttle grid 200 of the logistics tower 2. As will be described in the forthcoming pages with respect to the structure and operation of the logistics tower 2 and the components thereof, when a new order is processed by the central control system 136, the order is routed to a particular loading dock 970. The vertical retrieval system 20 of the logistics tower 2 retrieves storage bins 16 from the vertical storage cell columns 418 containing the contents of the order. The storage bins 16 are lowered to the shuttles 206 on the horizontal shuttle grid 200 of the horizontal shuttle system 202. The shuttles 206 traverse the horizontal shuttle grid 200 of the horizontal shuttle system 202 to the loading dock 970.

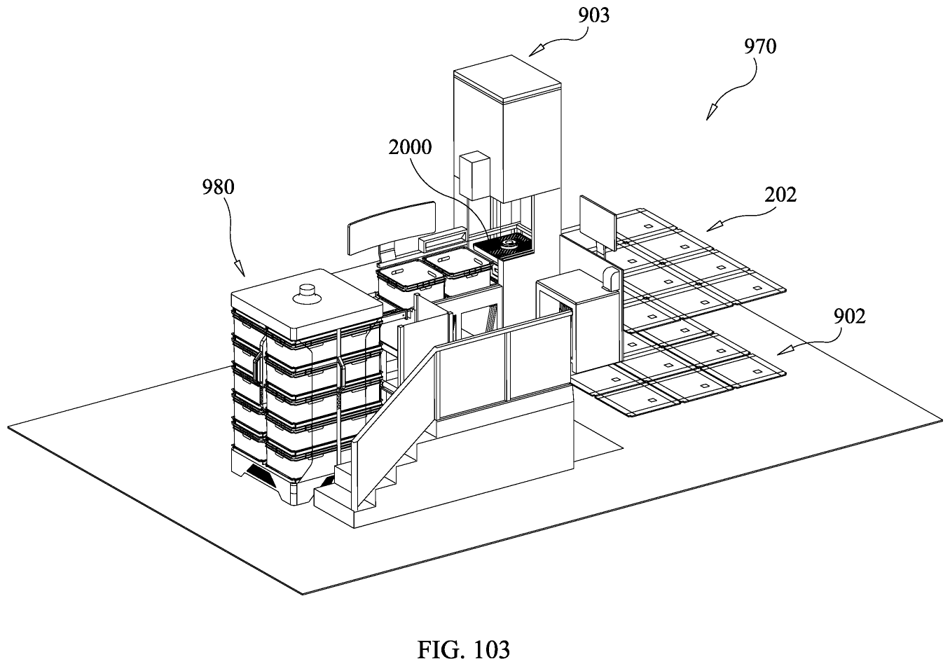

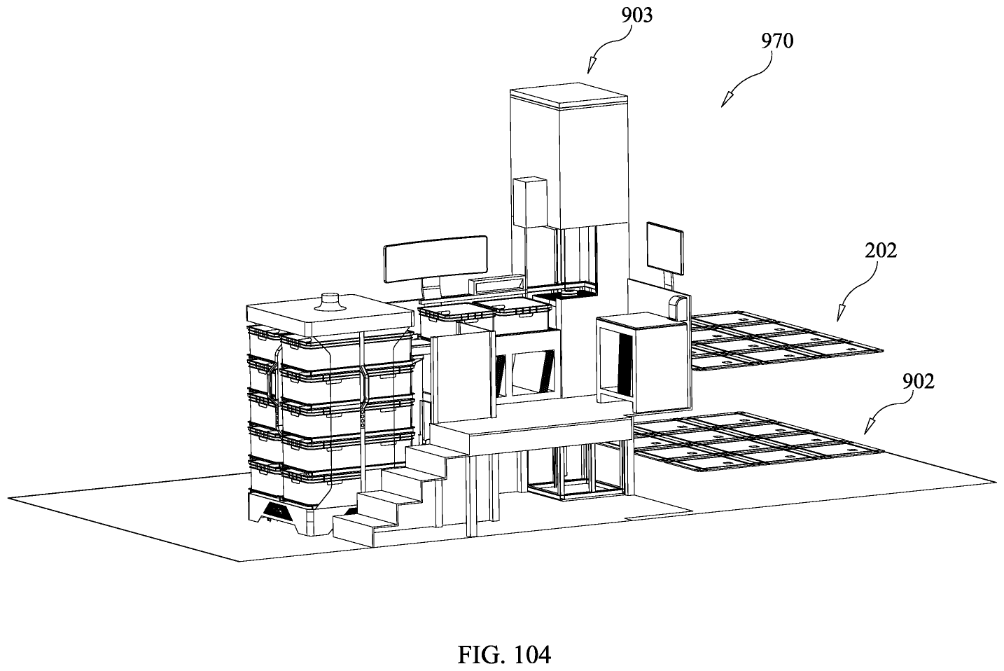

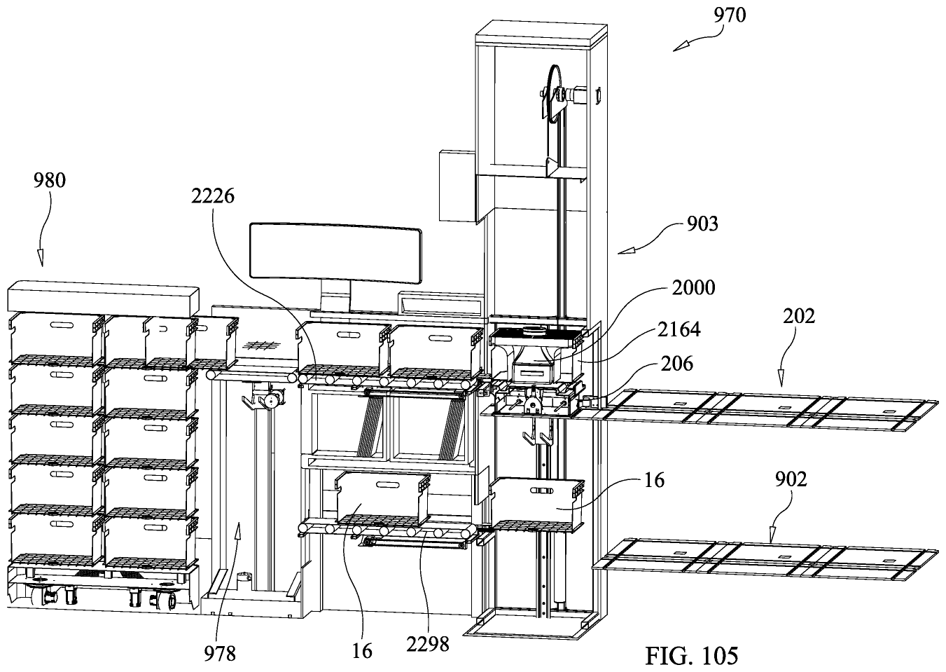

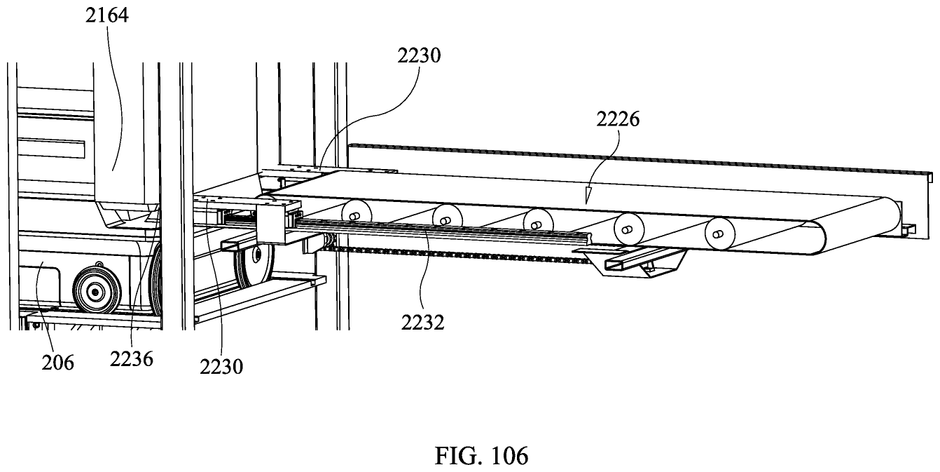

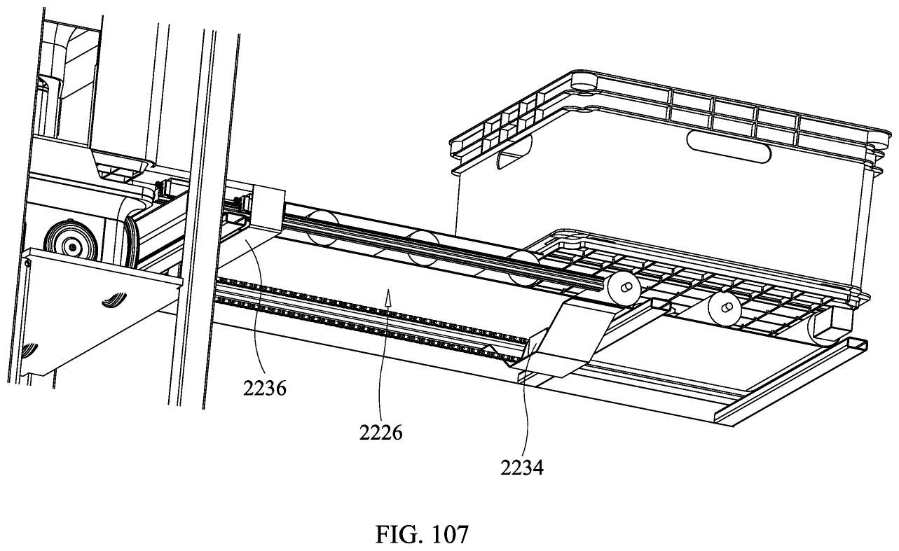

A preferred form of the loading dock 970 is shown in FIGS. 103-107 of the drawings and includes at least one active elevator 903, at least one storage bin elevator lift 978, a first conveyor 2226 and a second conveyor 2228. As described above, when a new order is placed, the vertical retrieval system 20 retrieves the storage bins 16 containing the items that make up the order from the logistics tower 2. The shuttles 206 transport the storage bins 16 to the elevator 903 which raises or lowers the shuttles 206 containing the storage bins 16 to either the first conveyor 2226 or the second conveyor 2228. Another shuttle 206 then transports the drone ferry 2164 and delivery drone 2000 situated thereon to the elevator 903. The elevator 903 raises or lowers the drone ferry 2164 to one of the first conveyor 2226 and the second conveyor 2228. One or more of the first conveyor 2226 and the second conveyor 2228 may also include two extensions 2230 on linear rails 2232 powered by a motor 2234 that extend out into channels 2236 in the drone ferry 2164. In one form, the motor 2234 may drive a bracket 2236 that is coupled to the extensions 2230. The shuttle 206 then makes a wheel adjustment (by default) that lowers the shuttle 206 approximately an inch. When the shuttle 206 is in its lower position, the drone ferry 2164 can be pulled off the shuttle 206 by the linear rail extensions 2230.

The user or articulated robotic arm 976 loads the drawer 2158 of the delivery drone 2000 with the ordered items contained within the storage bins 16 on the conveyors 2226, 2228. Thereafter, the shuttle 206 transports the drone ferry 2164 and loaded delivery drone 2000 to an exit shaft, which may merely be an unused storage column 403, a robotic bin handler 410 or the drone loader 2166. When the drone 2000 is positioned below an exit shaft by the shuttle 206 on the horizontal shuttle grid 200, the drone 2000 undocks from the drone ferry 2164 and follows a flightpath out of the exit shaft to a particular destination. As described above, the drone 2000 may also be coupled to the drone dock 2174 of the drone loader 2166 and moved up towards the tower drone port 2136 situated on the top of the logistics tower 2, where the drone 2000 exits and follows a flight path to a particular destination. As also described above, the robotic bin handler 410 may remove the drone 2000 from the drone ferry 2164 and move the drone 2000 to the tower drone port 2136 situated on the side of the logistics tower 2 where the drone 2000 exits and travels along a flightpath to a particular destination.

The automated delivery system formed in accordance with the present invention includes one more scalable logistics towers 2, one or more drone ports 2062 situated at remote structures (e.g., a house, a store or other residential or commercial structure) and at least one delivery drone 2000. A method of delivering goods utilizing the automated system disclosed herein is also provided and comprises one or more of the steps of: receiving an order, retrieving the order items from the logistics tower 2 with the vertical retrieval system 20, transporting storage bins 16 containing the items making up the order with the shuttle 206 to a loading dock 970; transporting the delivery drone 2000 to the loading dock 970 with the shuttle 206; loading the delivery drone 2000 with the ordered items from the retrieved storage bins 16; delivering the ordered items to a drone port 262 at a particular destination with the delivery drone 2000.

As described above, the delivery drones 2000 may also pick up ordered items from one drone port 2062 (e.g., a drone port 2062 at a local store) and transport the ordered items to a second drone port 2062 (e.g., a drone port 2062 at a house), the method of which includes the steps of: receiving a new order from a user; determining the drone port 2062 containing the items of the order; creating a flightpath for the delivery drone; sending the delivery drone 2000 along the flightpath to the drone port 2062 containing the ordered items; loading the delivery drone 2000 with the ordered items; transporting the ordered items with the delivery drone 2000 along a flightpath to a predetermined second drone port 2062.

In a reverse manner, the delivery drones 2000 may pick up parcels at drone ports 2062, for example at local businesses, and return them to the logistics tower 2. The drones 2000 enter the logistics tower 2 as described above and the shuttles 206 transport the drones to the loading station 970. While at a loading station 970, the user or an articulating robotic arm 976 open the drawer 2058 and unload the parcels/items therein. The items are then loaded into one or more storage bins 16 and loaded into the logistics tower 2 by the shuttles 206 and vertical retrieval system 20.

A description of an exemplary logistics tower 2 that may utilize the drone delivery system formed in accordance with the present invention is described below:

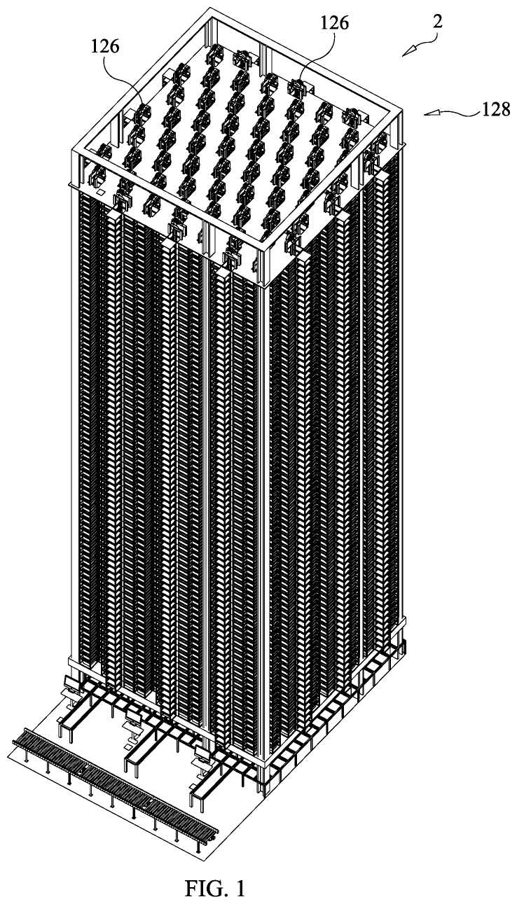

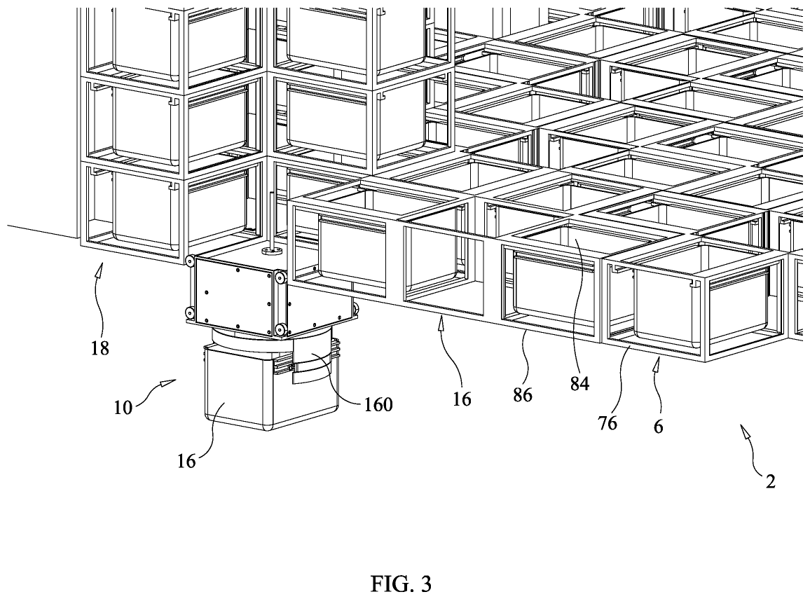

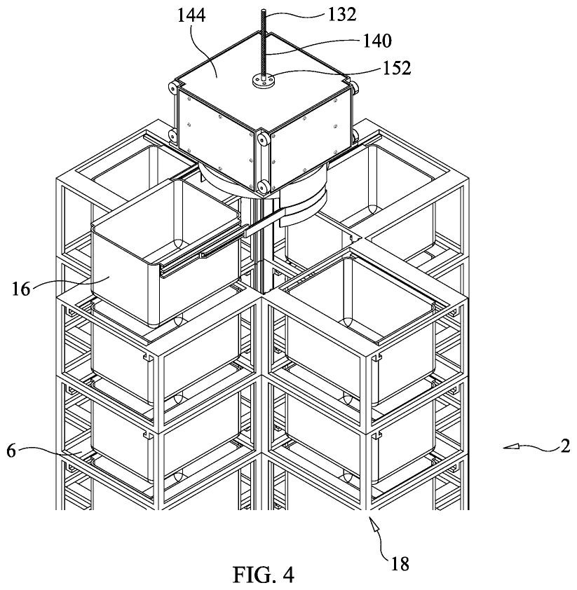

Initially referring to FIGS. 1-5 of the drawings, the scalable logistics tower 2 formed in accordance with a first embodiment of the present invention preferably includes a plurality of storage cells 4. Each storage cell 4 includes a plurality of storage modules 6 arranged around an elevator shaft 8 through which a robotic bin handler 10 traverses. The storage module 6 generally includes an outer frame 12 defining an internal cavity 14 or compartment into which a storage bin 16 is received. In a preferred form, each storage cell 4 includes four storage modules 6 arranged around the elevator shaft 8.

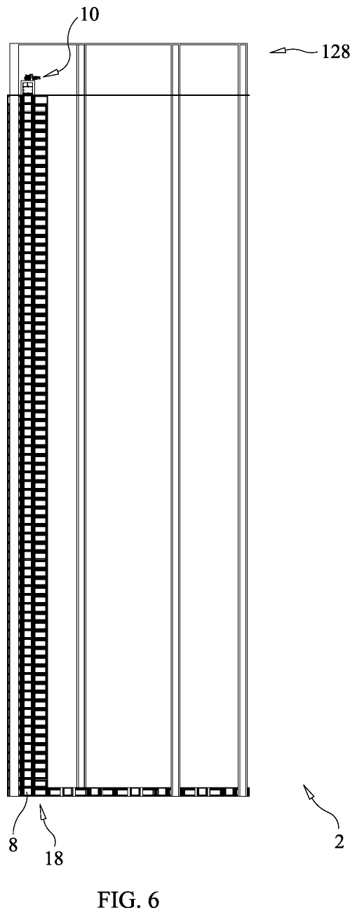

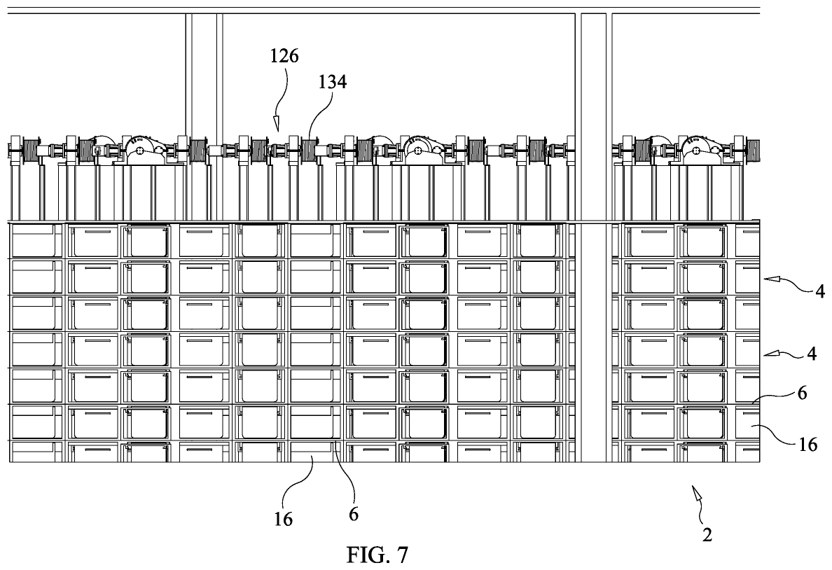

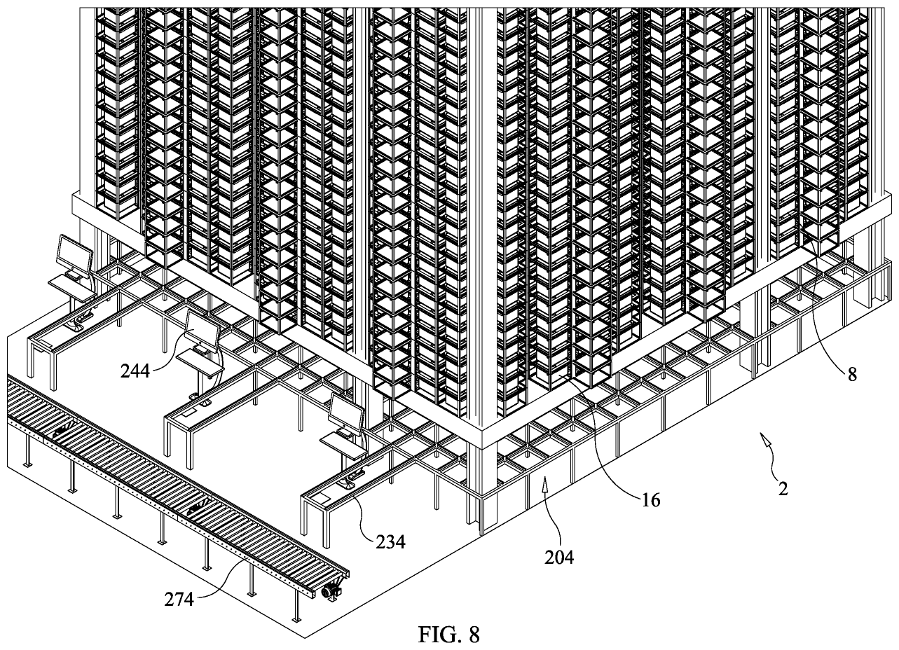

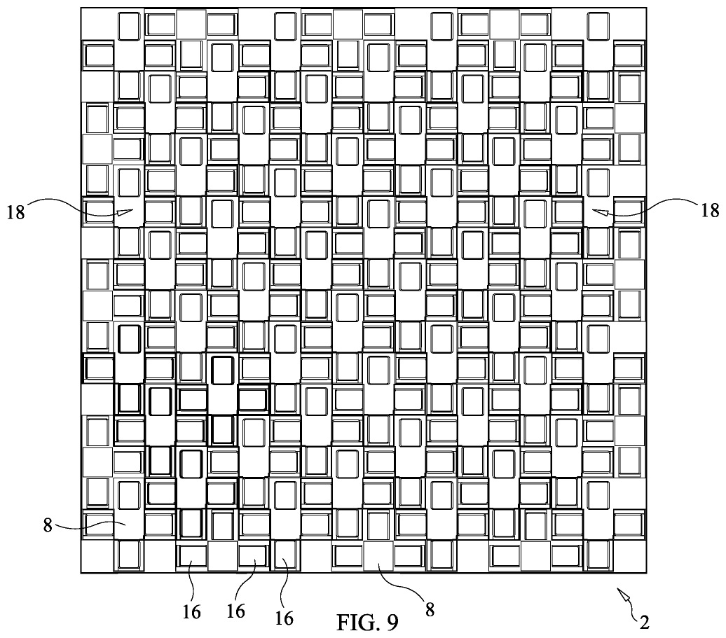

As can be seen in FIGS. 6-8 of the drawings, the storage cells 4 may be stacked on one another in a vertical orientation to increase the storage capacity of the logistics tower 2. More specifically, a plurality of storage cells 4 can be stacked on one another to form a vertical storage cell column 18. The storage modules 6 and elevator shaft 8 of each storage cell 4 of the vertical storage cell column 18 are aligned such that a vertical retrieval system 20 can selectively remove and insert storage bins 16 from each of the storage modules 6 in the vertical storage cell column 18. Depending on any land variances and zoning laws of the parcel on which the logistics tower 2 is situated (e.g., the size of the parcel where the logistics tower 2 is located), additional storage cells 4 or additional vertical storage cell columns 18 can be added in a grid-like pattern within the logistics tower 2 to increase the storage capacity thereof, as shown in FIG. 9 of the drawings. Accordingly, the logistics tower 2 formed in accordance with present invention can be both vertically scaled and horizontally scaled to maximize the storage capacity thereof.

For example, if the parcel has variances prohibiting structures over a certain height, the logistics tower 2 may be horizontally scaled to maximize storage capacity by adding additional vertical storage cell columns 18 of storage cells 4. If there are no height restrictions on the parcel where the logistics tower 2 is constructed, but the footprint of the property is small, the logistics tower 2 may be vertically scaled by increasing the number of storage cells 4 in the vertical storage cell columns 18 to maximize storage capacity. As explained previously, the number of storage modules 6 in each storage cell 4 can be adjusted. Accordingly, to maximize the storage capacity of the logistics tower 2, some vertical storage cell columns 18 may comprise storage cells 4 having three storage modules 6 while other vertical storage cell columns 18 in the logistics tower 2 may comprise storage cells 4 having four storage modules 6.

In an exemplary form, as shown in FIG. 9 of the drawings, the logistics tower 2 may be configured such that it has 64 vertical storage cell columns 18 and 64 robotic bin handlers 10. Some of the vertical storage cell columns 18 comprise storage cells 4 having three storage modules 6 while other vertical storage cell columns 18 comprise storage cells 4 having four storage modules 6. Each vertical storage cell column 18 has 75 storage cells 4 such that the logistics tower 2 has 75 storage levels. As can be seen in FIG. 9 of the drawings, each storage level has 244 storage bins 16 such that the logistics tower 2 has a total capacity of 18,300 storage bins 16.

The storage capacity of the logistics tower 2 can be varied depending on the shape of the logistics tower 2, any height restrictions on the logistics tower 2 and the footprint of the logistics tower 2 by varying the number of vertical storage cell columns 18, the number of storage cells 4 in each vertical storage cell column 18 or the number of storage modules 6 in each storage cell 4. Additionally, if the logistics tower 2 has a shape that is not square or rectangular, some portions of the logistics tower 2 can be filled with vertical storage cell columns 18 having a first number of storage cells 4 (e.g., storage cell levels) while other portions of the logistics tower 2 can be filled with vertical storage cell columns 18 having a second number of storage cells 4 (e.g., storage cell levels). For example, the logistics tower 2 may have a first portion extending to a first height and a second portion extending to a second height. Accordingly, various storage cells 4 and vertical storage cell columns 18 can be arranged in the logistics tower 2 depending on the shape and dimensions thereof.

The storage bin 16 includes an open top end 22, a closed bottom end 24 and a sidewall 26 extending therebetween, the open top end 22, the sidewall 26 and the bottom end 24 defining an internal cavity 28 or compartment into which at least one parcel or item is received. A plurality of flanges comprising at least a first flange 30 and a second flange 32 extend outwardly from the sidewall 26 at least partially around the periphery of the storage bin 16. The first flange 30 and the second flange 32 are situated in proximity to the open top end 22 of the storage bin 16. The first flange 30 and the second flange 32 define a channel 34 therebetween that extends at least partially around the periphery of the storage bin 16. A plurality of ridges 36 extend outwardly from the sidewall 26 of the storage bin 16 between the first flange 30 and the second flange 32. The ridges 36 divide the channel 34 into a plurality of receptacles 38 that are engaged by the robotic bin handler 10. The storage bin 16 may further include a mounting flange 42 situated in proximity to the bottom end 24 thereof. The mounting flange 42 extends outwardly from the sidewall 26 at least partially around the periphery of the storage bin 16. The storage bin 16 formed in accordance with the present invention may be constructed using standard manufacturing techniques, such as molding.

The storage bin 16 is generally rectangular or square in shape and includes a first sidewall 44, a second sidewall 46, a third sidewall 48 and a fourth sidewall 50, each of which extends between the closed bottom end 24 and the open top end 22. The first sidewall 44 is situated opposite and generally parallel to the third sidewall 48, and the second sidewall 46 is situated opposite and generally parallel to the fourth sidewall 50. Preferably, one receptacle 38 is situated on each of the second sidewall 44 and the fourth sidewall 48.

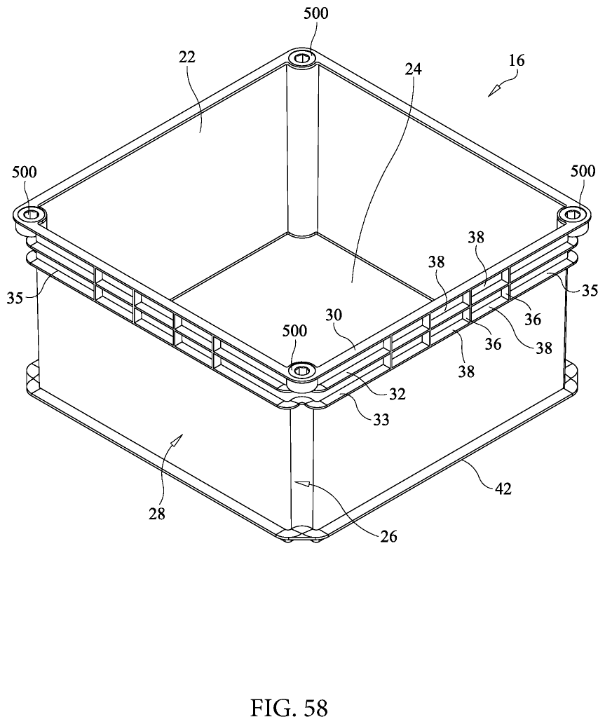

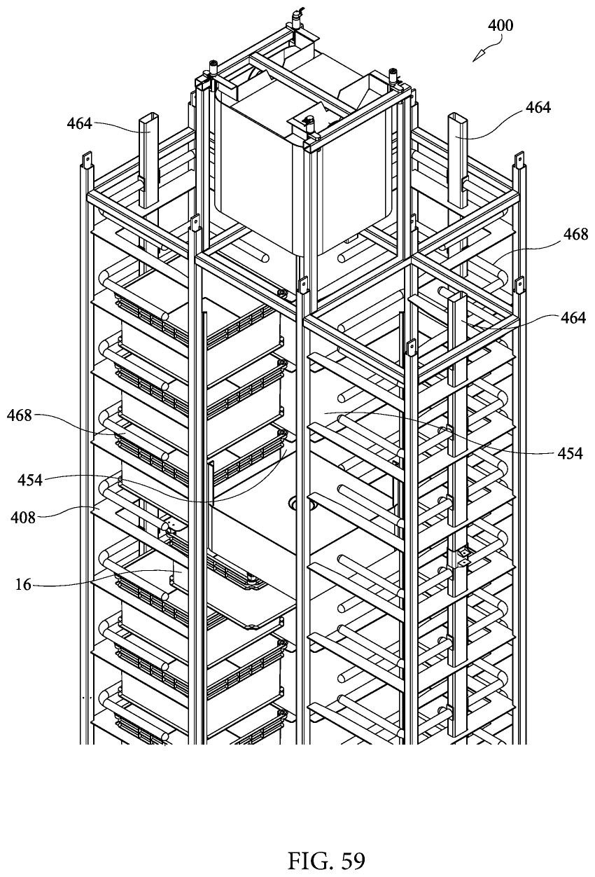

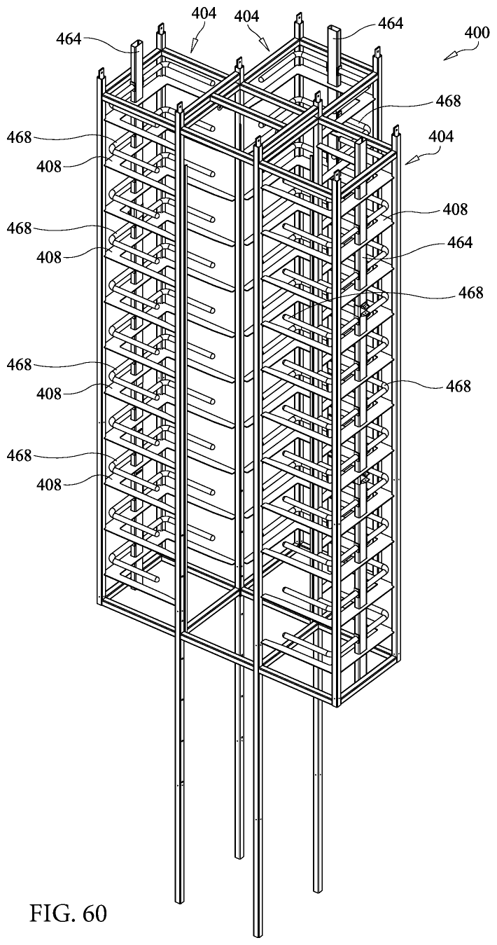

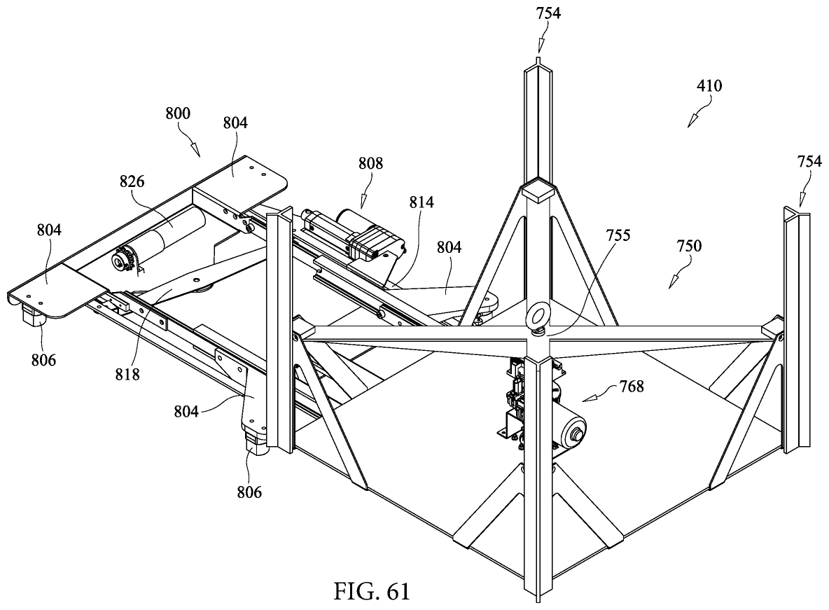

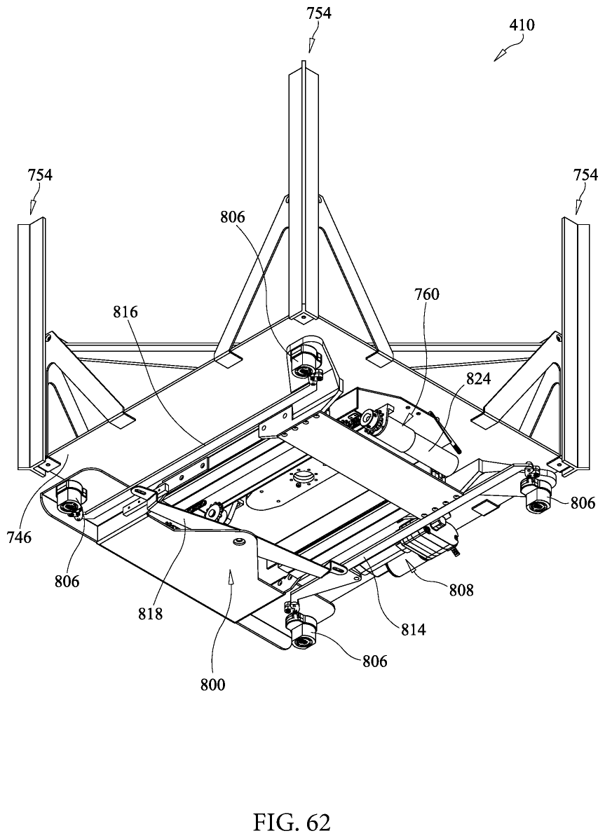

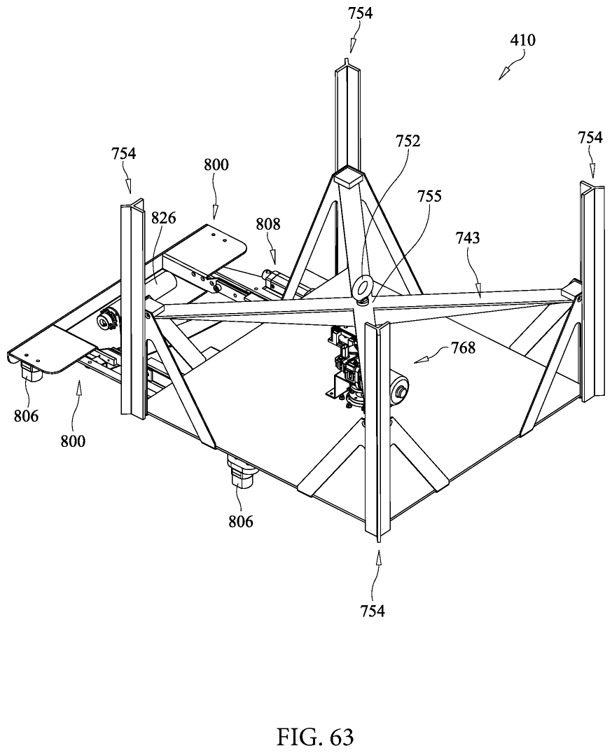

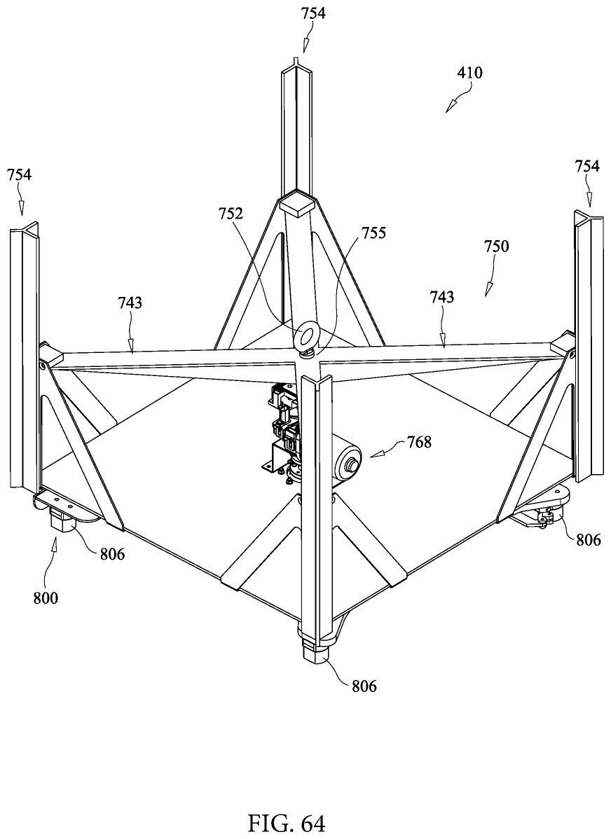

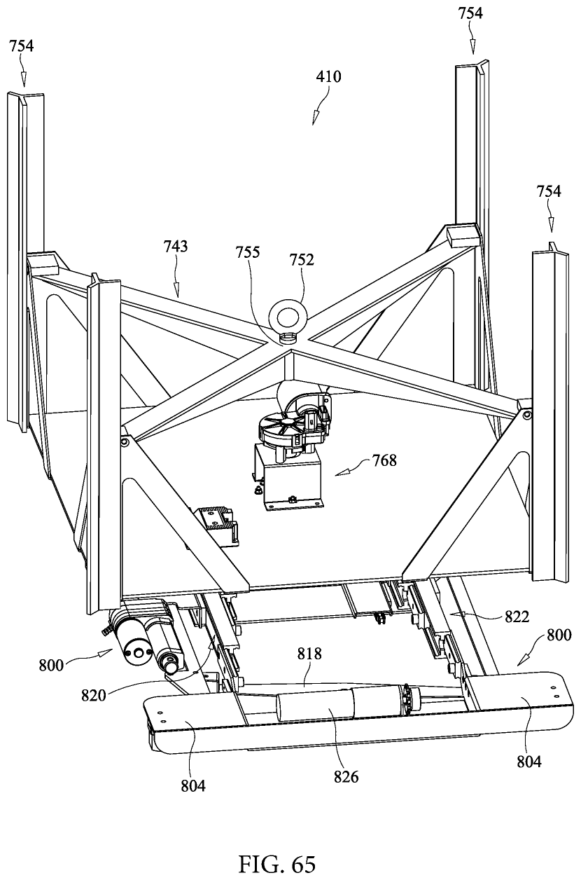

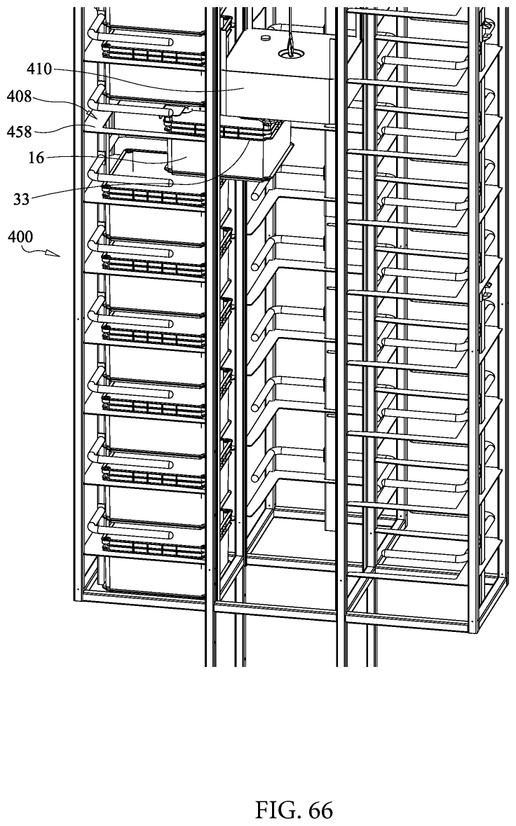

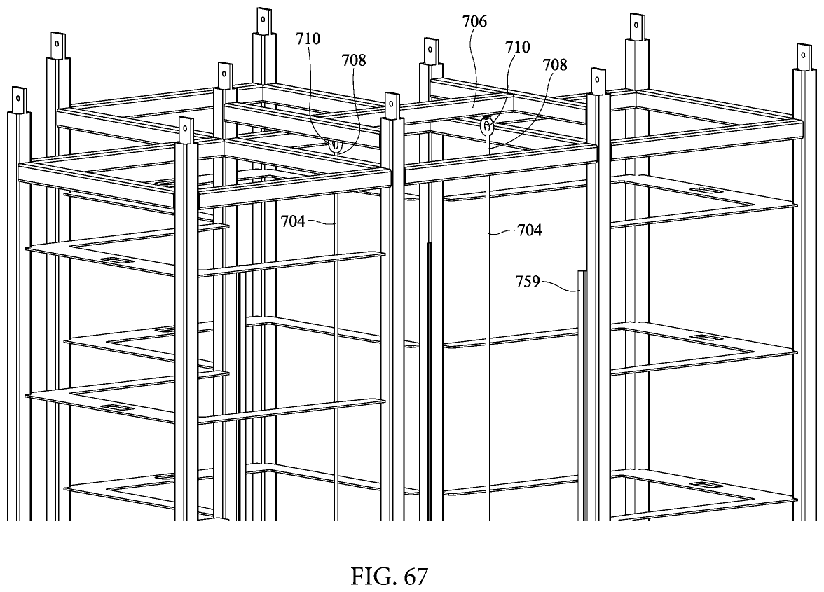

As can be seen in FIG. 58 of the drawings, in another form, the storage bin 16 includes a third flange 33 that extends outwardly from the sidewall 26 at least partially around the periphery of the storage bin 16. The third flange 33 is situated in proximity to the open top end 22 of the storage bin 16. The third flange 33 and the second flange 32 define a channel 35 therebetween that extends at least partially around the periphery of the storage bin 16. The ridges 36 extend outwardly from the sidewall 26 of the storage bin 16 between the first flange 30, the second flange 32 and the third flange 33. The ridges 36 divide the channels 34, 35 into a plurality of receptacles 38 that are engaged by the robotic bin handler 10. A plurality of metal lugs 500, preferably steel lugs, are formed around the periphery of the storage bin 16, preferably in proximity to the open top end 22 that are engageable by complementary magnets 806 situated on the robotic bin handler 410.

It is envisioned to be within the scope of the present invention to form the storage bin 16 as any type of container or packaging capable of holding goods.

Each storage module 6 preferably includes an outer frame 12 defining an internal cavity 14 or compartment into which a storage bin 16 is received. In one form, the outer frame 12 comprises a plurality of vertical members 52 and horizontal members 54. More specifically, the outer frame 12 includes a first vertical member 56, a second vertical member 58, a third vertical member 60 and a fourth vertical member 62, each of the first through fourth vertical members 56, 58, 60, 62 having a first axial end 64 and an oppositely disposed second axial end 66.

A first horizontal member 68 interconnects the first axial ends 64 of the first vertical member 56 and the second vertical member 58. A second horizontal member 70 interconnects the first axial ends 64 of the second vertical member 58 and the third vertical member 60. A third horizontal member 72 interconnects the first axial ends 64 of the third vertical member 60 and the fourth vertical member 62. A fourth horizontal member 74 interconnects the first axial ends 64 of the fourth vertical member 62 and the first vertical member 56. A fifth horizontal member 76 interconnects the second axial ends 66 of the first vertical member 56 and the second vertical member 58. A sixth horizontal member 78 interconnects the second axial ends 66 of the second vertical member 58 and the third vertical member 60. A seventh horizontal member 80 interconnects the second axial ends 66 of the third vertical member 60 and the fourth vertical member 62. An eighth horizontal member 82 interconnects the second axial ends 66 of the fourth vertical member 62 and the first vertical member 56.

The first through fourth horizontal members 68, 70, 72, 74 define a top side 84 of the storage module 6 and the fifth through eighth horizontal members 76, 78, 80, 82 define a bottom side 86 of the storage module 6. The first vertical member 56, first horizontal member 68, second vertical member 58 and fifth horizontal member 76 define a rear side 88 of the storage module 6. The third vertical member 60, third horizontal member 72, fourth vertical member 62 and seventh horizontal member 80 define a front side 90 of the storage module 6. The second vertical member 58, second horizontal member 70, third vertical member 60 and sixth horizontal member 78 define a first lateral side 92 of the storage module 6. The fourth vertical member 62, fourth horizontal member 74, first vertical member 56 and eighth horizontal member 82 define a second lateral side 94 of the storage module 6.

The rear side 88 of the storage module 6 is situated opposite to the front side 90 of the storage module 6, the first lateral side 92 of the storage module 6 is situated opposite to the second lateral side 94 of the storage module 6 and the top side 84 of the storage module 6 is situated opposite to the bottom side 86 of the storage module 6. Preferably, the front side 90 of the storage module 6 is open so that a storage bin 16 may be inserted therethrough and withdrawn therefrom by the robotic bin handler 10; however, other sides of the storage module 6 may also be open. For example, to conserve materials and weight, each of the sides (e.g., the top side 84, the bottom side 86, the front side 90, the rear side 88, the first lateral side 92 and the second lateral side 94) of the storage module 6 may be open.

The storage module 6 and the storage bin 16 are generally complementary in shape so that the storage bin 16 can be situated within the internal cavity 14 or compartment thereof. The storage module 6 includes a storage bin support 96. In one form, the storage bin support 96 includes a first elongated member 98 and a second elongated member 100 on which the second flange 32 of the storage bin 16 rests when the storage bin 16 is situated within the internal cavity 14 of the storage module 6.

More specifically, each of the first elongated member 98 and the second elongated member 100 includes a first axial end and an oppositely disposed second axial end. The first elongated member 98 extends between the first vertical member 56 and the fourth vertical member 62 and is generally parallel to the fourth horizontal member 64 and eighth horizontal member 82. At least a portion of the first elongated member 98 extends inwardly into the internal cavity 14 of the storage module 6 and has a top surface 106 on which the second flange 32 of the storage bin 16 rests. The second elongated member 100 extends between the second vertical member 58 and the third vertical member 60 and is generally parallel to the second horizontal member 70 and the sixth horizontal member 78. At least a portion of the second elongated member 100 extends inwardly into the internal cavity 14 of the storage module 6 and has a top surface 108 on which the second flange 32 of the storage bin 16 rests.

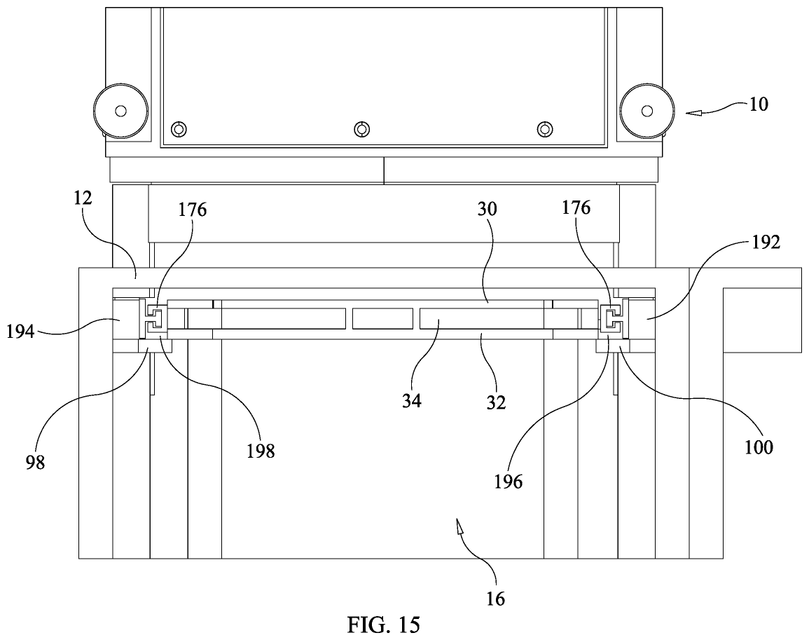

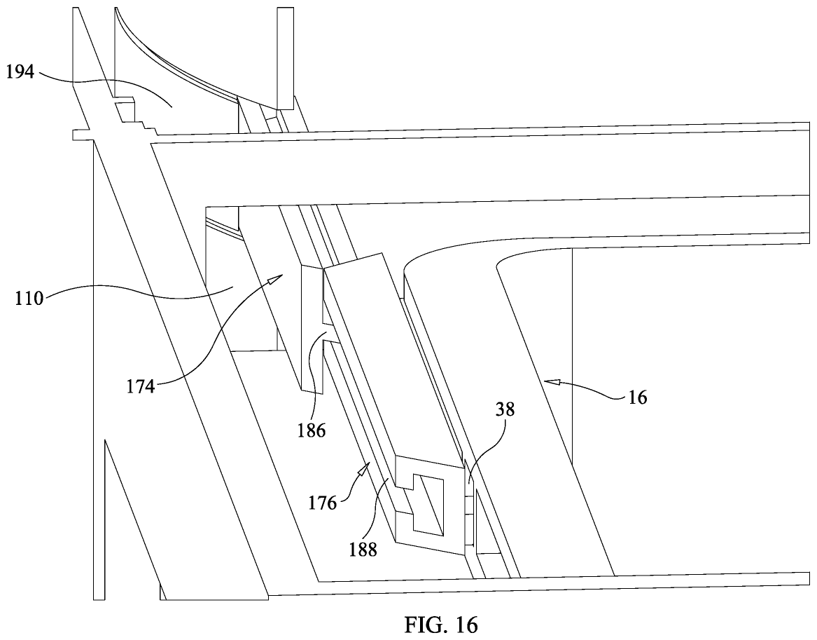

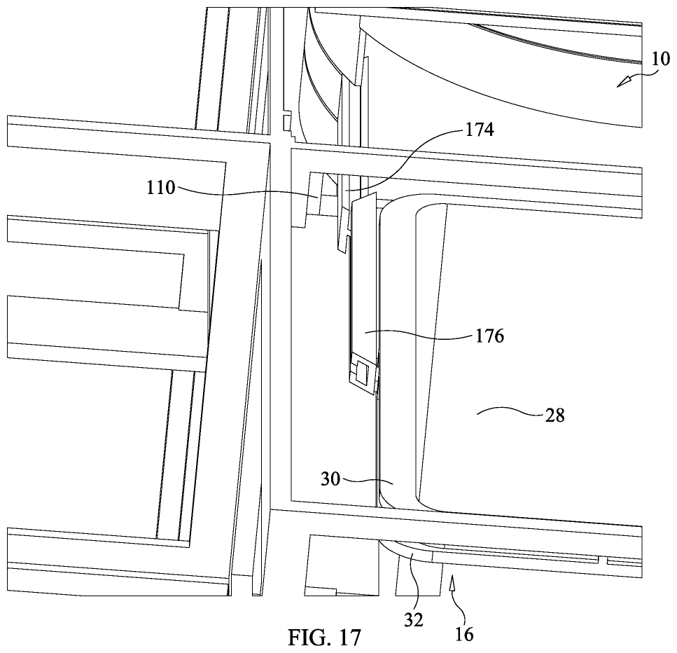

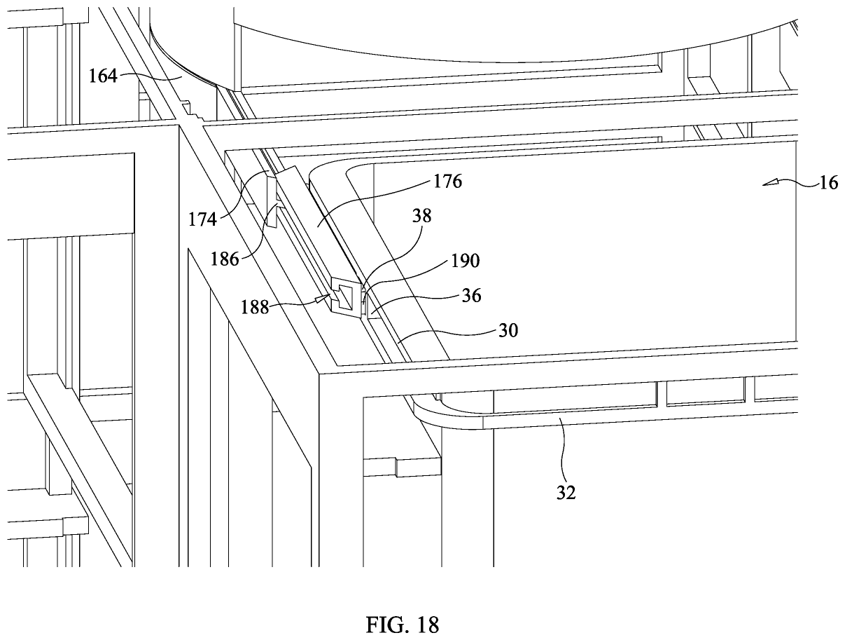

The first elongated member 98 and the second elongated member 100 may also be formed as part of the second horizontal member 70 and fourth horizontal member 74, respectively. As can be seen in FIGS. 15-18 of the drawings, when the storage bin 16 is situated in the storage module 6, the outer frame 12 of the storage module 6 and the flanges 30, 32 of the storage bin 16 define a space 110 therebetween. As will be described in greater detail in the forthcoming paragraphs, the rail slides 172 of the robotic bin handler 10 are inserted and withdrawn from the space 110 to insert and withdraw the storage bin 16 from the storage module 6.

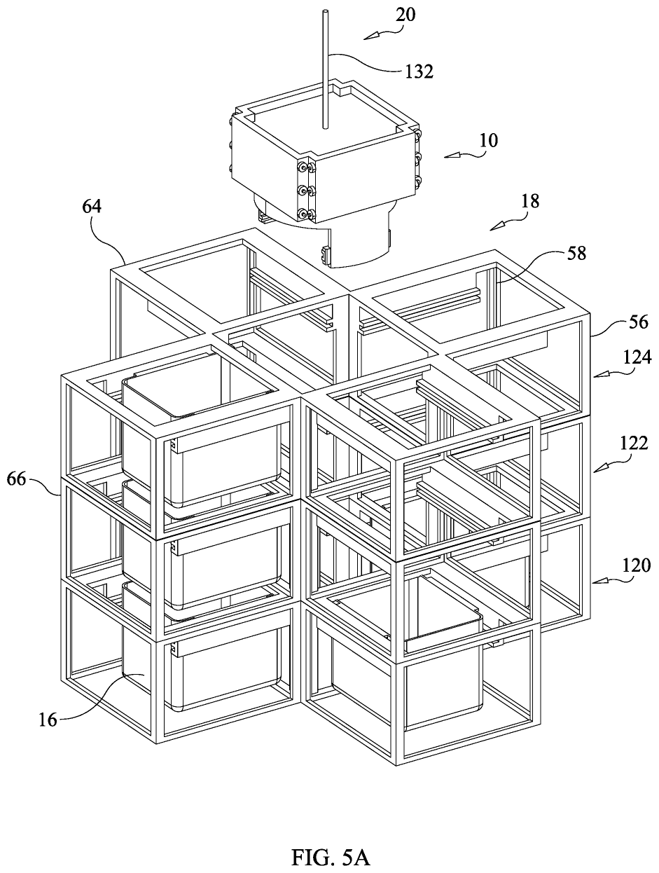

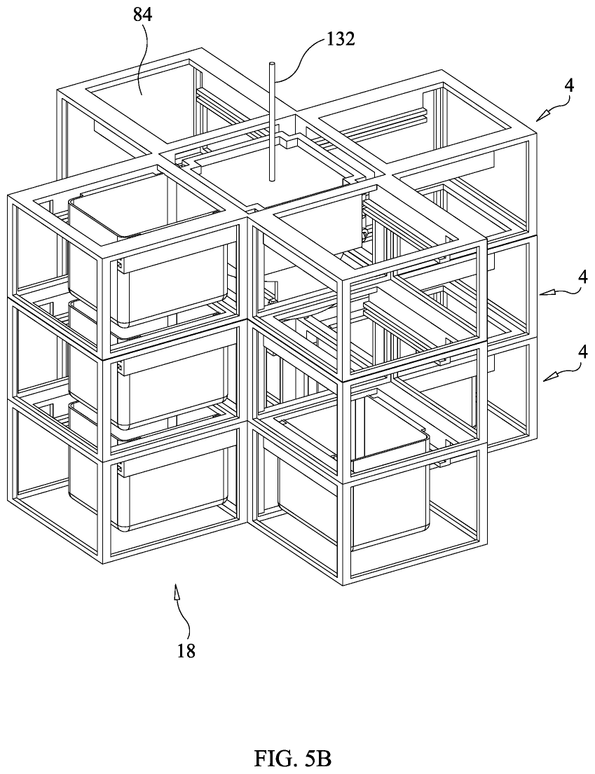

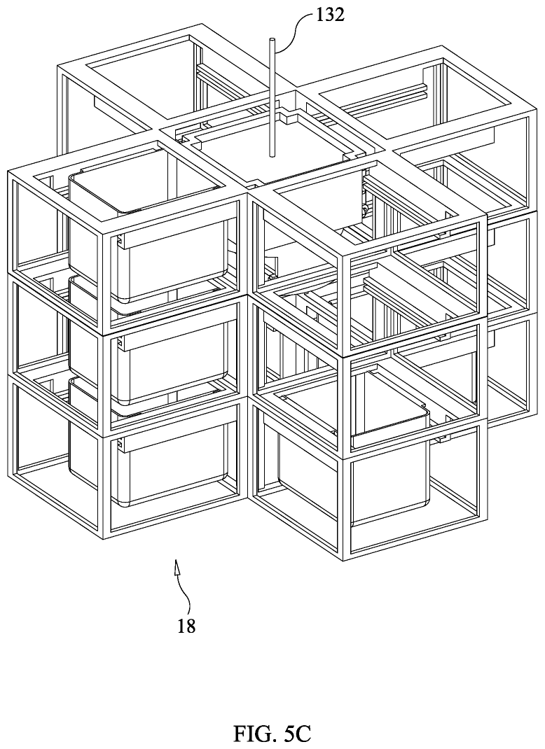

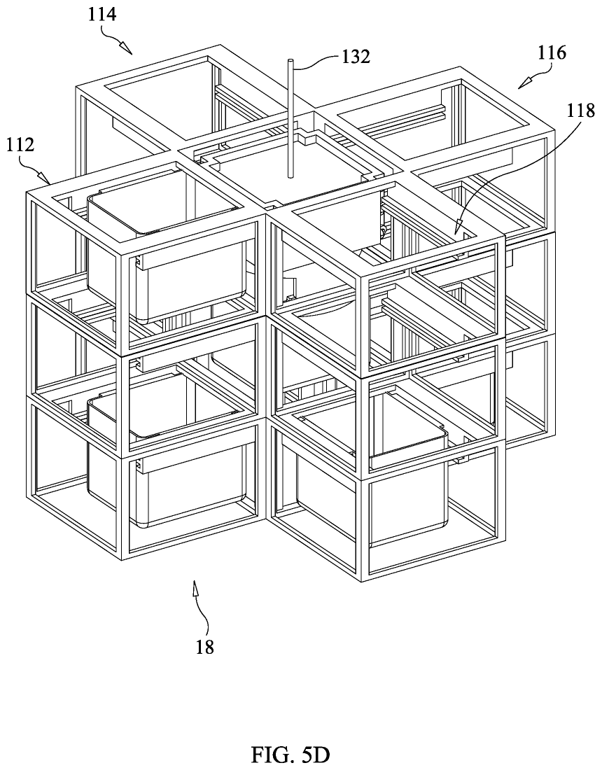

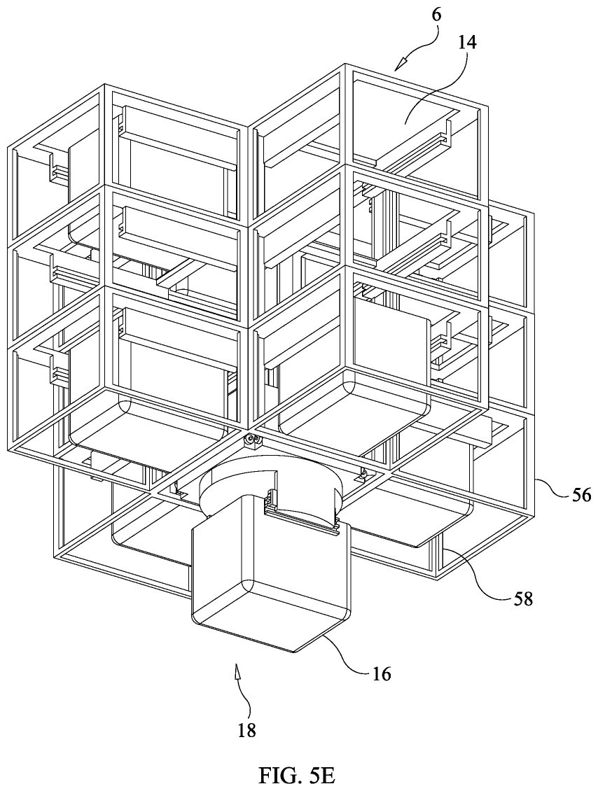

As described previously, a storage cell 4 may comprise a plurality of storage modules 6. Preferably, each storage cell 4 includes three or four storage modules 6. As can be seen in FIGS. 5A-5E of the drawings, in a storage cell 4 that comprises four storage modules 6, a first storage module 112 is situated opposite to a third storage module 116 and a second storage module 114 is situated opposite to a fourth storage module 118. More specifically, the front side 90 of the first storage module 112 is situated opposite and parallel to the front side 90 of the third storage module 116. The front side 90 of the second storage module 114 is situated opposite and parallel to the front side 90 of the fourth storage module 118. The front sides 90 of each of the first storage module 112, the second storage module 114, the third storage module 116 and the fourth storage module 118 together define the elevator shaft 8 through which the robotic bin handler 10 traverses when inserting and retrieving storage bins 16 from the storage modules 6 of the storage cells 4.

As can be seen in FIGS. 1, 6, 7 and 8 of the drawings, in a vertical storage cell column 18, a plurality of storage cells 4 are situated on top of one another. More specifically, the vertical storage cell column 18 may comprise two or more storage cells 4. For example, in a vertical storage cell column 18 that comprises three storage cells 4, a second storage cell 122 is situated above a first storage cell 120 and third storage cell 124 is situated above the second storage cell 122. Each respective storage module 6 of a storage cell 4 is aligned with a corresponding storage module 6 in the storage cell 4 situated above it or below it. For example, in a vertical storage cell column 18 formed of storage cells 4 having four storage modules 6, the first storage module 112, second storage module 114, third storage module 116 and fourth storage module 118 of the second storage cell 122 are aligned with and situated above the first storage module 112, second storage module 114, third storage module 116 and fourth storage module 118 of the first storage cell 120, respectively. The first storage module 112, second storage module 114, third storage module 116 and fourth storage module 118 of the third storage cell 124 are aligned with and situated above the first storage module 112, second storage module 114, third storage module 116 and fourth storage module 118 of the second storage cell 122, respectively. Accordingly, the front sides 90 of each of the storage modules 6 of each storage cell 4 define a level or portion of the elevator shaft 8 through which the robotic bin handler 10 traverses.

In a vertical storage cell column 18 formed of storage cells 4 having three storage modules 6, wherein the second storage module 114 is situated between the first storage module 112 and the third storage module 116, the first storage module 112, second storage module 114 and third storage module 116 of the second storage cell 122 are aligned with and situated above the first storage module 112, second storage module 114 and third storage module 116 of the first storage cell 120, respectively. The first storage module 112, second storage module 114 and third storage module 116 of the third storage cell 124 are aligned with and situated above the first storage module 112, second storage module 114 and third storage module 116 of the second storage cell 122, respectively. Accordingly, the front sides 90 of each of the storage modules 6 of each storage cell 4 define a level or portion of the elevator shaft 8 through which the robotic bin handler 10 traverses. As shown in FIGS. 1 and 9 of the drawings, a combination of vertical storage cell columns 18 can be used to maximize the storage capacity of the logistics tower 2. For example, a plurality of vertical storage cell columns 18 formed of storage cells 4 having four storage modules 6 can be used in combination with a plurality vertical storage cell columns 18 formed of storage cells 4 having three storage modules 6 to maximize the storage capacity of the logistics tower 2.

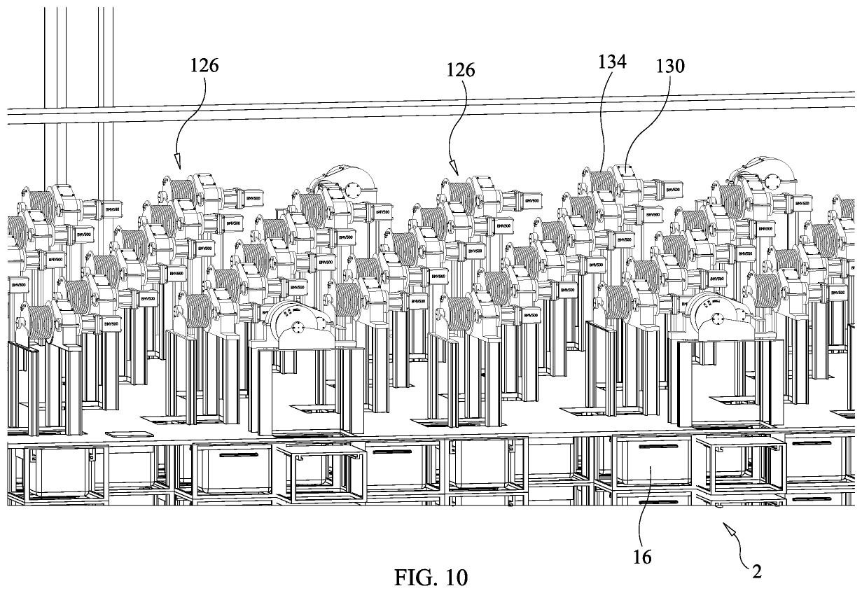

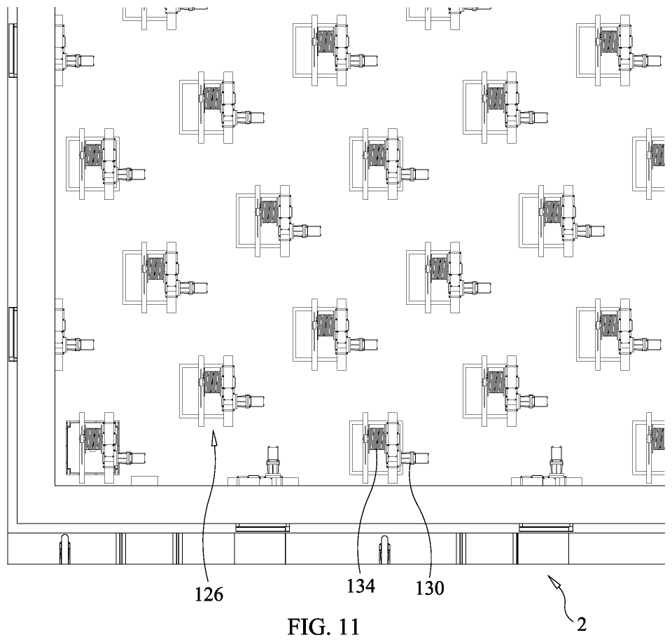

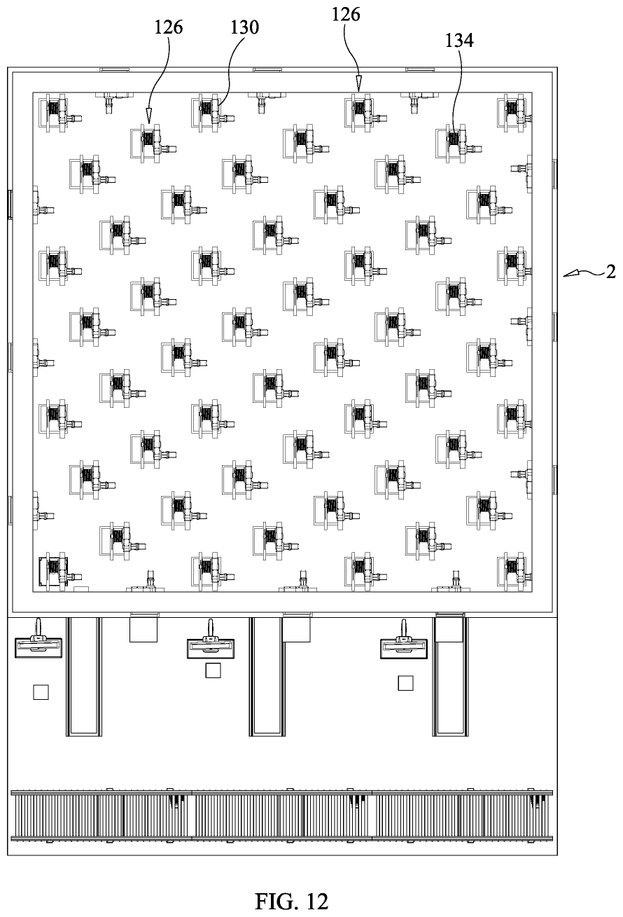

Storage bins 16 are inserted and withdrawn from the storage modules 6 of the storage cells 4 by one or more vertical retrieval systems 20. In one form, the vertical retrieval system 20 comprises a winch 126 and a robotic bin handler 10 coupled thereto. As can be seen in FIGS. 1, 7 and 10-12 of the drawings, a winch 126, such as an electro-mechanical winch, is preferably situated in a top portion 128 of the logistics tower 2. The winch 126 is aligned with the elevator shaft 8 defined by the storage modules 6 of the storage cells 4 of a particular vertical storage cell column 18. The winch 126 includes a motor 130 that selectively advances and retracts a cable 132 through the elevator shaft 8. In one form, the motor 130 may be mechanically coupled to a cable drum 134 on which the cable 132 is coiled. The motor 130 selectively rotates the cable drum 134 to advance and retract the cable 132 through the elevator shaft 8 of a particular vertical storage cell column 18. As will be described in greater detail in the forthcoming paragraphs, the motor 130 is in electrical communication with the computer 138 of the central control system 136 of the logistics tower 2 and is selectively controllable thereby.

A robotic bin handler 10 is mechanically coupled to a free end 140 of the cable 132 of the winch 126 and is generally situated in the elevator shaft 8 of a particular vertical storage cell column 18. The robotic bin handler 10 is selectively, vertically movable within the elevator shaft 8 to deliver and retrieve storage bins 16 from the storage modules 6 of the storage cells 4 in a particular vertical storage cell column 18. More specifically, the winch 126 raises and lowers the robotic bin handler 10 to a particular storage cell 4 (e.g., storage cell level) in the vertical storage cell column 18 so that the robotic bin handler 10 may access the storage modules 6 of the storage cell 4.

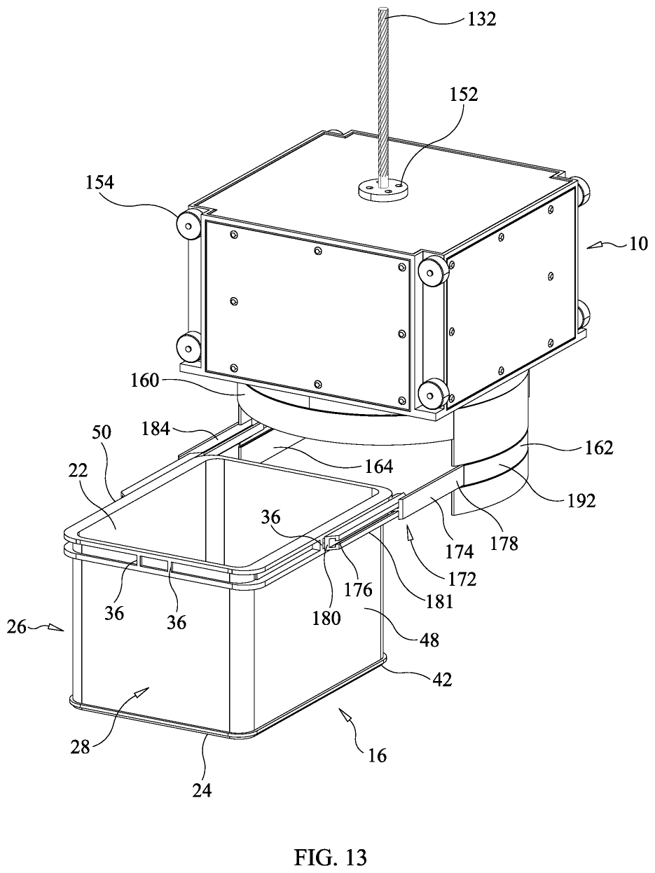

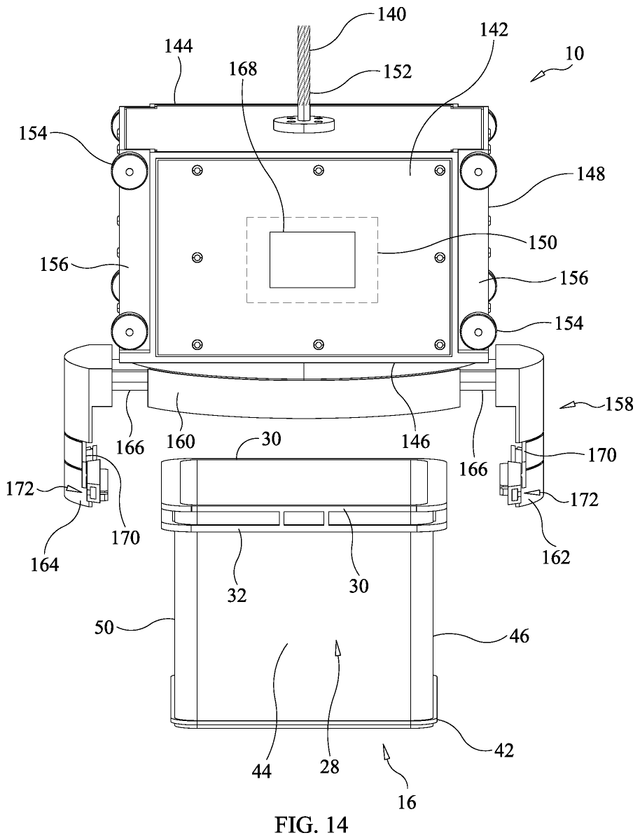

As can be seen in FIGS. 13-18 of the drawings, the robotic bin handler 10 includes a main housing 142 having a top surface 144, a bottom surface 146 disposed opposite the top surface 144 and a sidewall 148 extending therebetween. The top surface 144, bottom surface 146 and sidewall 148 of the main housing 142 define an internal cavity 150. A cable mount 152 is situated on the top surface 144 of the housing 142 that is coupled to the free end 140 of the winch cable 132. The housing 142 is preferably rectangular in shape and conforms to the dimensions and shape of the elevator shaft 8 to limit undesired movement of the robotic bin handler 10 as it traverses the elevator shaft 8. As can be seen in FIGS. 13 and 14 of the drawings, the robotic bin handler 10 includes a plurality of wheels 154 situated on the housing 142 to guide the robotic bin handler 10 through the elevator shaft 8. The wheels 154 may also be situated in a plurality of recessed portions 156 formed in the housing 142 of the robotic bin handler 10.

The robotic bin handler 10 further includes a gripping assembly 158 that inserts and removes storage bins 16 from the storage modules 6. More specifically, the gripping assembly 158 includes a base 160, a first arm 162 and a second arm 164. The base 160 is rotatably mounted to the bottom surface 146 of the housing 142. Each of the first arm 162 and the second arm 164 is mechanically coupled to the base 160 at opposite sides thereof by one or more actuators 166, such as a hydraulic actuator, a pneumatic actuator or an electrical actuator. The actuators 166 bias the first arm 162 and the second arm 164 between at least a first position and a second position, wherein in the second position, the distance between the arms 162, 164 is greater than the distance between the arms 162, 164 in the first position. As will be described in greater detail in the forthcoming paragraphs, the actuators 166 bias the arms 162, 164 outwardly from the base 160 to retrieve or deposit a storage bin 16 in a storage module 6. The base 160 is mechanically coupled to a motor 168 that is at least partially situated within the internal cavity 150 of the housing 142 of the robotic bin handler 10. The motor 158 selectively rotates the base 160 about the Z-axis (e.g., the vertical axis of the cable 132 within the elevator shaft 8). The base 160 is rotatable in 360 degrees so that the arms 162, 164 can access each of the storage modules 6 of a particular storage cell 4.

Each arm 162, 164 further includes one or more rail actuators 170 that are mechanically coupled to a rail slide 172. The rail actuator 170 of each of the first arm 162 and the second arm 164 drives the rail slide 172 inwardly and outwardly therefrom. The rail slide 172 may be formed as a single or multi-segmented elongated member. In a preferred form, the rail slide 172 includes a first elongated member 174 and a second elongated member 176. More specifically, as can be seen in FIGS. 13 and 16-18 of the drawings, each of the first elongated member 174 and the second elongated member 176 of the rail slide 172 includes a first axial end 178, a second axial end 180 disposed opposite the first axial end 178, an outer surface 182 and an inner surface 184 disposed opposite the outer surface 182.

The first and second elongated members 174, 176 of the rail slide 172 may be joined together and may be slidable relative to one another by forming one of the members, such as the first elongated member 174, with a T-shaped rail 186 extending outwardly from the inner surface 184 of the first elongated member 174, and forming a complementary T-shaped slot 188 in the outer surface 182 of the second elongated member 176, which slot 188 receives the T-shaped rail 186 of the first elongated member 174. Such structure joins the first elongated member 174 and the second elongated member 176 together, yet allows the second elongated member 176 to move reciprocatingly slidingly relative to the first elongated member 174 along the axial length thereof. Of course, it should be understood that the T-shaped rail 186 may be formed on the second elongated member 176, and that the T-shaped slot 188 may be formed in the first elongated member 174.

The inner surface 184 of the second elongated member 176 includes one or more engagement clamps 190 that extend outwardly therefrom. In one form, the engagement clamps 190 are formed as one or more protrusions that are generally rectangular in shape. More specifically, the engagement clamps 190 are formed to be generally complementary in shape to the receptacles 38 formed in the channel 34 of the storage bin 16. As will be described in greater detail in the forthcoming paragraphs, as the rail actuators 170 bias the arms 162, 164 and the rail slides 172 coupled thereto toward the storage bin 16, the engagement clamps 190 are engaged with the receptacles 38 in the storage bins 16. In particular, the engagement clamp 190 of the rail slide 172 of the first arm 162 engages a receptacle 38 formed in the channel 34 on the second sidewall 46 of the storage bin 16 and the engagement clamp 190 of the rail slide 172 of the second arm 164 engages a receptacle 38 formed in the channel 34 on the fourth sidewall 50 of the storage bin 16.

The locations of each of the storage modules 6 (e.g., the location within the vertical storage cell column 18 and storage cell 4 that the particular storage module 6 is located in) are stored in the central control system 136, as well as the identity and location of the storage bins 16 and any parcels contained therein. To retrieve a storage bin 16 from a storage module 6 of a storage cell 4 in the vertical storage cell column 18, the winch 126 extends the cable 132 so that the robotic bin handler 10 coupled thereto is lowered to the particular storage cell 4 (e.g., storage cell level) within the vertical storage cell column 18 containing the storage bin 16 to be retrieved. The motor 168 of the robotic bin handler 10 rotates the base 160 so that the arms 162, 164 are aligned with the storage module 6 containing the storage bin 16 to be retrieved. The robotic bin handler 10 may further include sensors, such as optical sensors utilized with a vision guidance system, to assist with aligning the robotic bin handler 10 and arms 162, 164 thereof with the storage module 6 containing the storage bin 16 to be retrieved.

After the robotic bin handler 10 has been positioned in front of the storage module 6 containing the storage bin 16 to be retrieved, the actuators 166 that couple the first arm 162 and the second arm 164 to the base 160 bias the arms 162, 164 outwardly therefrom to the second position (e.g., the widened position) such that first arm 162 and the second arm 164 may be positioned adjacent to the second sidewall 46 and fourth sidewall 50 of the storage bin 16, respectively. More specifically, after the arms 162, 164 are biased outwardly from the base 160 to the second position, the rail actuators 170 bias the rail slides 172 outwardly from the arms 162, 164 towards the storage module 6 and storage bin 16 contained therein. As can been seen in FIGS. 15-18 of the drawings, the rail actuators 170 advance each of the rail slides 172 into the space 110 between the channel 34 of the storage bin 16 and the outer frame 12 of the storage module 6.

More specifically, a first rail actuator 192 inserts the rail slide 172 of the first arm 162 into a space 196 defined by the top surface 106 of the second elongated member 100 of the bin support 96, the fourth horizontal member 74 of the outer frame 12 and the channel 34 of the storage bin 16. Similarly, a second rail actuator 194 inserts the rail slide 172 of the second arm 164 into a space 198 defined by the top surface 108 of the first elongated member 98 of the bin support 96, the second horizontal member 70 of the outer frame 12 and the channel 34 of the storage bin 16. Each of the rail slides 172 is advanced so that the engagement clamp 190 thereof is aligned with a respective receptacle 38 in the channel 34 of the storage bin 16. After the engagement clamps 190 of the rail slides 172 have been aligned with receptacles 38 in the channel 34 of the storage bin 16, the actuators 166 position the arms 162, 164 in the first position by biasing the arms 162, 164 inwardly towards the base 160. As the arms 162, 164 are biased inwardly, the engagement clamps 190 of the rail slides 172 engage the receptacles 38 in the channel 34 such that the storage bin 16 is mechanically coupled to the robotic bin handler 10.

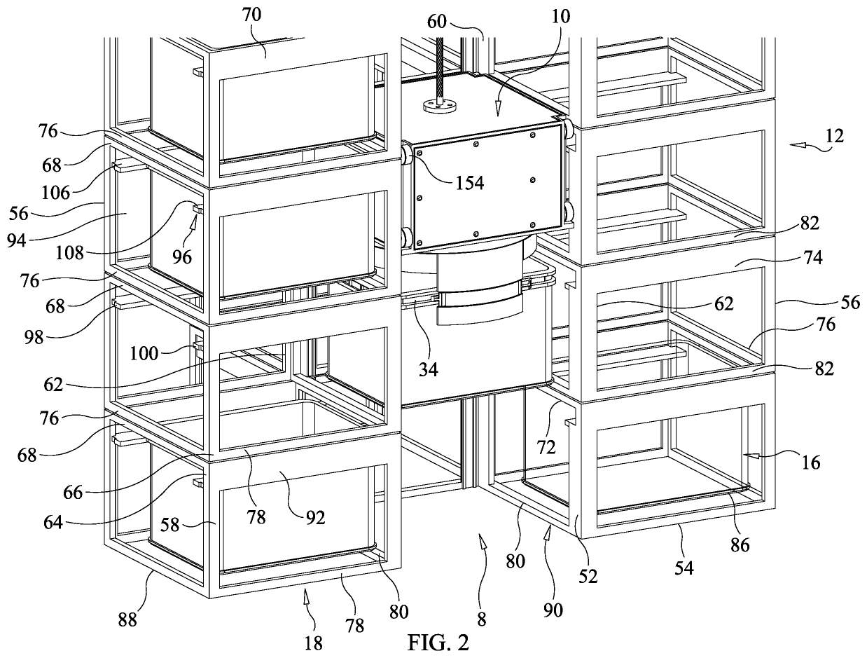

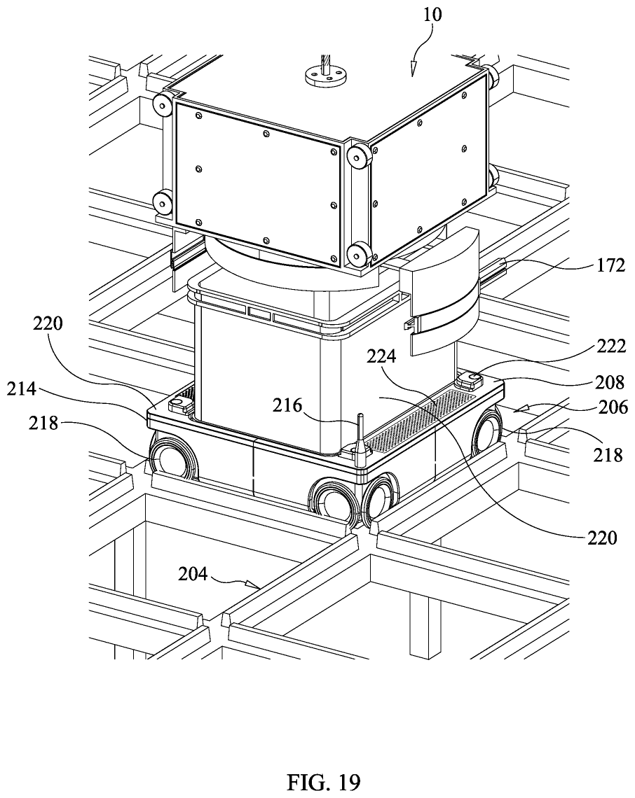

Once the rail slides 172 of the robotic bin handler 10 have engaged the storage bin 16, the rail actuators 170 retract the rail slides 172 inwardly towards the robotic bin handler 10, thereby withdrawing the storage bin 16 from the storage module 6. As can be seen in FIGS. 2 and 19 of the drawings, after the storage bin 16 has been withdrawn from the storage module 6, the rail slides 172 and storage bin 16 engaged therewith are situated substantially below the robotic bin handler 10 in the elevator shaft 8 so that the robotic bin handler 10 can traverse the elevator shaft 8 to a delivery point. As will be described in greater detail in the forthcoming paragraphs, after a storage bin 16 has been retrieved from the storage module 6, the winch 126 extends the cable 132 and robotic bin handler 10 coupled thereto downwardly through the elevator shaft 8 to either a delivery station or a horizontal shuttle grid 200, at which point the actuators 166 that couple the first arm 162 and the second arm 164 to the base 160 bias the arms 162, 164 outwardly therefrom to the second position (e.g., the widened position) to disengage the engagement clamps 190 from the receptacles 38 in the channel 34 and release the storage bin 16 from the robotic bin handler 10.

Similarly, the robotic bin handler 10 may also transport a storage bin 16 to a particular storage module 6 for storage. As will be described in greater detail in the forthcoming paragraphs, to pick up a storage bin 16 for transport to a storage module 6, the winch 126 lowers the robotic bin handler 10 to the level that the storage bin 16 is located (e.g., the ground floor or a subterranean loading station in the logistics tower 2). After the robotic bin handler 10 has been lowered to the storage bin 16, the actuators 166 that couple the first arm 162 and the second arm 164 to the base 160 bias the arms 162, 164 outwardly therefrom to the second position (e.g., the widened position) and the motor 168 of the robotic bin handler 10 rotates the base 160 so that the arms 162, 164 are aligned with the second sidewall 46 and fourth sidewall 50 of the storage bin 16. The winch 126 further lowers the robotic bin handler 10 so that the widened arms 162, 164 and the engagement clamps 190 of the rail slides 172 are aligned with the receptacles 38 in the channel 34 of the storage bin 16. Thereafter, the actuators 166 of the base 160 position the arms 162, 164 in the first position by biasing the arms 162, 164 inwardly towards the base 160. As the arms 162, 164 are biased inwardly, the engagement clamps 190 of the rail slides 172 engage the receptacles 38 in the channel 34 such that the storage bin 16 is mechanically coupled to the robotic bin handler 10. The winch 126 then retracts the cable 132 so that the robotic bin handler 10 moves upwardly through the elevator shaft 8 to a particular storage cell 4 (e.g., storage cell level) within the vertical storage cell column 18.

Once the winch 126 positions the robotic bin handler 10 at a desired storage cell 4, the motor 168 rotates the base 160 so that the arms 162, 164 are aligned with the particular storage module 6 that the storage bin 16 is to be stored in. The rail actuators 170 then bias the rail slides 172 and storage bin 16 engaged therewith into the storage module 6 so that the second flange 32 of the storage bin 16 rests on the storage bin support 96. After the storage bin 16 has been inserted into the storage module 6, the actuators 166 that couple the first arm 162 and the second arm 164 to the base 160 bias the arms 162, 164 outwardly therefrom to the second position (e.g., the widened position) to disengage the engagement clamps 190 from the receptacles 38 in the channel 34 and release the storage bin 16 from the robotic bin handler 10.

As described above, in one embodiment, as shown in FIGS. 1, 8, 9 and 12 of the drawings, the logistics tower 2 may be configured such that it has 64 vertical storage cell columns 18 and a vertical retrieval system 20 that comprises 64 winches 126 coupled to 64 robotic bin handlers 10 that traverse 64 elevator shafts 8 to access 18,300 storage bins 16. Each of the winches 126 and the robotic bin handlers 10 are in electrical communication with the central control system 136 such that a specific winch 126 and robotic bin handler 10 are utilized to retrieve a desired storage bin 16 from a particular storage module 6 in a particular storage cell 4, within a particular vertical storage cell column 18.

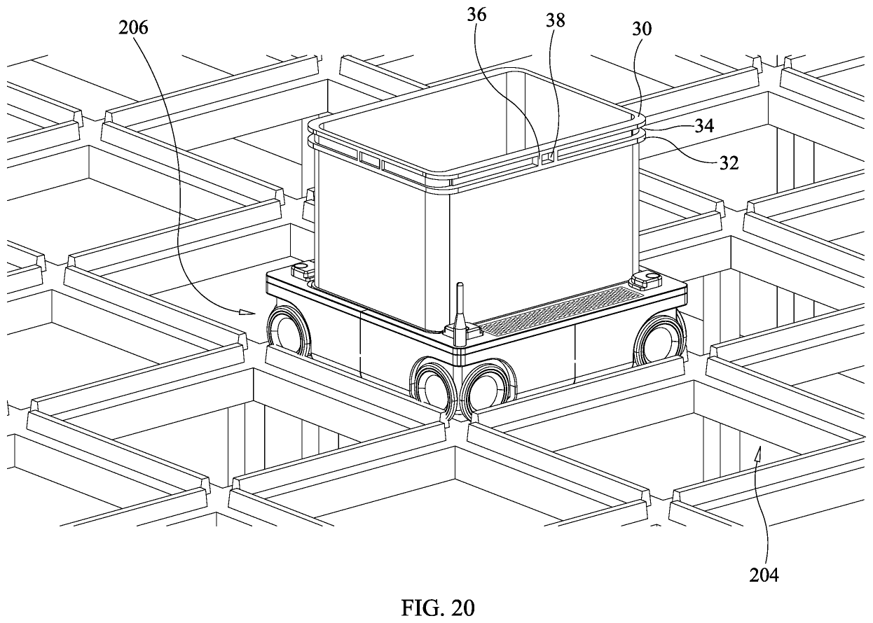

The logistics tower 2 may further include a horizontal shuttle system 202 situated below the vertical storage cell columns 18. As can be seen in FIGS. 19 and 20 of the drawings, the horizontal shuttle system 202 includes a horizontal shuttle grid 200 and one or more robotic flatbed shuttles 206. The shuttle grid is formed of a network of rails 204 or configured in a grid-like arrangement, or may be formed by a plurality of rail tiles 900 that are situated adjacent to another having grooves 901 that define a track for the wheels 218 of the robotic flatbed shuttle 206 to traverse. Preferably, one or more of the rail tiles 900 are selectively removable for maintenance, replacement or, as will be explained in greater in the forthcoming paragraphs, to access other portions of the logistics tower 2. The robotic flatbed shuttles 206 traverse the horizontal shuttle grid 200 to receive and/or deliver storage bins 16 to one of the robotic bin handlers 10.

Each robotic flatbed shuttle 206 includes a generally rectangular housing 208 having a top surface 210, a bottom surface disposed opposite the top surface 210 and a sidewall 214 extending therebetween. The top surface 210, bottom surface and sidewall 214 define an internal cavity in which electronics, such as motors, wireless communications systems, control circuitry and a battery, are situated. One or more antennas 216 may be situated on the top surface 210 of the housing 208 and transmit signals to the central control system 136. A plurality of bi-directional wheels 218 are situated on the housing 208 and are coupled to one or more motors that are at least partially situated within the internal cavity of the housing 208. The bi-directional wheels and motors drive the robotic flatbed shuttle 206 on the rails 204 or the removeable rail tiles 900 of the horizontal shuttle grid 200 in a plurality of directions (e.g., the robotic flatbed shuttle 206 can traverse the horizontal shuttle grid 200 in four directions).

The robotic flatbed shuttle 206 further includes electronic circuitry and control systems, such as optical sensors, radar, wireless communication systems and a wireless antenna 216, that assist the robotic flatbed shuttle 206 to navigate the rails 204 or removeable rail tiles 900 of the horizontal shuttle grid 200 and communicate the robotic flatbed shuttle's location to the central control system 136. The central control system 136 communicates and coordinates the movement of the one or more robotic flatbed shuttles 206 on the rails 204 or the removeable rail tiles 900 of the horizontal shuttle grid 200. The wireless communications systems of the robotic flatbed shuttle 206 further relay information to the central control system 136, such as tasks and the health of the robotic flatbed shuttle 206.

The robotic flatbed shuttle 206 further comprises a mounting platform 220 situated on the top surface 210 of the housing 208 on which a storage bin 16 or done ferry 2164 is situated. The robotic flatbed shuttle 206 includes one or more rotatable clasps 222 on the top surface 210 of the housing 208. Each clasp 222 is mechanically coupled to an actuator or gearing that selectively rotates the clasp 222 between at least a first position and a second position. As will be described in greater detail in the forthcoming paragraphs, when the robotic bin handler 10 places a storage bin 16 on the mounting platform 220 of the robotic flatbed shuttle 206, the clasps 222 rotate and a latching mechanism engages the mounting flange 42 of the storage bin 16, thereby securing the storage bin 16 to the robotic flatbed shuttle 206. The top surface 210 of the housing 208 of the robotic flatbed shuttle 206 may also include one or more vents 224 in communication with the internal cavity thereof.

When the robotic bin handler 10 of the vertical retrieval system 20 retrieves a storage bin 16 from a storage module 6 in a storage cell 4, the central control system 136 signals one of the robotic flatbed shuttles 206 to position itself below the elevator shaft 8 of the vertical storage cell column 18 that the specific robotic bin handler 10 is traversing. The winch 126 lowers the robotic bin handler 10 and storage bin 16 engaged therewith through the elevator shaft 8 onto the mounting platform 220 of the robotic flatbed shuttle 206 situated therebelow. The robotic bin handler 10 may include a sensor, such as a weight sensor in the base 160 of the gripping assembly 158, that detects when the storage bin 16 is situated on the mounting platform 220 and supported thereby. As described previously, when the storage bin 16 is delivered (e.g., placed on the mounting platform 220 of the robotic flatbed shuttle 206), the actuators 166 bias the arms 162, 164 outwardly to release the storage bin 16 from the rail slides 172 of the robotic bin handler 10. After the storage bin 16 is situated on the mounting platform 220, the clasps 222 rotate and engage the mounting flange 42 on the storage bin 16 to secure the storage bin 16 thereto during transport to a pick station 226.

The robotic flatbed shuttles 206 may also be utilized to load storage bins 16 into the logistics tower 2. More specifically, the logistics tower 2 may also include a loading bay 228 that is accessible by the rails 204 or removeable rail tiles 900 of the horizontal shuttle grid 200. The loading bay 228 may include one or more loading stations 230 where operators load storage bins 16 onto the robotic flatbed shuttles 206. More specifically, a storage bin 16 is presented at a particular loading station 230 in the loading bay 228. The storage bin 16 is identified by the central control system 136 (e.g., by a barcode or a radio frequency identification tag embedded in or on the storage bin 16). The central control system 136 directs a robotic flatbed shuttle 206 to the loading station 230 and the storage bin 16 is placed on the mounting platform 220 and secured thereon by the clasps 222. After the storage bin 16 is secured to the robotic flatbed shuttle 206, the central control system 136 instructs the robotic flatbed shuttle 206 to navigate the rails 204 or removeable rail tiles 900 of the horizontal shuttle grid 200 and position itself below the elevator shaft 8 of the vertical storage cell column 18 that the storage bin 16 will be stored in. When the robotic flatbed shuttle 206 positions itself below the elevator shaft 8, it transmits a signal to the central control system 136 indicating such. The central control system 136 directs the winch 126 of the vertical retrieval system 20 of the particular vertical storage cell column 18 to lower the robotic bin handler 10 downwardly through the elevator shaft 8 to the robotic flatbed shuttle 206 positioned therebelow. As described previously, the robotic bin handler 10 engages the storage bin 16 and the robotic flatbed shuttle 206 disengages the latches of the clasps 222, thereby releasing the storage bin 16 therefrom. The winch 126 then retracts the robotic bin handler 10 and storage bin 16 coupled thereto through the elevator shaft 8 and positions the robotic bin handler 10 at the storage cell 4 (e.g., storage cell level) containing the storage module 6 that the storage bin 16 will be placed in.

In a further embodiment, the robotic flatbed shuttles 206 may be configured to vertically traverse the elevator shaft 8 of a particular vertical storage cell column 18 to access a particular storage module 6 and retrieve a storage bin 16 therefrom or insert a storage bin 16 therein. For example, as described previously, the robotic shuttle 206 may traverse the rails 204 or removeable rail tiles 900 of the horizontal shuttle grid 200 and align itself below the elevator shaft 8 of the vertical storage cell column 18 in which the storage bin 16 to be retrieved is situated. The robotic flatbed shuttle 206 may include means, such as extendible wheels, tracks or an extendable lift system, that enable the robotic flatbed shuttle 206 to climb from the rails 204 or removeable rail tiles 900 of the horizontal shuttle grid 200 into the elevator shaft 8. The robotic flatbed shuttle 206 then can drive itself through the elevator shaft 8 to the storage cell 4 (e.g., storage cell level) at which the storage bin 16 is situated. The robotic flatbed shuttle 206 further includes means for retrieving and/or inserting the storage bin 16 from the storage module 6. For example, the robotic flatbed shuttles 206 may be configured to include a gripping assembly similar to the gripping assembly 158 of the robotic bin handler 10, the gripping assembly being situated at least partially on the top surface 210 of the robotic flatbed shuttle 206. Accordingly, the robotic flatbed shuttle 206 can be used to retrieve and/or insert bins without the need of the robotic bin handler 10. Alternatively, the elevator shaft 8 may include portions that extend downwardly towards the horizontal shuttle grid 200 that enable the robotic flatbed shuttles 206 to climb from the horizontal shuttle grid 200 to the elevator shaft 8.

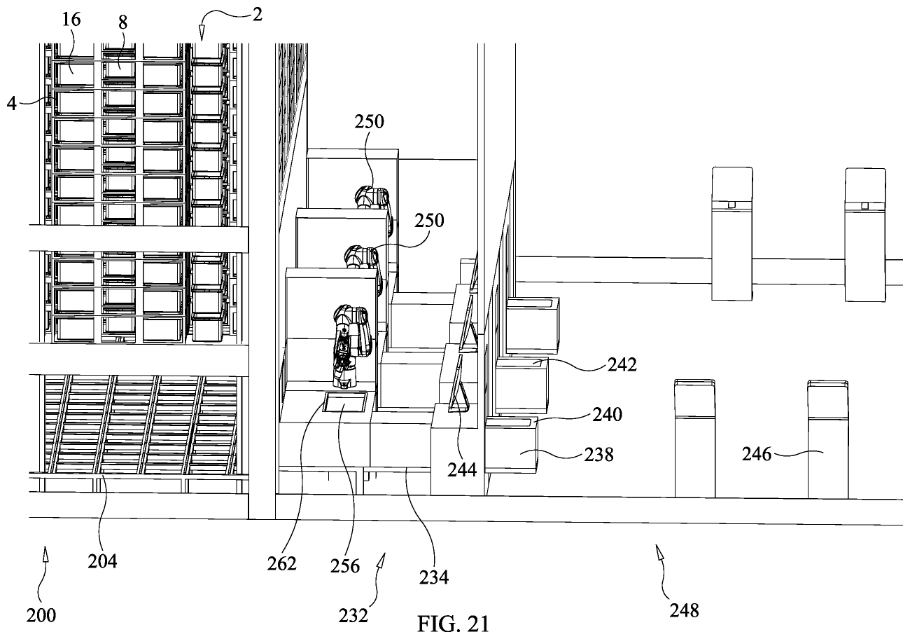

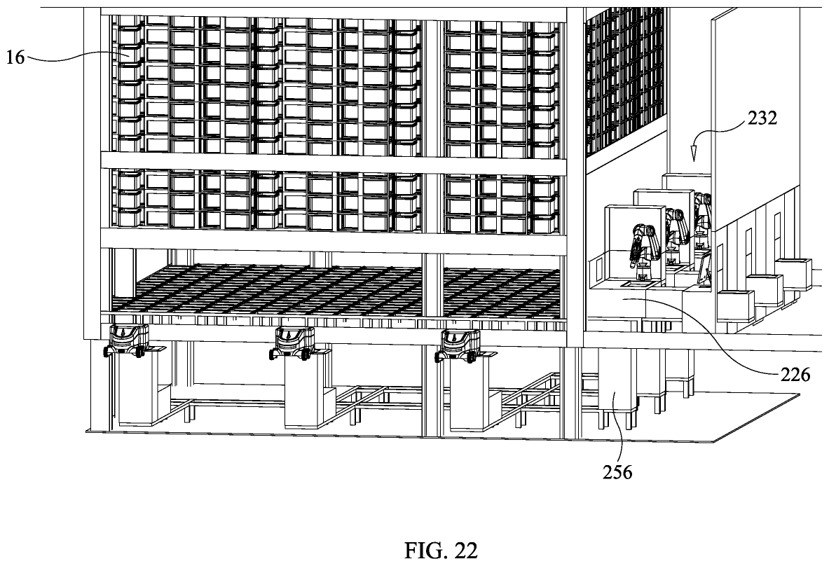

The logistics tower 2 may also include a delivery bay 232. As can be seen in FIGS. 21 and 22 of the drawings, the delivery bay 232 includes one or more pick stations 226 that are interconnected to the horizontal shuttle grid 200 so that the robotic flatbed shuttles 206 can transport storage bins 16 thereto. More specifically, the pick station 226 includes a track 234 interconnected to the horizontal shuttle grid 200. A pickup port 236 is situated at the end of the track 234 opposite to the track's interconnection to the horizontal shuttle grid 200. The pickup port 236 comprises a sidewall 238 that extends upwardly from the track 234 and an open top 240. A door 242 is situated over the open top 240 of the pickup port 236 and is selectively moveable between a first position and a second position. In the first position, the door 242 covers the open top 240 of the pickup port 236 so a consumer cannot access the contents thereof. In the second position, the door 242 is retracted from the open top 240 of the pickup port 236 so that a consumer can access a storage bin 16 on a robotic flatbed shuttle 206 situated therein. The door 242 may be mechanically coupled to an actuator that drives the door 242 between the first position and the second position. The deliver bay 232 may also include one or more touch monitors 244 for employee/staff use.

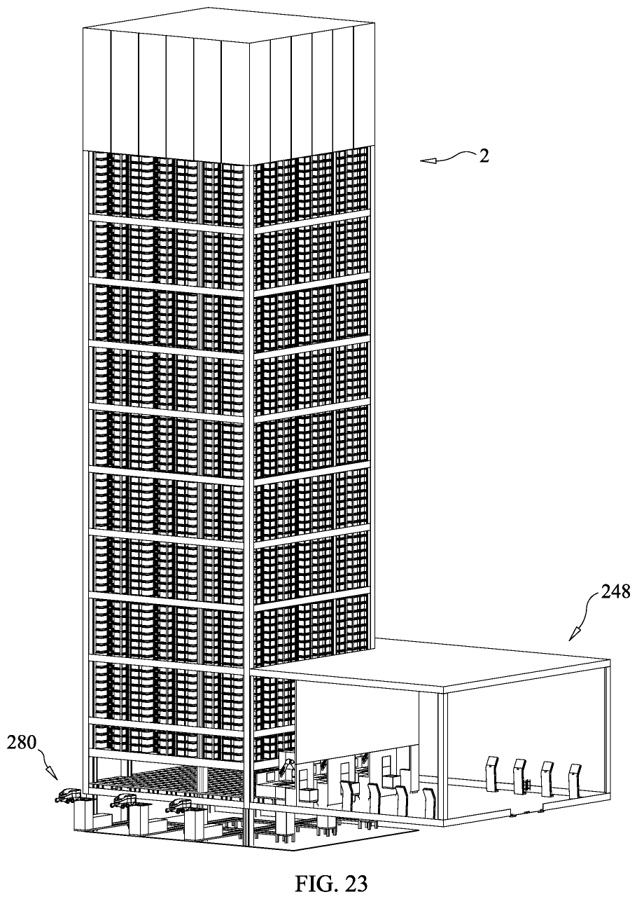

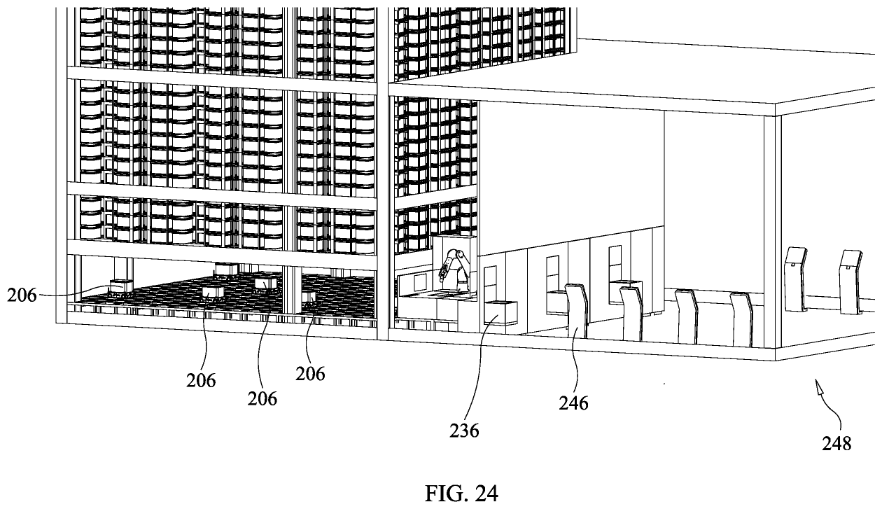

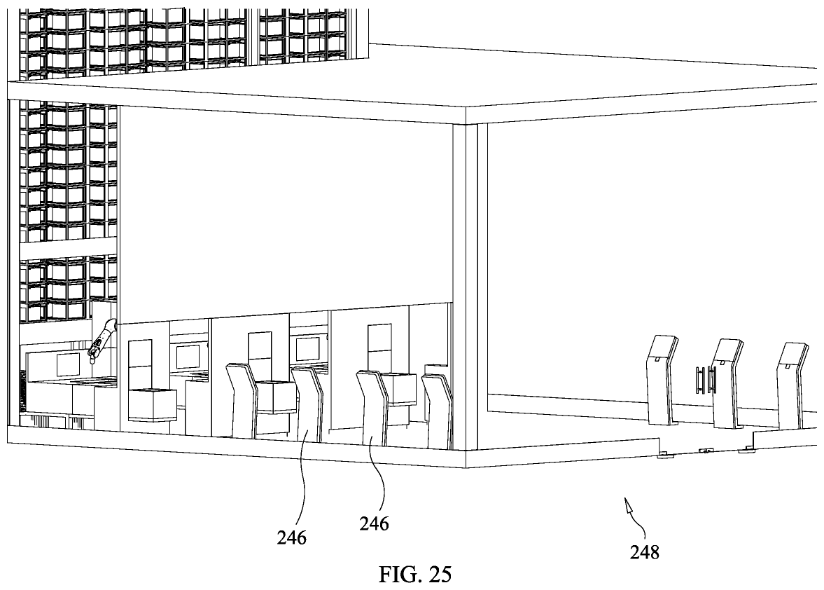

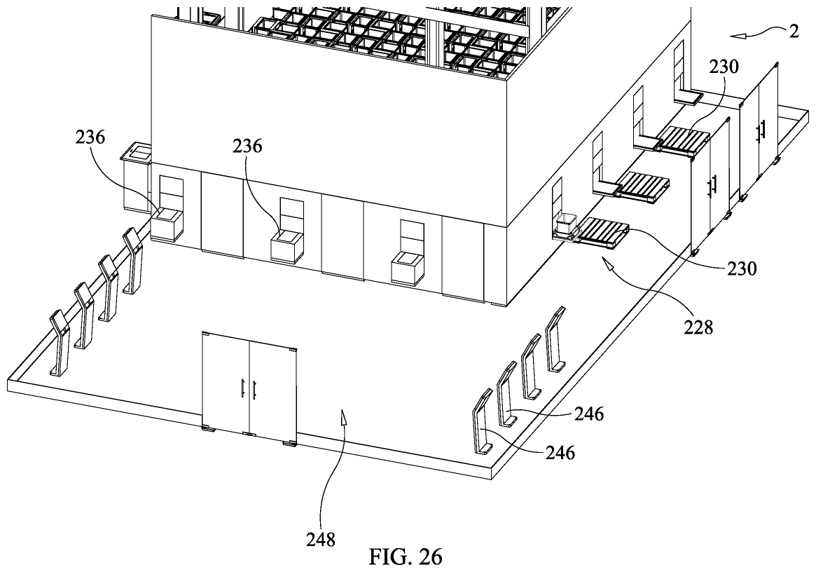

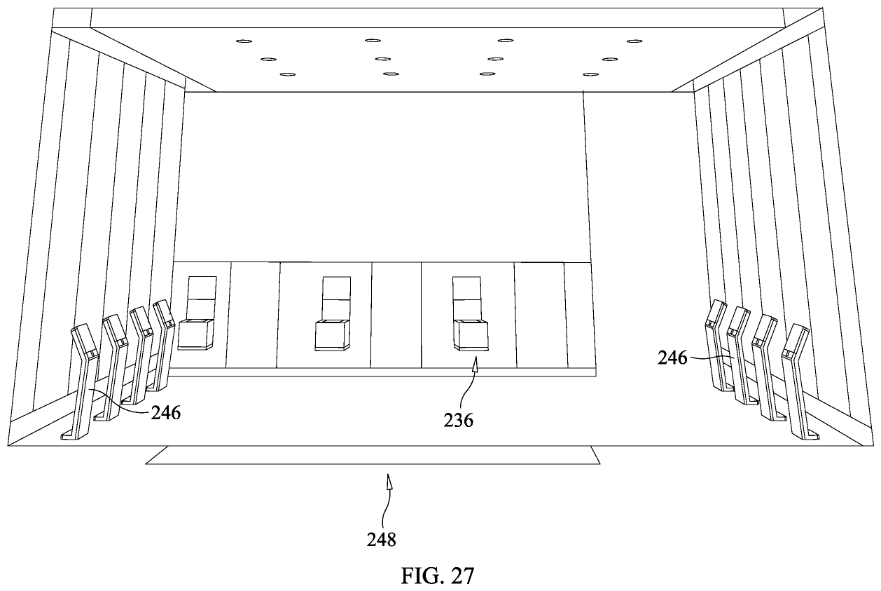

As can be seen in FIGS. 21-27 of the drawings, a consumer can select a desired product from one or more kiosks 246 situated in a customer center 248 situated adjacent to or in the logistics tower 2. The kiosk 246 is in electrical communication with the central control system 136. When a user selects a particular product from the kiosk 246, the location of the storage bin 16 that the product is stored in is accessed by the central control system 136 and the vertical retrieval system 20 retrieves and transports the particular storage bin 16 to a robotic flatbed shuttle 206. The robotic flatbed shuttle 206 transports the storage bin 16 on rails 204 or removeable rail tiles 900 of the horizontal shuttle grid 200 to the track 234 that leads to the particular pickup port 236. Once the robotic flatbed shuttle 206 is positioned within the pickup port 236, the actuator causes the door 242 to uncover the open top 240 of the pickup port 236 such that the consumer can remove the storage bin 16 and/or product from the robotic flatbed shuttle 206 situated therein. A plurality of sensors, such as radio frequency identification tags, optical sensors and weight sensors, can be utilized to determine when the consumer has removed the storage bin 16 and/or product from the robotic flatbed shuttle 206 and transmit a signal to the central control system 136 that is indicative of such. After the storage bin 16 is removed, the actuator causes the door 242 to close over the open top 240 of the pickup port 236. It is envisioned to be within scope of the present invention to have a plurality of pick stations 226 within the delivery bay 232.

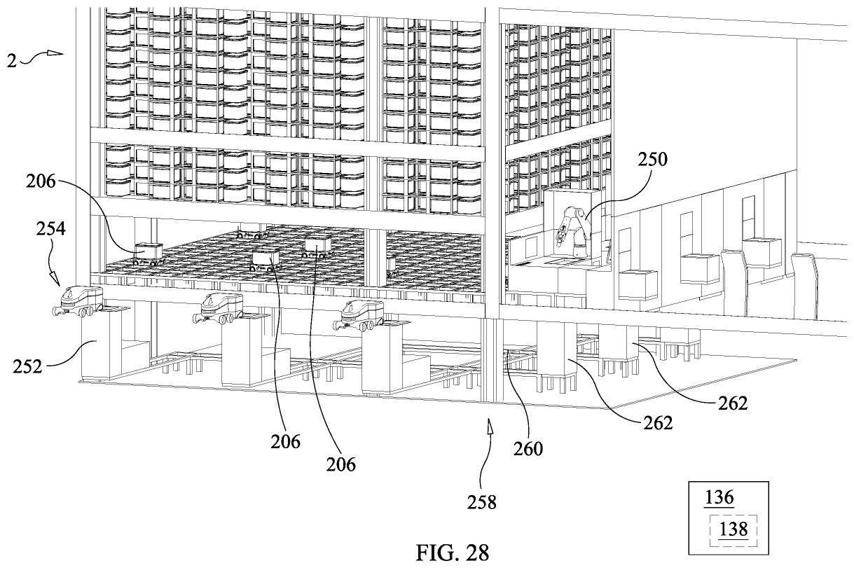

As can be seen in FIGS. 21, 22 and 28 of the drawings, the delivery bay 232 may further include one or more robotic arms 250 and one or more elevator lifts 252. More specifically, the storage bins 16 may also be transported to consumers by autonomous or semi-autonomous delivery robots 254 or delivery drones 2000. When a consumer orders a product from home or work, the storage bin 16 containing the product is retrieved from a particular storage module 6 and placed on a robotic flatbed shuttle 206. The robotic flatbed shuttle 206 traverses the horizontal shuttle grid 200 with the storage bin 16 to a robotic arm 250 situated in the delivery bay 232. The robotic arm 250 removes the storage bin 16 from the robotic flatbed shuttle 206 and moves it to an elevator lift 252.

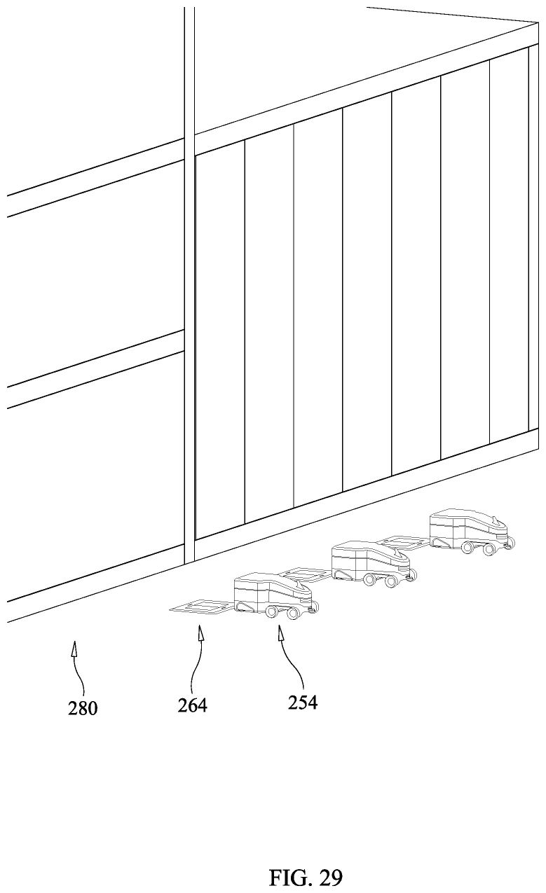

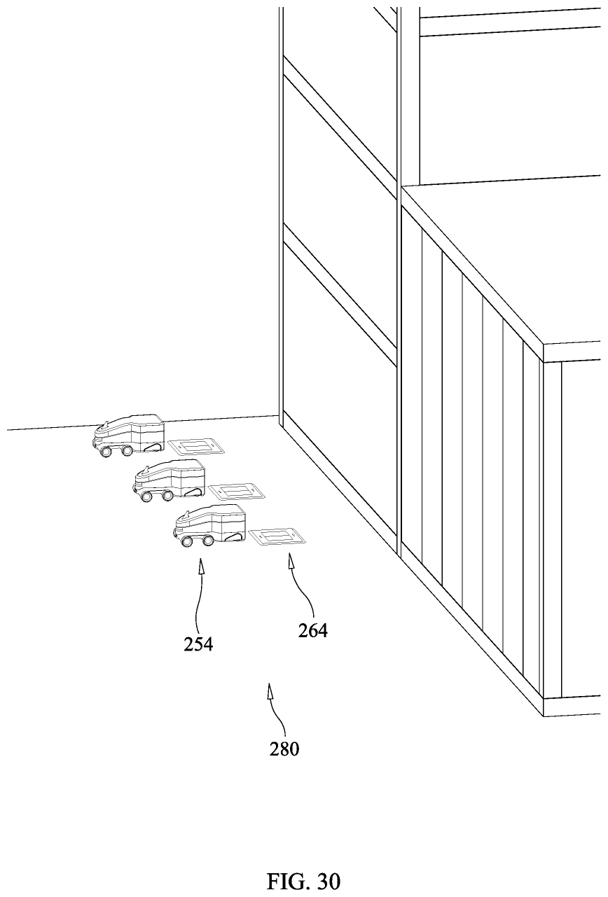

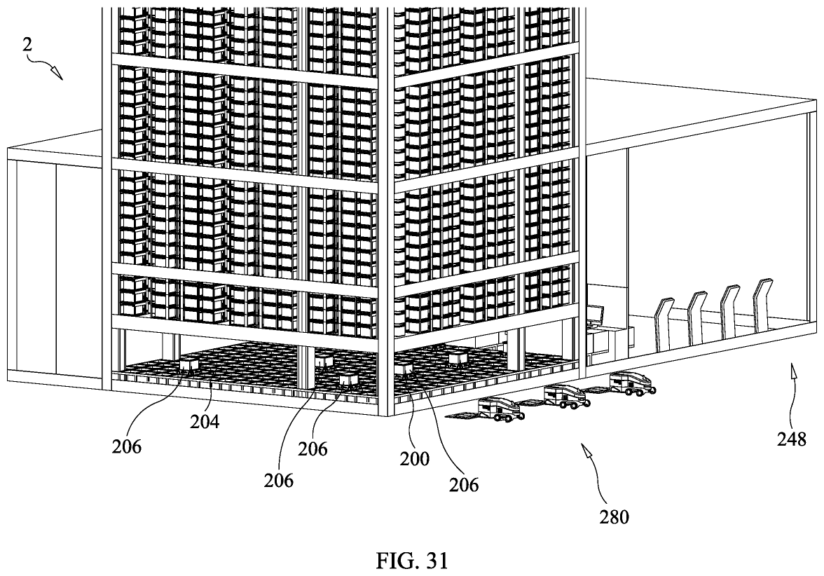

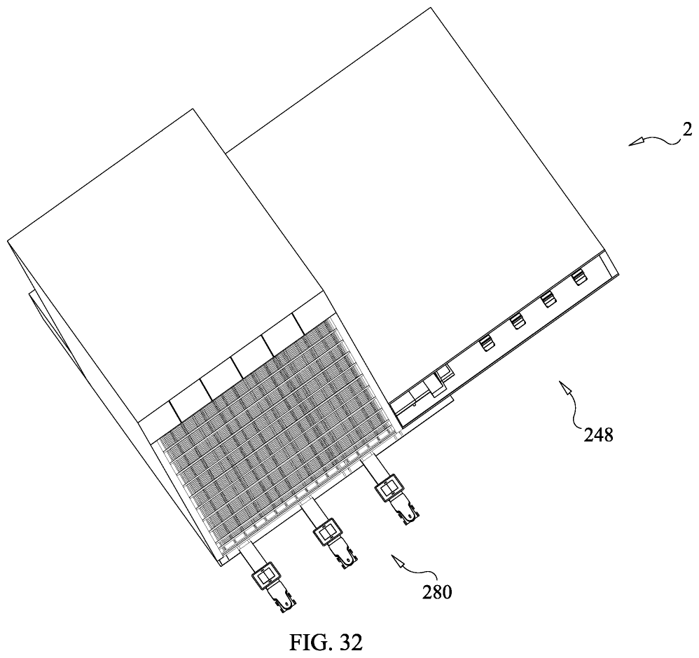

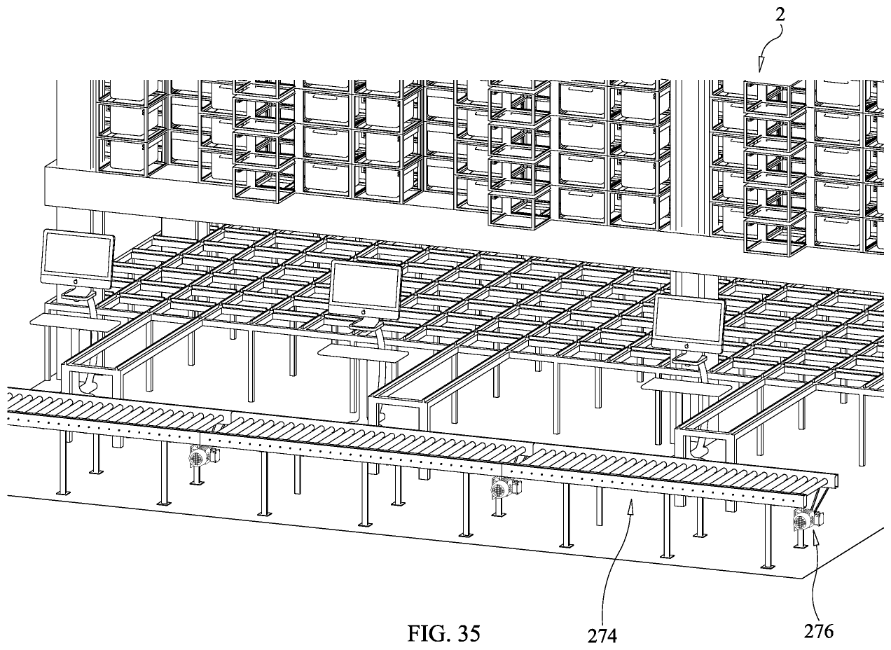

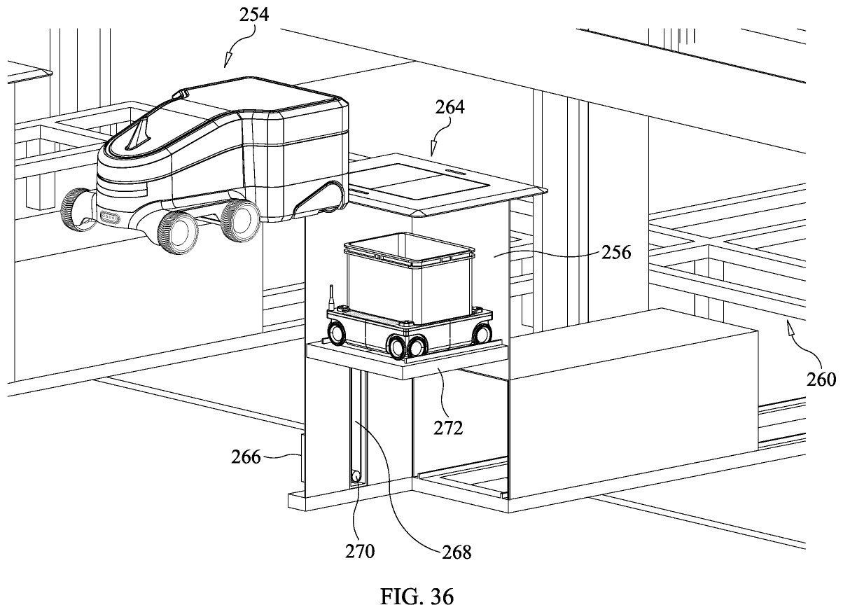

The elevator lift 252 preferably comprises an elevator shaft 256 that extends between the delivery bay 232 and a parcel transit system 258 situated at a lower level of the logistics tower 2. The parcel transit system 258 includes a plurality of conveyors 260 and elevators 262 that transport storage bins 16 from the elevator lift 252 to storage lockers 264 situated outside of the logistics tower 2. As can be seen in FIGS. 29-32 of the drawings, the delivery robots 254 are situated over the lockers 264. In one form, as shown in FIG. 36 of the drawings, each elevator lift 252 comprises a motor 266, cable 268 and winch 270 that drives an embedded track 272 upwardly and downwardly within the elevator shaft 256. The robotic arm 250 places a storage bin on the elevator lift 252 and the lift 252 lowers the storage bin 16 to the conveyor system 260. As can be seen in FIG. 35 of the drawings, the conveyor system 260 may comprise one or more conveyors 274 that are powered by one or more motors 276. The conveyor system 260 transports the storage bin 16 to another elevator lift 252 situated within a storage locker 264 outside of the logistics tower 2. When a delivery robot 254 drives over the storage locker 264, the storage locker 264 opens and the elevator lift 252 raises the track 272 and storage bin 16 situated thereon into the delivery robot 254. The delivery robot 254 then navigates to an external location and delivers the storage bin 16 and parcel therein to the ordering consumer.

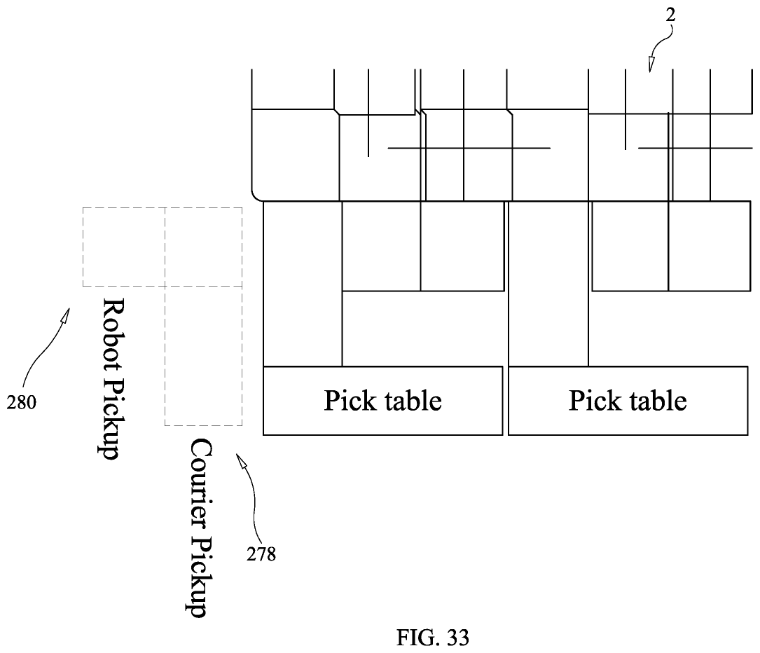

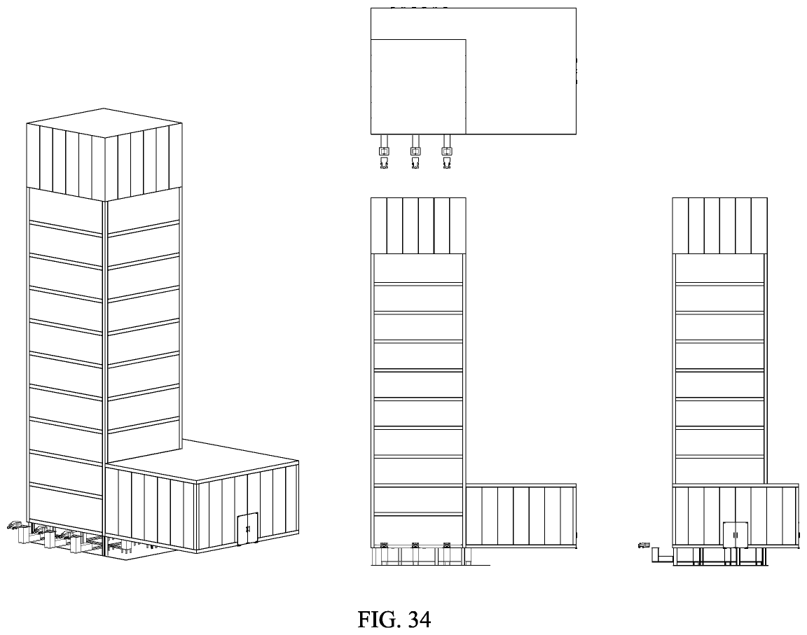

In summary, when an order is placed for a particular item (e.g., via an e-commerce platform), the complete order is sent to the closest logistics tower 2 to the user via cloud network infrastructure. Once the central control system 136 of the logistics tower 2 receives the order, it is either processed for immediate retrieval or scheduled to be retrieved at a later time defined by the user. When an order is processed, each item in each vertical storage cell column 18 is prepared for retrieval. The robotic bin handler 10 is moved up and down by a winch 126. The robotic bin handler 10 has the ability to rotate 360 degrees. The robotic bin handler 10 can access all of the storage modules 6 (e.g., two, three or four storage modules 6) of a particular storage cell 4. Once a storage bin 16 is picked, the rail slides 172 of the arms 162, 164 are retracted under and the robotic bin handler 10 brings the storage bin 16 down to the horizontal shuttle grid 200 and robotic flatbed shuttle 206 thereon. The robotic flatbed shuttle 206 includes bi-directional wheels 218. Vision systems and radar may be used to guide the robotic flatbed shuttle 206 over the horizontal shuttle grid 200. Once an order is picked, a designated robotic flatbed shuttle 206 moves in a single line and transports the order to a designated pick station. Each item is picked and placed into an outbound container. The container moves outbound to two pickup areas, as shown in FIG. 33 of the drawings. The first is the courier pickup area 278. This area consists of one or multiple conveyors that hold orders ready for pickup. The second is the robot pickup area 280. This is an area outside the main area that would consist of a locker 264 that the delivery robot 254 could drive over and pick up the item.

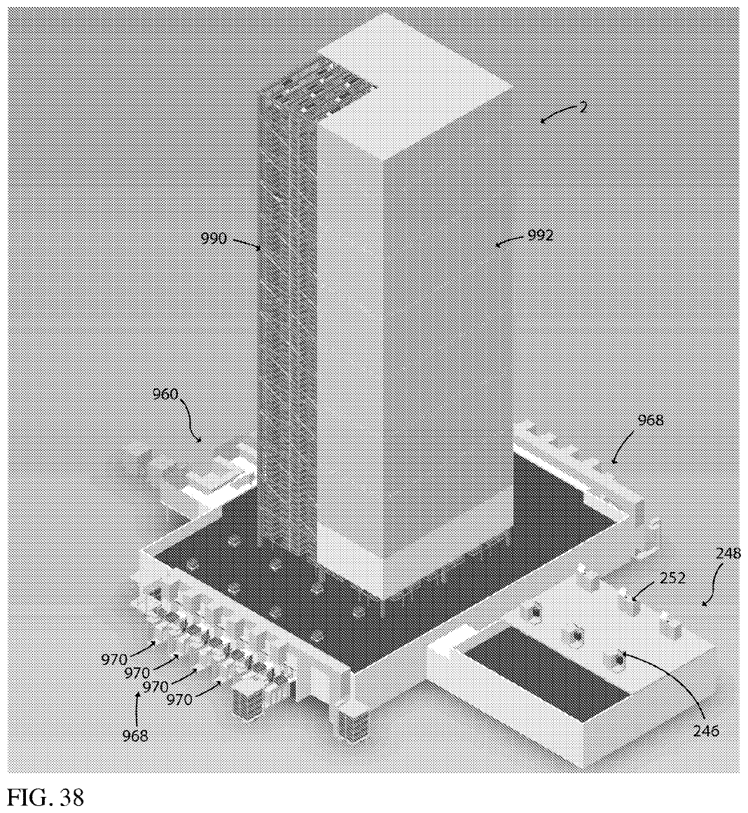

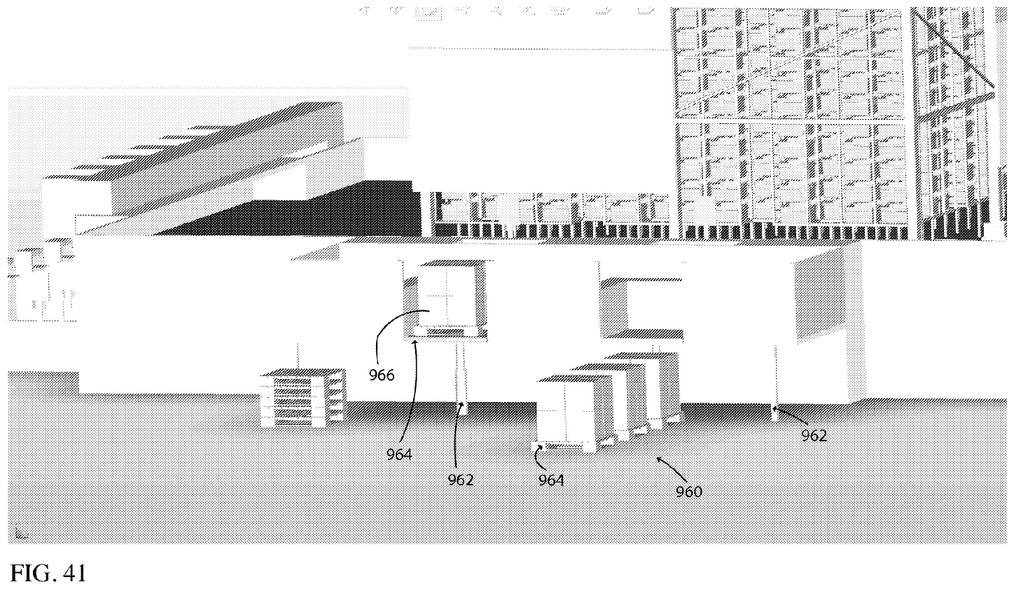

In another embodiment of the present invention, as shown in FIGS. 38 and 41 of the drawings, the horizontal shuttle system 202 is situated at a level below the customer center 248 and the loading bay 228 and one or more elevator lifts 252 are situated in the customer center 248 next to each kiosk 246. The elevator lift 252 extends between the customer center 248 and the horizontal shuttle grid 200 of the horizontal shuttle system 202. A pickup port 1002 is situated above the elevator lift 252. One or more elevator lifts 252 are situated in the loading bay 228, extending between the loading bay 228 and the horizontal shuttle grid 200 of the horizontal shuttle system 202. The structure and operation of the elevator lifts 252 situated in the customer center 248 and loading bay 228 are the same as the previously described.

As previously described a consumer can select a desired product from one or more kiosks 246 situated in a customer center 248 situated adjacent to or in the logistics tower 2. When a user selects a particular product from the kiosk 246, the location of the storage bin 16 that the product is stored in is accessed by the central control system 136 and the vertical retrieval system 20 retrieves and transports the particular storage bin 16 to a robotic flatbed shuttle 206 situated on the horizontal shuttle grid 200 of the horizontal shuttle system 2 situated below the customer center 248 and the loading bay 228. The robotic flatbed shuttle 206 transports the storage bin 16 on the horizontal shuttle grid 200 to the elevator lift 252 that leads to the particular pickup port in the customer center 248. Once the robotic flatbed shuttle 206 is positioned on the track 272 of the elevator lift 252, the motor 266 drives the track and shuttle 206 situated thereon upwardly within the elevator shaft 256 to the pickup port 1002. After the storage bin 16 is removed from the shuttle 206, the motor 266 lowers the track 272 back to the horizontal shuttle grid 200 of the horizontal shuttle system 202 and the bin 16 is returned to a particular storage module 6 by the vertical retrieval system 20. Alternatively, as will be explained in greater detail in the forthcoming paragraphs, the empty storage bin 16 may be transported by the shuttle 206 to one of the elevator lifts 252 that extends between the horizontal shuttle grid 200 of the horizontal shuttle system 202 and the loading bay 228 so that the bin 16 can be loaded into a logistics trailer (not shown).

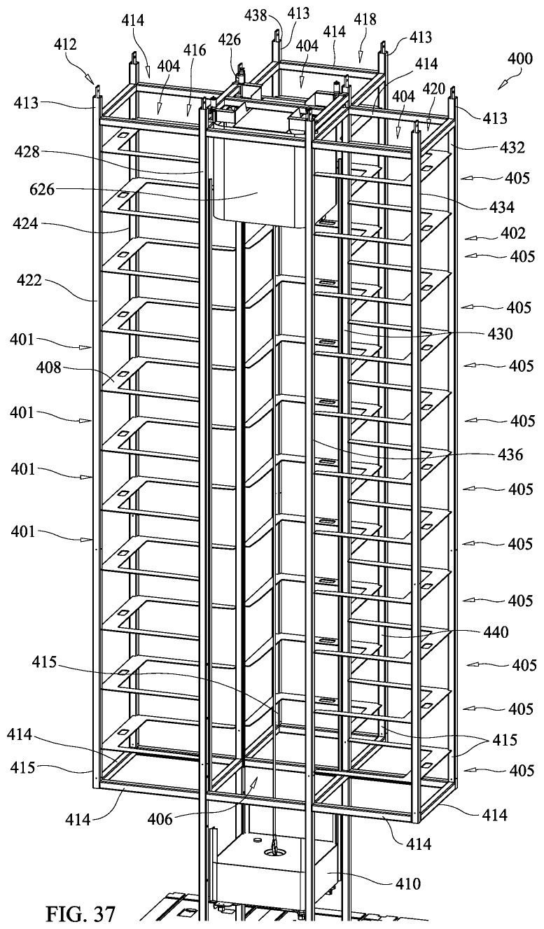

In accordance with a second embodiment of the present invention, as shown in FIG. 37 of the drawings, the scalable logistics tower 2 includes a plurality of vertical storage cell columns 418. Each vertical storage cell column 418 includes one or more vertical storage cells 400. Each vertical storage cell 400 includes a frame 402 that defines a plurality of storage columns 404 and an elevator shaft 406, the storage columns 404 being arranged around the elevator shaft 406. The number of storage columns 404 defined by the frame 402 in each vertical storage cell 400 can be selected to maximize the storage capacity of the logistics tower 2 when the vertical storage cell columns 418 are arranged in a grid-lock manner therein. Preferably, each vertical storage cell 400 includes two to four storage columns 404. A plurality of storage modules 401 into which storage bins 16 are received are situated in each of the storage columns 404. The storage modules 401 are formed as storage bin support trays 408 that are horizontally disposed in each of the storage columns 404. The storage bin support trays 408 in each of the storage columns 404 in the vertical storage cell 400 are aligned and coplanar to define a plurality of storage levels 405. As will be described in greater detail in the forthcoming paragraphs, the storage bins 16 are situated on the storage bin support trays 408 within the storage columns 404 and are selectively removable therefrom by the robotic bin handler 410.

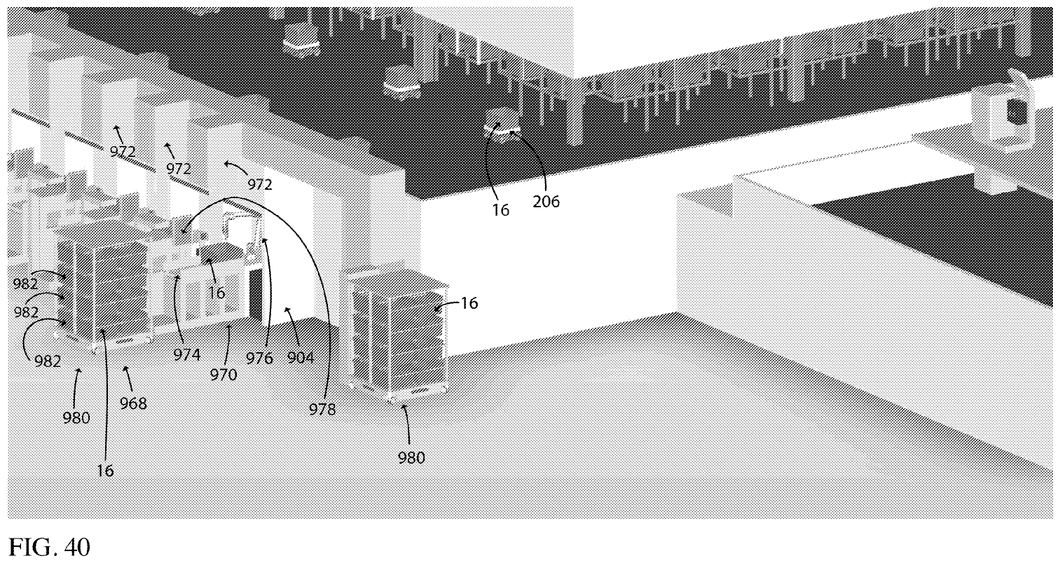

As can be seen in FIGS. 38-42 of the drawings, the vertical storage cells 400 can be stacked on one another in a vertical orientation to increase the storage capacity of the vertical storage column 418 and the logistics tower 2. More specifically, the storage columns 404 and elevator shaft 406 of each vertical storage cell 400 are aligned to form the vertical storage column 418 such that the vertical retrieval system 20 can selectively remove and insert storage bins 16 from the storage columns 404.

Depending on any land variances and zoning laws of the parcel on which the logistics tower 2 is situated (e.g., the size of the parcel where the logistics tower 2 is located), additional vertical storage cells 400 can be added to one or more of the vertical storage columns 418 to increase the height and vertical storage capacity of the logistics tower 2. Furthermore, additional vertical storage cell columns 418 can be added in a grid-like pattern within the logistics tower 2 to increase the width and horizontal storage capacity of the logistics tower 2. Accordingly, the logistics tower 2 formed in accordance with present invention can be both vertically scaled and horizontally scaled to maximize the storage capacity thereof.

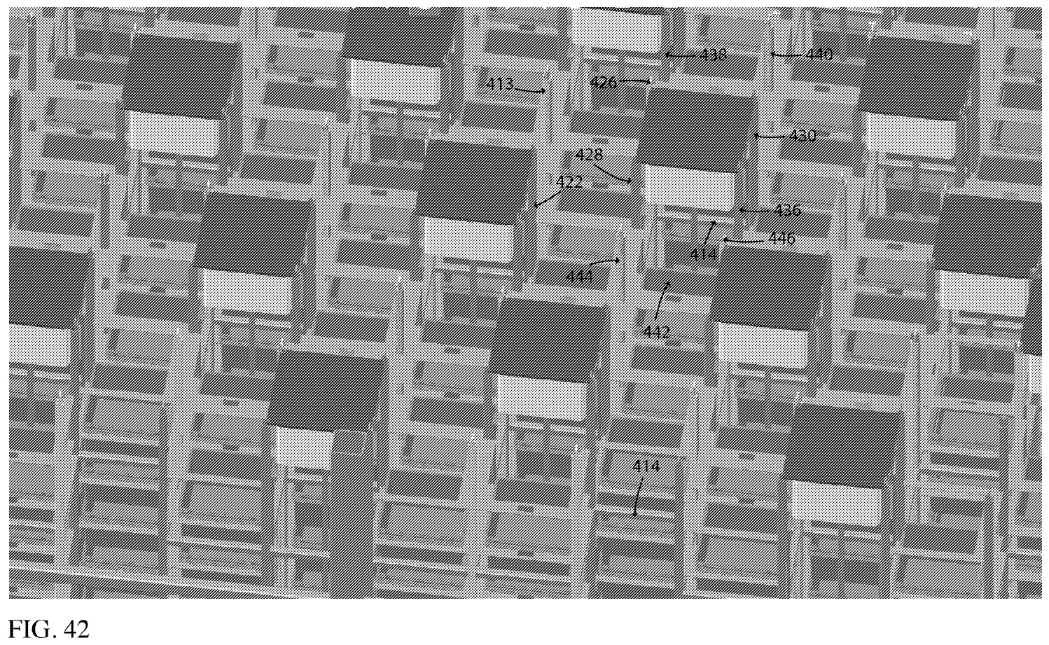

For example, if the parcel has variances prohibiting structures over a certain height, the logistics tower 2 may be horizontally scaled to maximize storage capacity by adding additional vertical storage cell columns 418. As can be seen in FIG. 42 of the drawings, the frames 402 of vertical storage cells 400 of adjacent vertical storage cell columns 418 may be at least partially shared to form one or more storage columns 404 in one or more of the vertical storage cells 400.

If there are no height restrictions on the parcel where the logistics tower 2 is constructed, but the footprint of the property is small, the logistics tower 2 may be vertically scaled by increasing the number of vertical storage cells 400 in the vertical storage cell columns 418 to maximize storage capacity. As explained previously, the number of storage columns 404 in each vertical storage cell 400 can be vary. Accordingly, to maximize the storage capacity of the logistics tower 2, some vertical storage cell columns 418 may include vertical storage cells 400 having four storage columns 404 while other vertical storage cell columns 418 may include vertical storage cells 400 having three storage columns 404.

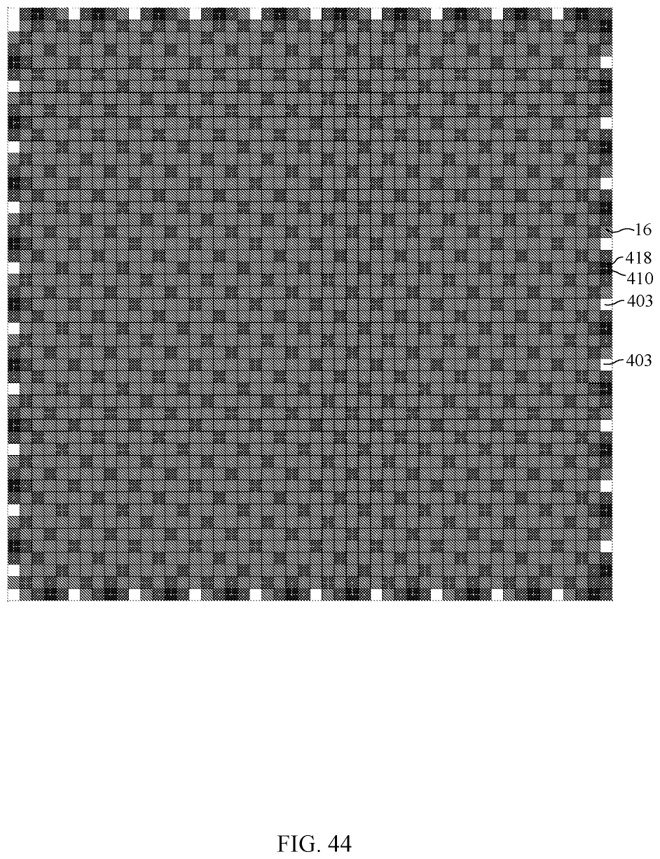

In an exemplary form, as shown in FIG. 43 of the drawings, the logistics tower 2 may be configured such that it has 42 vertical storage cell columns 418 and 42 robotic bin handlers 410, resulting in minimal unusable space 403, as indicated by the white boxes in FIG. 43 of the drawings. Some of the vertical storage cell columns 418 comprise vertical storage cells 400 having three storage columns 404 while other vertical storage cell columns 418 comprise vertical storage cells 400 having four storage columns 404. Each vertical storage cell column 418 has 70 storage levels 405 such that the logistics tower 2 has 70 storage levels. Each storage level 405 has the capacity to receive and store 157 storage bins 16 such that the logistics tower 2 has a total capacity of 10,990 storage bins 16. In another exemplary form, based on an extrapolation of the configuration of the logistics tower shown in FIG. 43 of the drawings, the logistics tower 2 may be configured to include 490 robotic bin handlers 410 and have the capacity to receive and store 63,393 storage bins, as illustrated by the layout schematic shown in in FIG. 44 of the drawings.

The storage capacity of the logistics tower 2 can be varied depending on the shape of the logistics tower 2, any height restrictions on the logistics tower and the footprint of the logistics tower 2 by varying the number of vertical storage cell columns 418, the number of vertical storage cells 400 in each vertical storage cell column 418 and the number of storage columns 404 in each vertical storage cell 400. Additionally, if the logistics tower 2 has a shape that is not square or rectangular, some portions of the logistics tower 2 can be filled with vertical storage cell columns 418 having a first number of vertical storage cells 400 while other portions of the logistics tower 2 can be filled with vertical storage cell columns 418 having a second number of vertical storage cells 400. For example, the logistics tower 2 may have a first portion extending to a first height and a second portion extending to a second height. Accordingly, vertical storage cell columns 418 of varying heights can be arranged in the logistics tower 2 depending on the shape and dimensions thereof.

The frame 402 of each vertical storage cell 400 includes a plurality of vertical members 412 and horizontal members 414 that define the storage columns 404 and elevator shaft 406 thereof. Each vertical member 412 includes an upper end 413 and an opposed disposed lower end 415. For example, the vertical storage cell 400 shown in FIG. 37 of the drawings includes a first storage column 416, a second storage column 418 and a third storage column 420. The first storage column 416 is defined by a first vertical member 422, a second vertical member 424, a third vertical member 426 and a fourth vertical member 428. The upper ends 413 of the first, second, third and fourth vertical members 422, 424, 426, 428 are interconnected by the horizontal members 414. More specifically, the upper end 413 of the first vertical member 422 is connected to the upper end 413 of the second vertical member 424. The upper end 413 of the second vertical member 424 is connected to the upper end 413 of the third vertical member 426. The upper end 413 of the third vertical member 426 is connected to the upper end 413 of the fourth vertical member 428. The upper end 413 of the fourth vertical member 428 is connected to the upper end 413 of the first vertical member 422. Similarly, the lower ends 415 of the first, second, third and fourth vertical members 422, 424, 426, 428 are interconnected by the horizontal members 414. More specifically, the lower end 415 of the first vertical member 422 is connected to the lower end 415 of the second vertical member 424. The lower end 415 of the second vertical member 424 is connected to the lower end 415 of the third vertical member 426. The lower end 415 of the third vertical member 426 is connected to the lower end 415 of the fourth vertical member 428. The lower end 415 of the fourth vertical member 428 is connected to the lower end 415 of the first vertical member 422.

The third storage column 420 is defined by a fifth vertical member 430, a sixth vertical member 432, a seventh vertical member 434 and an eighth vertical member 436. The upper ends 413 of the fifth, sixth, seventh and eighth vertical members 430, 432, 434, 436 are interconnected by the horizontal members 414. More specifically, the upper end 413 of the fifth vertical member 430 is connected to the upper end 413 of the sixth vertical member 432. The upper end 413 of the sixth vertical member 432 is connected to the upper end 413 of the seventh vertical member 434. The upper end 413 of the seventh vertical member 434 is connected to the upper end 413 of the eighth vertical member 436. The upper end 413 of the eighth vertical member 436 is connected to the upper end 413 of the fifth vertical member 430. Similarly, the lower end 415 of the fifth vertical member 430 is connected to the lower end 415 of the sixth vertical member 432. The lower end 415 of the sixth vertical member 432 is connected to the lower end 415 of the seventh vertical member 434. The lower end 415 of the seventh vertical member 434 is connected to the lower end 415 of the eighth vertical member 436. The lower end 415 of the eighth vertical member 436 is connected to the lower end 415 of the fifth vertical member 430.

The second storage column 418 is defined by the third vertical member 426, the fifth vertical member 430, a ninth vertical member 438 and a tenth vertical member 440. The upper ends 413 of the third, ninth, tenth and fifth vertical members 426, 438, 440, 430 are interconnected by the horizontal members 414. More specifically, the upper end 413 of the third vertical member 426 is connected to the upper end 413 of the ninth vertical member 438. The upper end 413 of the ninth vertical member 438 is connected to the upper end 413 of the tenth vertical member 440. The upper end 413 of the tenth vertical member 440 is connected to the upper end 413 of the fifth vertical member 430. The upper end 413 of the fifth vertical member 430 is connected to the upper end 413 of the third vertical member 426. Similarly, the lower end 415 of the third vertical member 426 is connected to the lower end 415 of the ninth vertical member 438. The lower end 415 of the ninth vertical member 438 is connected to the lower end 415 of the tenth vertical member 440. The lower end 415 of the tenth vertical member 440 is connected to the lower end 415 of the fifth vertical member 430. The lower end 415 of the fifth vertical member 430 is connected to the lower end 415 of the third vertical member 426.

For stability purposes, a horizontal member 414 may also connect the upper end 413 of the eighth vertical member 436 to the upper end 413 of the fourth vertical member 428. Similarly, a horizontal member 414 may also connect the lower end 415 of the eighth vertical member 436 to the lower end 415 of the fourth vertical member 428.

As shown in FIG. 42 of the drawings, the vertical storage cell 400 may also include a fourth storage column 442. The fourth storage column 442 is defined by the fourth vertical member 428, the eighth vertical member 436, an eleventh vertical member 446 and a twelfth vertical member 444. The upper ends 413 of the fourth, eighth, eleventh and twelfth vertical members 428, 436, 446, 444 are interconnected by the horizontal members 414. More specifically, the upper end 413 of the eighth vertical member 436 is connected to the upper end 413 of the eleventh vertical member 446. The upper end 413 of the eleventh vertical member 446 is connected to the upper end 413 of the twelfth vertical member 444. The upper end 413 of the twelfth vertical member 444 is connected to the upper end 413 of the fourth vertical member 428. The upper end 413 of the fourth vertical member 428 is connected to the upper end 413 of the eighth vertical member 436. Similarly, the lower end 415 of the eighth vertical member 436 is connected to the lower end 415 of the eleventh vertical member 446. The lower end 415 of the eleventh vertical member 446 is connected to the lower end 415 of the twelfth vertical member 444. The lower end 415 of the twelfth vertical member 444 is connected to the lower end 415 of the fourth vertical member 428. The lower end 415 of the fourth vertical member 428 is connected to the lower end 415 of the eighth vertical member 436.

As described previously, each storage bin support tray 408 is situated within a respective storage column 404. More specifically, each storage bin support tray 408 is horizontally disposed within one of the storage columns 404 and joined to or engaged with the vertical members 412 that define the respective storage column 404 that the storage bin support tray 408 is situated within. The storage bin support tray 408 is preferably formed in a U-shape with a closed end portion 450, a pair of parallel spaced apart legs 452 extending outwardly from the closed end portion 450 and an open end 454 at the far end of the parallel, straight legged portion 452. The closed end portion 450 and parallel, straight legged portion 452 define a receptacle 456 that the storage bin 16 is received within, the receptacle 456 generally conforming to the shape of the storage bin 16.

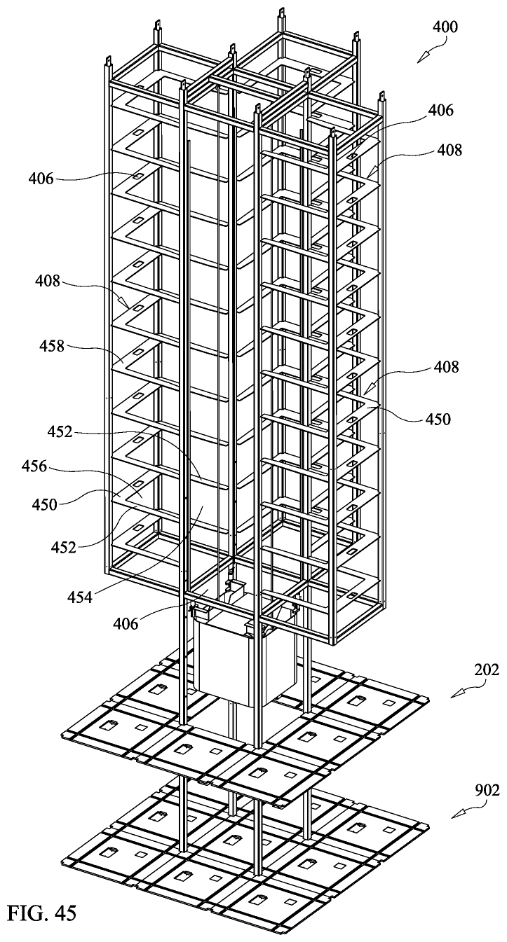

The storage bin support tray 408 includes a top surface 458 on which the third flange 33 of the storage bin 16 rests. If the storage bin 16 only includes a first flange 30 and a second flange 32, the second flange 32 rests on the top surface 458 of the storage bin support tray 408. As can be seen in FIG. 45 of the drawings, the open end 454 the of storage bin support tray 408 is situated in proximity to the elevator shaft 406 such that storage bins 16 engaged by the robotic bin handler 410 in the elevator shaft 406 can be inserted through the open end 454 into the receptacle 456.

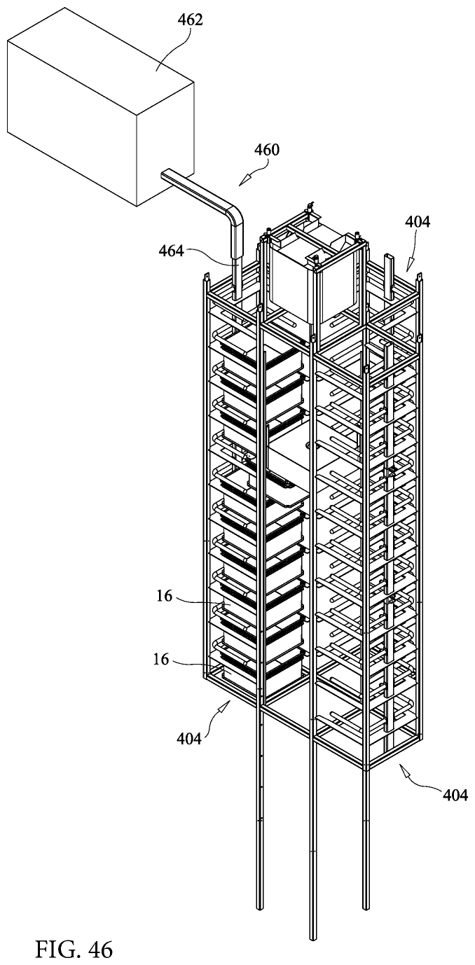

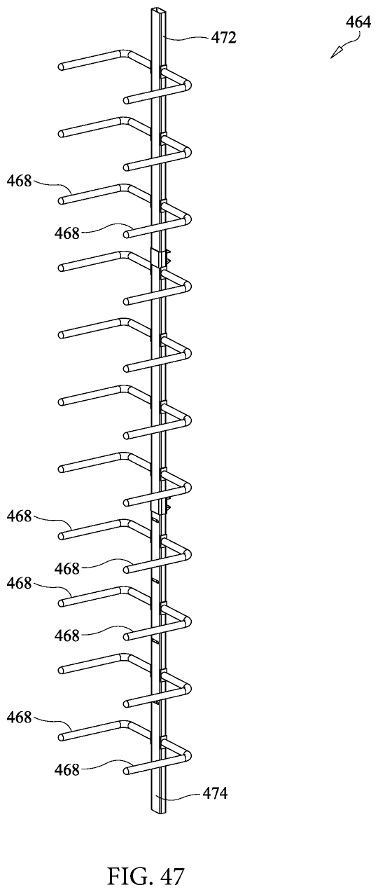

The scalable logistics tower 2 formed in accordance with the present invention may also include a temperature control system 460. The temperature control system 460 includes one or more heating, ventilation and air conditioning units 462 that are fluidly connected to a cooling column 464 that extends, at least partially, through a storage column 404 of the vertical storage cells 400 forming the vertical storage cell columns 418. More specifically, as can be seen in FIGS. 46 and 47 of the drawings, a cooling column 464 extends through an opening 466 formed through each closed end portion 450 of the storage bin support tray 408 in a respective storage column 404 of the vertical storage cell 400. A plurality of cooling arms 468 in fluid communication with the cooling column 464 extend outwardly therefrom above each storage bin support tray 408. The cooling arms 468 include dispersion vents or holes that extend through at least a portion of the cooling arms 468 and direct heated or cooled air towards the open top 22 of the storage bin 16 and contents thereof.

As shown in FIG. 47 of the drawings, each cooling column 464 includes a first axial end 472 and an oppositely disposed second axial end 474. When the vertical storage cells 400 are stacked on top of one another to form the vertical storage cell columns 418, the first axial end 472 of one cooling column 464 may be engaged with or received within the second axial end 474 of one cooling column 464 in the vertical storage cell 400 above. One of the ends 472, 474 of the cooling columns 464 is connected to the heating, ventilation and air conditioning unit 462. As can be seen in FIG. 46 of the drawings, each storage column 404 of the vertical storage cell 400 preferably includes a cooling column 464.

Storage bins 16 are inserted and withdrawn from the storage bin support trays 408 of the in the vertical storage cell 400 by one or more vertical retrieval systems 20. In another form, the vertical retrieval system 20 comprises a winch 626 and a robotic bin handler 410 coupled thereto. As can be seen in FIG. 37 of the drawings, the winch 626 is preferably situated in a top portion 128 of the logistics tower 2. The winch 626 is aligned with the elevator shaft 406 defined by the frame 402 of the one or more vertical storage cells 400 that form a particular vertical storage cell column 418.

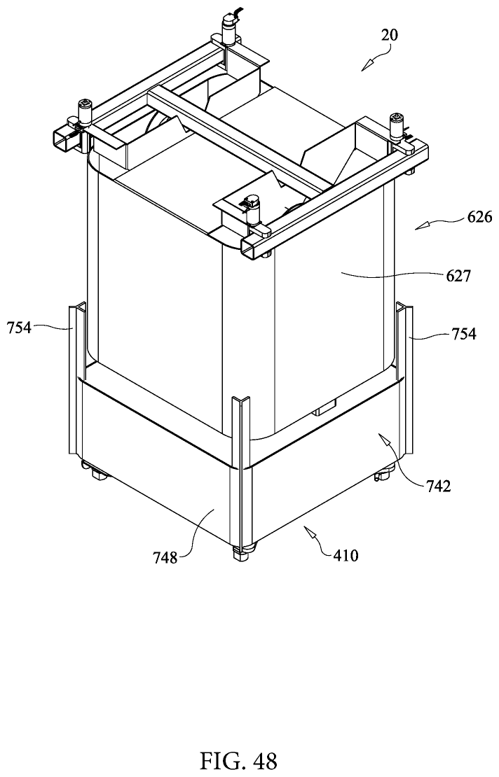

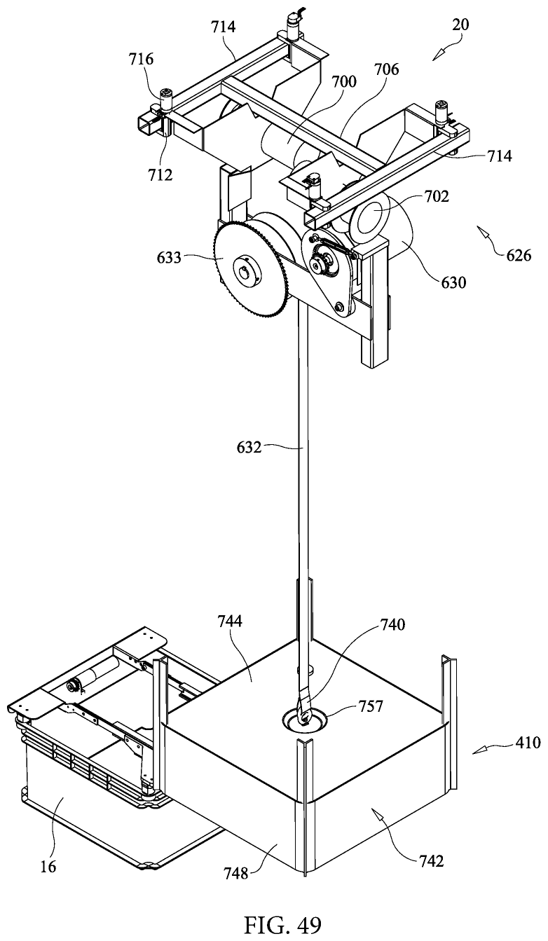

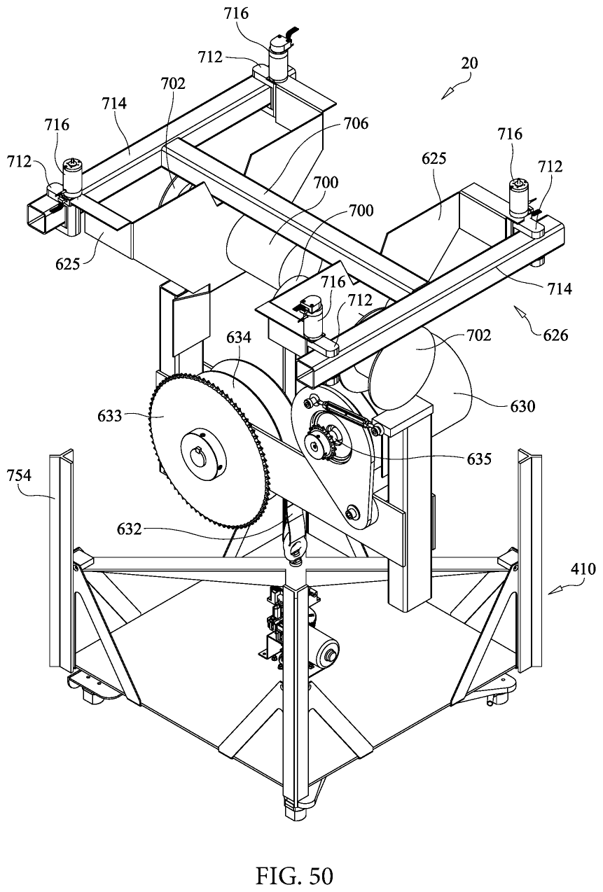

As can be seen in FIGS. 48-50 of the drawings, the winch 626 includes a housing 627 defining an internal cavity in which the winch frame 625 and the internal components are situated. The winch 626 includes a primary motor 630 that selectively advances and retracts a main cable 632 connected to the robotic bin handler 410 that is situated within and traverses the elevator shaft 406. In one form, the primary motor 630 may be mechanically coupled to a cable drum 634 on which the cable 632 is coiled, for example, by chain driven gearing 633, 635. The primary motor 630 selectively rotates the cable drum 634 to advance and retract the cable 632 through the elevator shaft 406 of a particular vertical storage cell column 418.

The winch 626 further includes at least one, but preferably two, secondary motors 700. Each secondary motor 700 is mechanically coupled to a secondary cable drum 702 on which a secondary cable 704 is coiled. The free end 708 of each secondary cable 704 is mechanically coupled to a cross member 706 situated above the elevator shaft 406 in the top portion 128 of the logistics tower 2 or on a top portion of the vertical storage cell 400 or vertical storage cell column 418. Preferably, the cross member 706 includes two eye loops 710 extending downwardly therefrom towards the elevator shaft 406 that are mechanically coupled to the free ends 708 of the secondary cables 704.

The winch further includes a plurality of winch clamps 712 extending upwardly from the winch frame 626. The winch clamps 712 are mechanically actuated, for example by gear motors 716, and selectively rotate between at least a first position and a second position. In the first position, the winch clamps 712 mechanically engage support members 714 situated above the elevator shaft 406 in the top portion 128 of the logistics tower 2 or on a top portion of the vertical storage cell 400 or vertical storage cell column 418, thereby securing the winch 626 thereto. In the second position, the winch clamps 712 rotate inwardly towards the winch 626 and disengage the support members 714, thereby releasing the winch 626 therefrom.

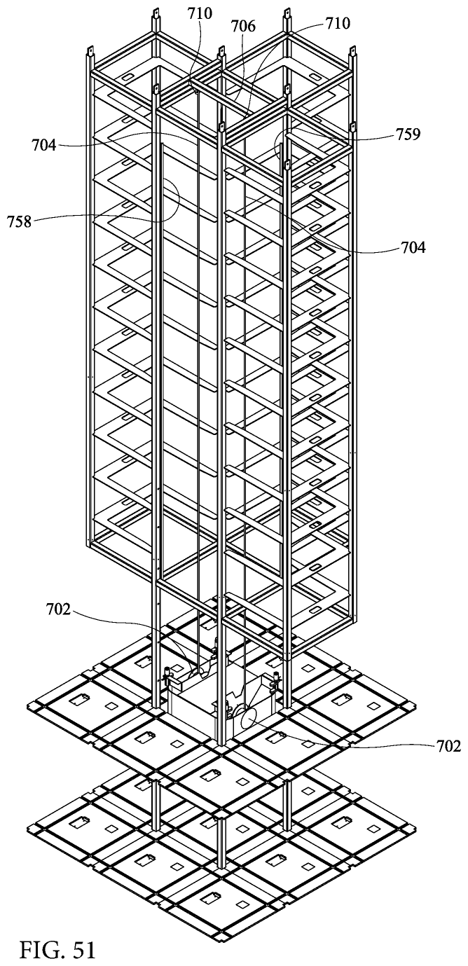

For servicing purposes, the winch 626 is selectively lowerable from the top portion of the logistics tower 2 or vertical storage cell column 418 through the elevator shaft 406, as shown in FIGS. 45 and 51 of the drawings. More specifically, to lower the winch 626, the winch clamps 712 are disengaged from the support members 714 and the secondary motors 700 rotate the drums 702 to lower the winch 626 from the logistics tower 2 with the secondary cables 704. The winch 626 can be lowered to the horizontal shuttle grid 200 or therethrough to a lower horizontal shuttle grid. The winch 626 and robotic bin handler 410 coupled thereto may also be lowered onto a robotic flatbed shuttle 206 situated on the horizontal shuttle grid 200 of the horizontal shuttle system 202. After service, the secondary motors 700 rotate the drums 702 to retract the secondary cables 704 and situate the winch 626 in proximity to the top portion 128 of the logistics tower 2 and, thereafter, the winch clamps 712 are engaged with the support members 714. As will be described in greater detail in the forthcoming paragraphs, the primary motor 630 and the secondary motors 700 are in electrical communication with computer 138 of the central control system 136 of the logistics tower 2 and are selectively controllable thereby.

A robotic bin handler 410 is mechanically coupled to a free end 740 of the cable 632 of the winch 626 and is generally situated in the elevator shaft 406 defined by the frame 402 of the one or more vertical storage cells 400 that form a particular vertical storage cell column 418. The robotic bin handler 410 is selectively, vertically movable within the elevator shaft 406 to deliver and retrieve storage bins 16 from the storage bin support trays 408 in the vertical storage cell columns 418. More specifically, the winch 626 raises and lowers the robotic bin handler 410 to a particular storage level 405 in the vertical storage cell column 418 so that the robotic bin handler 410 may access the storage bins 16 in the receptacles 456 of the storage bin support trays 408.

As can be seen in FIGS. 48-50 of the drawings, the robotic bin handler 410 includes a main housing 742 having a top surface 744, a bottom surface 746 disposed opposite the top surface 744 and a sidewall 748 extending therebetween. The top surface 744, bottom surface 746 and sidewall 748 of the main housing 742 define an internal cavity 750. The frame 743 of the robotic bin handler 410 is situated within the internal cavity of the housing 750. A cable mount 752 is situated on a center portion 755 of the frame 743 that is aligned with an opening 757 in the top surface 744 of the housing 742 The free end 740 of the winch cable 632 extends through the opening 757 and is coupled to the cable mount 752. The housing 742 is preferably rectangular in shape and conforms to the dimensions and shape of the elevator shaft 406 to limit undesired movement of the robotic bin handler 410 as it traverses the elevator shaft 8. As can be seen in FIGS. 48-50 of the drawings, the robotic bin handler 410 includes a plurality of guides 754 that are received within corresponding channels 759 formed in the portions of the frame 402 that define the elevator shaft 406. The guides 754 and channels 759 guide the robotic bin handler 410 through the elevator shaft 406.

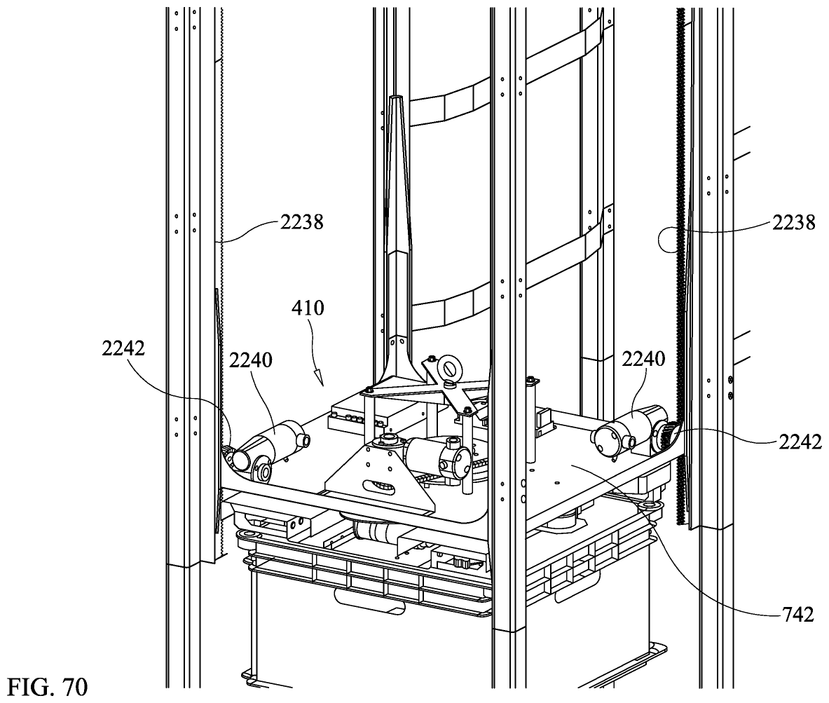

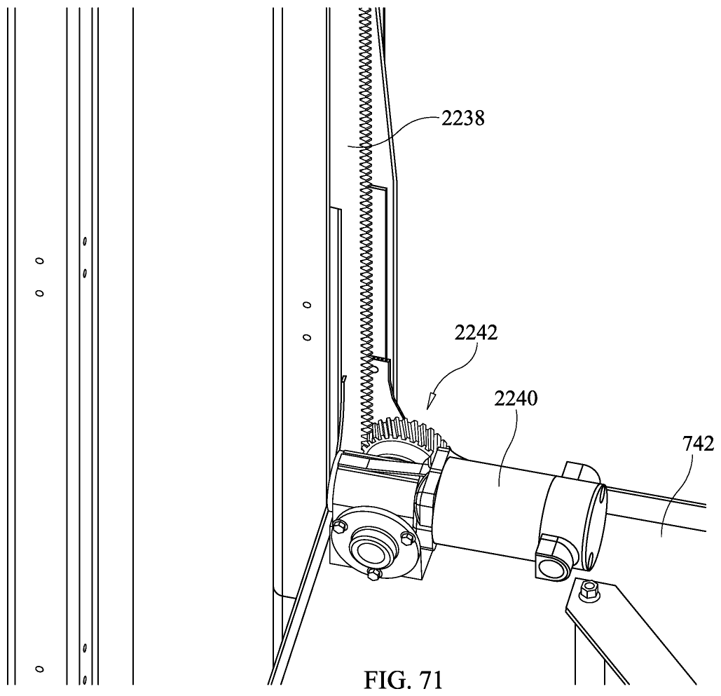

In another form, as shown in FIGS. 70 and 71 of the drawings, the robotic bin handler 410 may traverse the elevator shaft 406 by means of a rack and pinion system without the use of a winch 626. More specifically, a plurality of linear gears (e.g., racks) 2238 may be situated in the channels 759 or on the portions of the frame forming the elevator shaft 406. A plurality of drive motors 2240 are mounted to the main housing 742 of the robotic bin handler 410. A pinion gear 2242 is coupled to each drive motor 2240 and engages a respective linear gear 2238 situated along the elevator shaft 406. The drive motors 2240 drive the robotic bin hander 410 up and down within the elevator shaft 406.

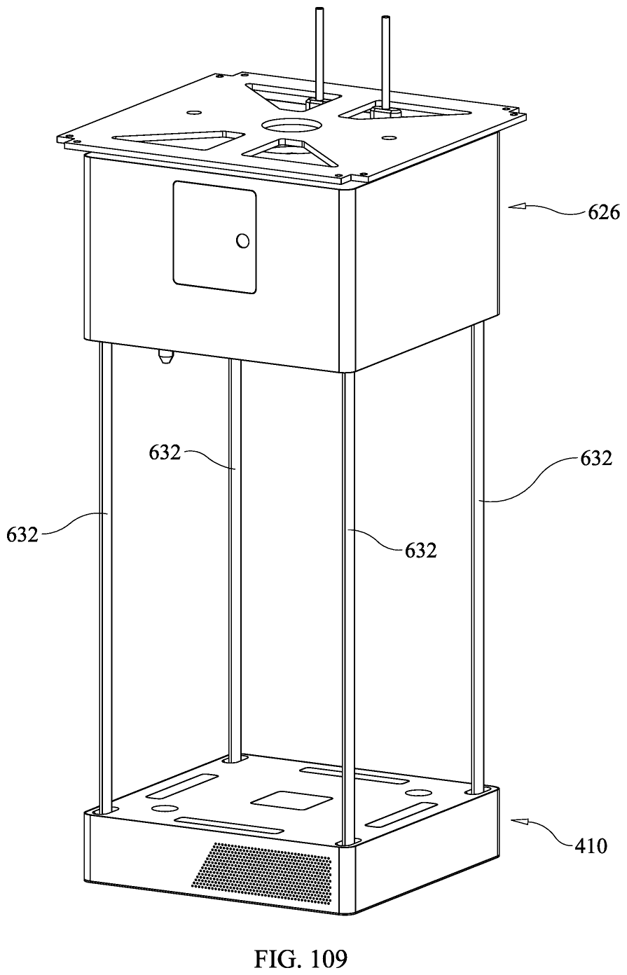

As can be seen in FIG. 109 of the drawings, in yet another embodiment of the present invention, the winch 626 includes one or more primary motors 630 that selectively advance and retract one or more main cables 632, preferably four, connected to the robotic bin handler 410 that is situated within and traverses the elevator shaft 406. The cables may include sensors that sense the amount of cable the winch 626 has let out.

The robotic bin handler 410 further includes a gripping assembly 758 that inserts and removes storage bins 16 from the storage bin support trays 408 in the vertical storage cell columns 418. More specifically, the gripping assembly 758 includes a base 760 and a carriage 800. The carriage 800 is preferably mechanically coupled to the base 760 and selectively extendable and retractable therefrom. The base 760 is rotatably mounted to the bottom surface 746 of the housing 742 by a crossed roller bearing 828 which handles the radial, axial, and moment forces of the extension system 812, and mechanically coupled to a motor 768 that is at least partially situated within the internal cavity 750 of the housing 742 of the robotic bin handler 410. The motor 768 selectively rotates the base 760 about the Z-axis (e.g., the vertical axis of the cable 632 within the elevator shaft 406). The base 760 is rotatable in 360 degrees so that the carriage 800 can access storage bin support trays 408 situated in each of the storage columns 404 of the vertical storage cells 400 forming the vertical storage cell columns 418, and selectively insert and withdraw storage bins 16 therefrom.

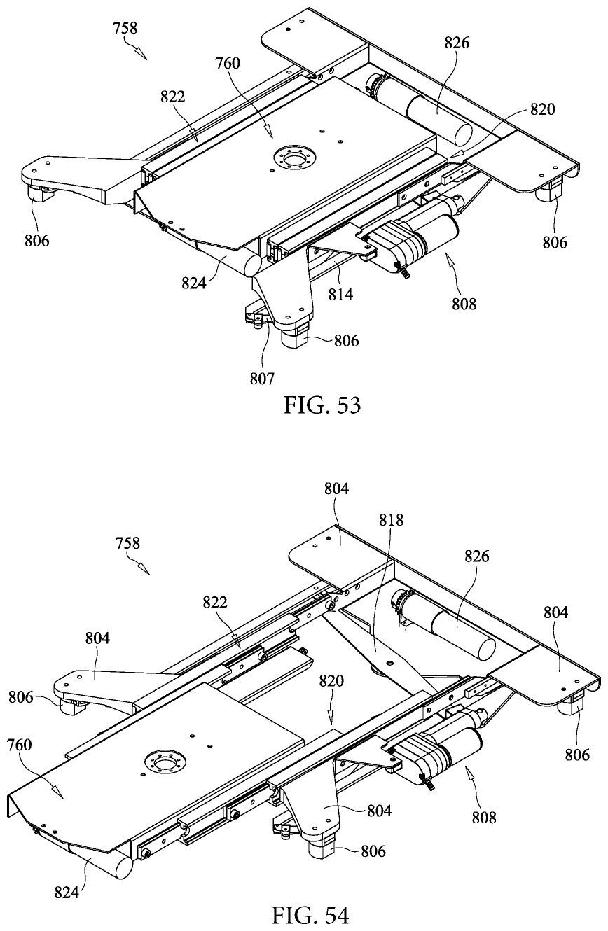

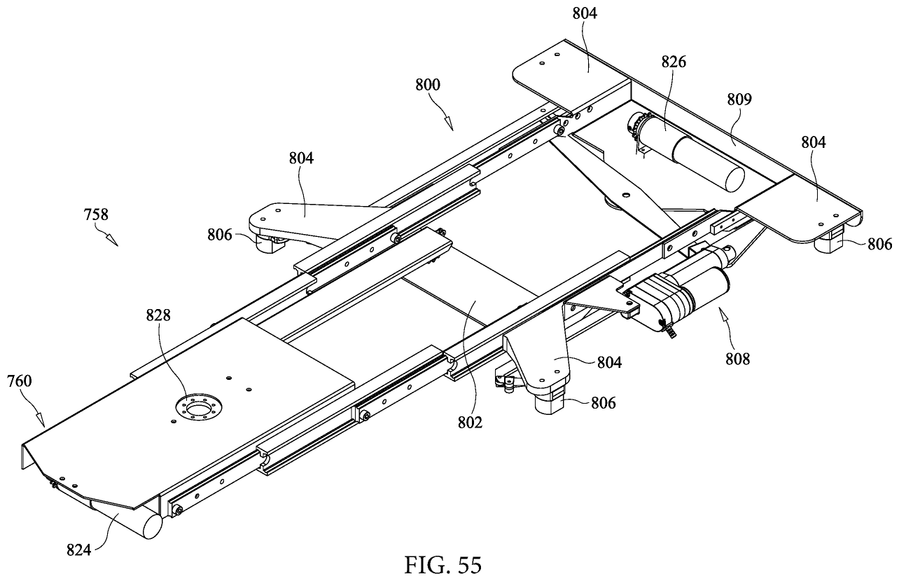

As can been seen in FIGS. 53-56 of the drawings, the carriage 800 includes a frame 802 and a plurality of arms or magnet mounting brackets 804 extending outwardly therefrom. At least one selectively activatable magnet 806 having a control lever 807, for example, a mechanically actuatable magnet such as a Magswitch® or another mechanical permanent magnet that can be switched on and off by moving a control lever 806, is situated on each arm 804 of the plurality of arms 804 and extends downwardly therefrom. The arms 804 and magnets 806 on the carriage 800 are arranged in a specific orientation that is complementary to the arrangement of the metal lugs 500 that are situated around the periphery of the storage bin 16. The magnets 806, in particular, the control levers 807 thereof, are mechanically coupled to the linear actuator 808 by a plurality of mechanical linkages 810 such that the magnets are mechanically switchable in unison between at least a first state and a second state by the linear actuator 808.

More specifically, one pair of magnets 806 are connected by an actuated linkage 814 that is mechanically coupled to the linear actuator 808. The other pair of the magnets 806 are connected by a passive linkage 816 that is mechanically coupled the actuated linkage 814 by a cross link 818. As the linear actuator 808 drives the actuated linkage 814 between a first position and a second position, the passive linkage 816 mechanically coupled thereto also moves between a first position and a second position. The movement of the actuated linkage 814 and the passive linkage 816 causes the magnets 806 to switch between a first state and a second state.

In the first state, the magnets 806 emanate a magnetic field that attracts the metal lugs 500 that are situated around the periphery of the storage bin 16. In a second state, the magnets 806 do not emanate a magnetic field and thus, do not attract the metal lugs 500. Accordingly, as will be described in greater detail in the forthcoming paragraphs, when the carriage 800 is positioned over a storage bin 16 situated in the receptacle 456 of the storage bin support tray 408, the linear actuator 808 switches the magnets 806 to the first state to magnetically couple a storage bin 16 to the carriage 800. To decouple the storage bin 16 from the carriage 800, the linear actuator switches the magnets 806 to the second state, thereby releasing the storage bin 16 from the carriage 800. It is also envisioned to be within the scope of the present invention to also use electromagnets to couple the storage bins 16 to the carriage 800.

As mentioned previously, the carriage 800 is mechanically coupled to the base 760, preferably, by a multi-stage extension system 812. More specifically, as can be seen in FIGS. 53-56 of the drawings, the multi-stage extension system preferably includes a first five stage slide 820 and a second five stage slide 822. The multi-stage extension system 812 is driven by a first roller chain gearmotor 824 situated on the base 760 and a second roller chain gearmotor 826 situated on a front magnet mount 809. The roller chain gearmotors 824, 826 selectively extend and retract the carriage 800 from the base 770 to retrieve and place storage bins 16. The five stage slides 820, 822 may also operate similarly to the rail actuators 170 and rail slides 172, as well as the sub-components thereof, described previously with respect to the robotic bin handler 10.

Generally, the whole assembly has coordinated motion between the roller chain drives 824, 826 and linear actuator 808, to minimize the total cycle time of extending out and picking up a storage bin (e.g., a “tote”). The process generally includes the steps of: the winch 626 positions the robotic bin handler 410 at the storage level 405 where a storage bin 16 to be retrieved is located, in particular, so that the robotic bin handler 410 is slightly above the storage bin; the extension system 812 causes the carriage 800 to be extended from the base 760; the linear actuator 808 causes the magnets 806 to generate/emanate a magnetic field; the winch 626 lowers the robotic bin handler 410 slightly so that the magnets 806 attach to metal lugs 500 in storage bin 16; the winch 626 raises the robotic bin handler 410 slightly, the extension system 812 causes the carriage 800 to be retracted towards the base 760; the winch 626 lowers the robotic bin handler 410 and storage bin 16 coupled thereto the horizontal shuttle grid 200; the robotic flatbed shuttle 206 positions itself below the elevator shaft 406 and the robotic bin handler 410; the winch 626 lowers the robotic bin handler 410 to just above the robotic flatbed shuttle 206; the linear actuator 808 causes the magnets 806 to cease generating a magnetic field, causing the storage bin 16 to be decoupled from the carriage 800; the horizontal flatbed shuttle 206 drives away; and the vertical retrieval system 20 comprising the winch 626 and robotic bin handler 410 waits for the next horizontal flatbed shuttle 206 to be positioned thereunder, if applicable.

The locations of each of the storage bin support trays 408 (e.g., the location within a specific vertical storage cell column 418 that the particular storage bin support tray 408 is located in are stored in the central control system 136, as well as the identity and location of the storage bins 16 and any parcels contained therein. To retrieve a storage bin 16 from a storage bin support tray 408 in the vertical storage cell column 418, the winch 626 extends the cable 632 and lowers the robotic bin handler 410 coupled thereto to the particular storage level 405 of the vertical storage cell column 418 that the storage bin 16 to be retrieved is located. The motor 768 of the robotic bin handler 410 rotates the base 760 so that the carriage 800 is aligned with the storage bin support tray 408 containing the storage bin 16 to be retrieved. The robotic bin handler 410 may further include sensors, such as optical sensors utilized with a vision guidance system, to assist with aligning the robotic bin handler 410 and carriage 800 thereof with the storage bin support tray 408 containing the storage bin 16 to be retrieved.

After the robotic bin handler 410 has been positioned in front of storage bin support tray 408 containing the storage bin 16 to be retrieved such that the carriage 800 is positioned slightly higher than the open top end 22 the storage bin 16, the multi-stage extension system 812, in particular, the first five stage slide 820 and the second five stage slide 822, extend outwardly from the base 760, thereby advancing the carriage 800 into the particular storage column 404 where the storage bin 16 to be retrieved is located. The carriage 800 is advanced into the storage column 404 until the magnets 806 thereof are situated above the respective metal lugs 500 of the storage bin 16. Thereafter, the linear actuator 808 drives the actuated linkage 814 to the first position, which drives the passive linkage 816 mechanically coupled thereto by the cross link 818 to move to the first position. The movement of the actuated linkage 814 and the passive linkage 816 to their respective first positions causes the linkages 814, 816 to bias the control levers 807 of the magnets 806 and switch the magnets 806 into a first state wherein each magnet 306 emanates a magnetic field. The magnetic fields of the magnets 806 attract the metal lugs 500 of the storage bin 16 thereto, which causes the storage bin 16 to be coupled to the carriage 800. Optionally, the winch 626 lowers the robotic bin handler 410 slightly to facilitate the coupling of the magnets 806 to the metal lugs 500, and the storage bin 16 to the carriage 800.

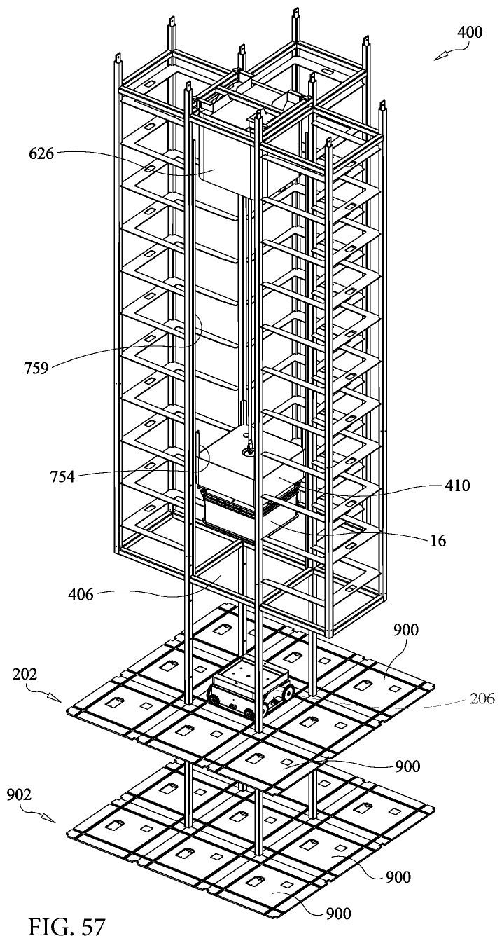

After the storage bin 16 has been coupled to the carriage 800, preferably, the winch 626 raises the robotic bin handler 410 slightly in the elevator shaft 406. Thereafter, the extension system 812, in particular, the first five stage slide 820 and the second five stage slide 822 thereof, retract the carriage 800 inwardly towards the robotic bin handler 410, thereby withdrawing the storage bin 16 from the storage bin support tray 408. As can be seen in FIG. 57 of the drawings, after the storage bin 16 has been withdrawn from the storage bin support tray 408, the carriage 800 and the storage bin 16 engaged therewith are situated substantially below the robotic bin handler 410 in the elevator shaft 406, which allows the robotic bin handler 410 to traverse the elevator shaft 406 to a delivery point.

As will be described in greater detail in the forthcoming paragraphs, after a storage bin 16 has been retrieved from the storage bin support tray 408, the winch 626 extends the cable 632 and robotic bin handler 410 coupled thereto downwardly through the elevator shaft 406 to a robotic flatbed shuttle 206 positioned therebelow on the horizontal shuttle grid 200. After the storage bin 16 has been lowered to the robotic flatbed shuttle, the linear actuator 808 drives the actuated linkage 814 to the second position, which drives the passive linkage 816 mechanically coupled thereto by the cross link 818 to move to the second position. The movement of the actuated linkage 814 and the passive linkage 816 to their respective second positions causes the linkages 814, 816 to bias the control levers 807 of the magnets 806 and switch the magnets 806 into a second state in which the magnets 806 do not emanate a magnetic field. After the magnets 806 are switched to their second state, the storage bin 16 decouples from the carriage 800, which allows the robotic flatbed shuttle 206 to transport the storage bin 16 to a particular destination.

Similarly, the robotic bin handler 410 may also transport a storage bin 16 to a particular storage bin support tray 408 for storage, albeit in a reversed order from the operation set forth above. More specifically, to pick up a storage bin 16 for transport to a storage bin support tray 408, the winch 626 lowers the robotic bin handler 410 to the storage bin 16 to be retrieved. For example, the storage bin 16 may be situated on a robotic flatbed shuttle 206 situated on the horizontal shuttle grid 200. Alternatively, the storage bin 16 may be located on the ground floor or a subterranean loading station in the logistics tower 2. After the robotic bin handler 410 has been lowered to the storage bin 16 and the magnets 806 thereof are situated above the respective metal lugs 500 of the storage bin 16, the linear actuator 808 drives the actuated linkage 814 to the first position, which drives the passive linkage 816 mechanically coupled thereto by the cross link 818 to move to the first position. The movement of the actuated linkage 814 and the passive linkage 816 to their respective first positions causes the linkages 814, 816 to bias the control levers 807 of the magnets 806 and switch the magnets 806 into a first state wherein each magnet 306 emanates a magnetic field. The magnetic fields of the magnets 806 attract the metal lugs 500 of the storage bin 16 thereto, which causes the storage bin 16 to be coupled to the carriage 800.

After the storage bin 16 has been coupled to the carriage 800, the winch 626 then retracts the cable 632 so that the robotic bin handler 410 moves upwardly through the elevator shaft 406 to a particular storage cell level 405 within the vertical storage cell column 418 on which the storage bin 16 will be stored. After the winch 626 positions the robotic bin handler 410 at the particular storage level 405, the motor 768 rotates the base 760 so that the carriage 800 is aligned with the particular storage column 404 containing the particular storage bin support tray 408 that will receive the storage bin 16. Thereafter, the multi-stage extension system 812, in particular, the first five stage slide 820 and the second five stage slide 822 extend outwardly from the base 760, thereby advancing the carriage 800 and storage bin 16 coupled thereto into the particular receptacle 456 of the storage bin support tray 408 such that the third flange 33 of the storage bin 16 is situated on the top surface 458. Optionally, the winch 626 may slightly lower robotic bin handler 410 so that the third flange 33 of the storage bin 16 rests on the top surface 458 of the storage bin support tray 408.

After the storage bin 16 is at least partially situated on the storage bin support tray 408, the linear actuator 808 drives the actuated linkage 814 to the second position, which drives the passive linkage 816 mechanically coupled thereto by the cross link 818 to move to the second position. The movement of the actuated linkage 814 and the passive linkage 816 to their respective second positions causes the linkages 814, 816 to bias the control levers 807 of the magnets 806 and switch the magnets 806 into a second state in which the magnets 806 do not emanate a magnetic field, thereby decoupling the storage bin 16 from the carriage 800.

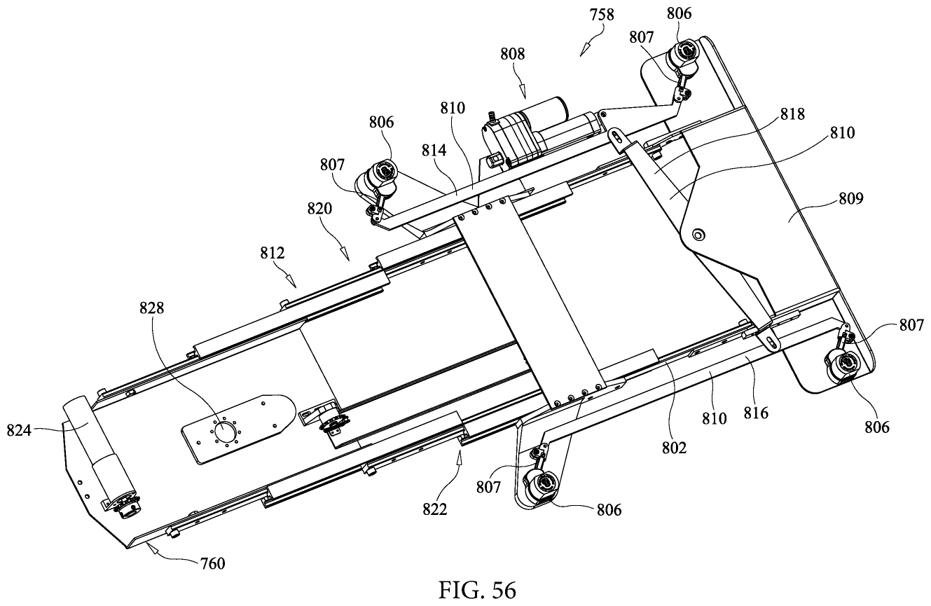

After the storage bin 16 has been decoupled from the carriage 800, the extension system 812, in particular, the first five stage slide 820 and the second five stage slide 822 thereof, retracts the carriage 800 inwardly towards the robotic bin handler 410, thereby withdrawing carriage 800 from the storage column 404. As can be seen in FIG. 56 of the drawings, after the carriage 800 has been withdrawn from the storage column 404, the carriage 800 is situated substantially below the robotic bin handler 410 in the elevator shaft 406, which allows the robotic bin handler 410 to traverse the elevator shaft 406 for another task.

The horizontal shuttle system 202 and the components thereof utilized in the first embodiment of the scalable logistics tower 2 described above are also utilized in the second embodiment of the scalable logistics tower 2. On or more of the rail tiles 900, in particular the rail tiles below the elevator shafts 406, include one or more electromechanical actuators that allow the rail tile 900 to swing downwardly or hingedly away from the adjacent rail tiles so that the robotic bin handler 410 or winch 626 may be lowered from the logistics tower 2 therethrough for servicing. The operation, control and communication between the components of the horizontal shuttle system 202 and the other components of the scalable logistics tower 2 in the first and second embodiments thereof are also substantially the same. For example, the central control system 136 coordinates the retrieval of storage bins 16 from the storage bin support trays 408 and placement of such storage bins 16 on the robotic flatbed shuttles 206 that traverse the horizontal shuttle grid 200.

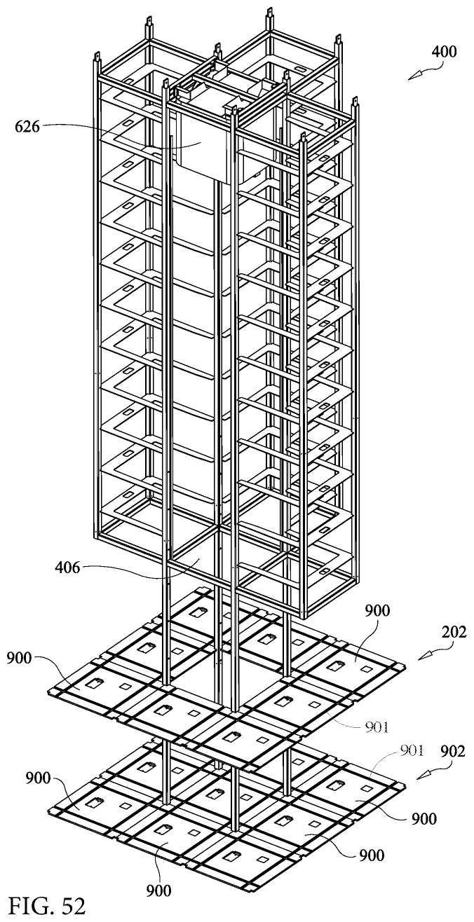

Furthermore, as can be seen in FIG. 52 of the drawings, in the second embodiment of the logistics tower, the parcel transit system 258 situated at a lower level of the logistics tower 2 is formed as a second horizontal shuttle system 902. The second horizontal shuttle system 902 includes the same components of the horizontal shuttle system 202; however, it is situated below the horizontal shuttle system 202. A plurality of passive elevators 904 and active elevators 903 extend between the horizontal shuttle system 202 and the second horizontal shuttle system 902 situated therebelow.

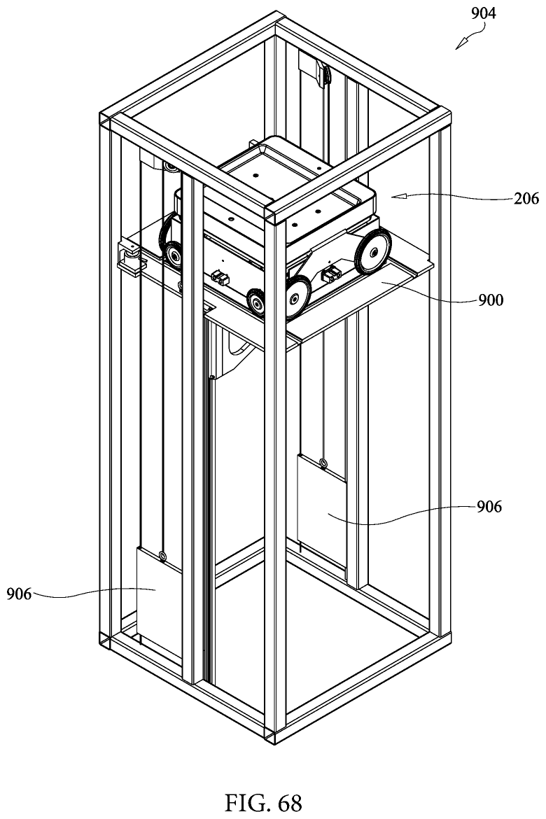

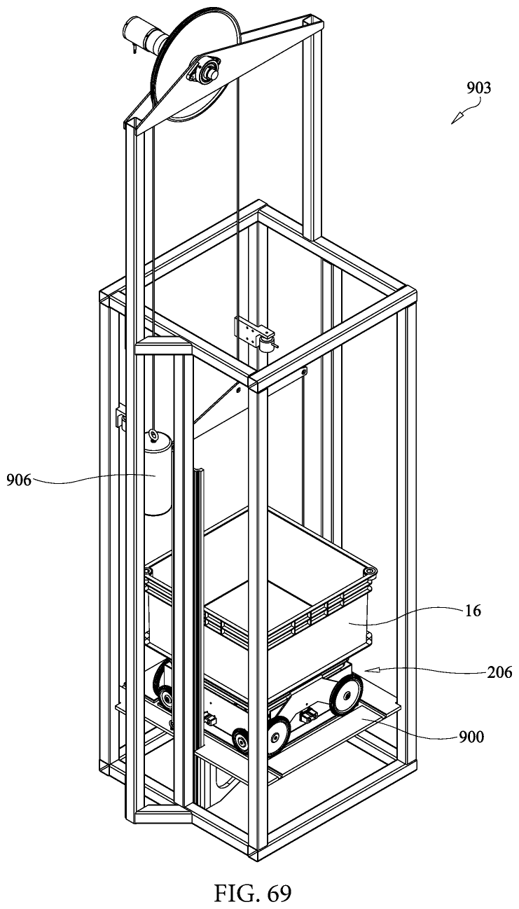

More specifically, as shown in FIG. 68 of the drawings, the passive elevators 904 merely include counterweights 906 that are equal to or slightly heavier than the weight of an unloaded robotic flatbed shuttle. The rail tile 900 situated above the passive elevator 904 services as the platform of the passive elevator 904 that transports the shuttle 206 from the horizontal shuttle grid 200 of the horizontal shuttle system 202 to the second horizontal rail system 902 situated below. More specifically, when a robotic flatbed shuttle 206 that is loaded with a storage bin 16 drives onto the rail tile 900 that serves as a platform for the passive elevator 904, the combined weight of the robotic flatbed shuttle 206 and the loaded storage bin 16 situated thereon overcomes the counter weight 906 and the rail tile 900 (e.g., the passive elevator 904 platform) lowers the loaded shuttle 206 from the horizontal rail system 202 to the second horizontal rail system 902 situated below. After the shuttle 206 drives off the platform onto the second horizontal rail system 902, the counterweight 906 causes the passive elevator to raise the rail tile 900 back up to the horizontal shuttle grid 200 of the horizontal shuttle system 202.

Each active elevator 903 also includes a counterweight 906; however, it also includes an electromechanical drive 909 or actuator that raises and lowers a rail tile 900 between the horizontal rail system 202 and the second horizontal rail system 902. The primary purpose of the active elevators 903 is to raise loaded and unloaded shuttles 206 from the second horizontal rail system 902 up to the horizontal rail system 202.

As can be seen in FIGS. 38-41 of the drawings, the logistics tower formed in accordance with a second embodiment of the present invention includes a customer center 248 that is substantially the same as the customer center 248 and the components thereof described with respect to the first embodiment of the logistics tower 2. Additionally, the logistics tower 2 formed in accordance with a second embodiment of the present invention includes an unpacking station 960 that includes one or more actuated lifts 962 (e.g., hydraulic, pneumatic, etc.) that raise and lower pallets 964 of product 966 from the ground to the upward in proximity to the horizontal shuttle system 202. Furthermore, the logistics tower 2 formed in accordance with a second embodiment of the present invention includes one or more loading stations 968 comprising a plurality of loading docks 970.

Each loading dock 970 preferably includes a storage bin retainer 972, a conveyor belt 974, an articulating robotic arm 976, a storage bin elevator lift 978 and a passive elevator 904. The storage bin retainer 972 is situated above the conveyor belt 974 and stores a plurality of storage bins 16 that are selectively dropped to the conveyor belt 974 to process a new order. More specifically, when a new order is processed by the central control system 136, the order is routed to a particular loading dock 970. One or more storage bins 16 are dropped or lowered from the storage bin retainer 972 to the conveyor belt. The vertical retrieval system 20 of the logistics tower 2 retrieves storage bins from the vertical storage cell columns 418 containing the contents of the order. The storage bins are lowered to shuttles 206 on the horizontal shuttle grid 200 of the horizontal shuttle system 202. The shuttles 206 traverse the horizontal shuttle grid 200 of the horizontal shuttle system 202 to a passive elevator 904 situated at a respective loading dock 970. The passive elevator 904 lowers the shuttles 206 to the ground in proximity to and within the reach of the articulating robotic arm 976. The articulating robotic arm 976 retrieves the ordered product from the storage bins and transfers it to the storage bins 16 on the conveyor belt 974. A cart 980 or robotic cart constructed with substantially the same components of the shuttle 206 having a plurality of storage levels 982 is situated in proximity to the storage bin elevator lift 978. After the storage bins 16 are loaded by the articulating robotic arm 976, the conveyor belt 974 moves one of the storage bins 16 to the storage bin elevator lift 978. The storage bin elevator lift 978 raises or lowers the storage bin situated thereon to an appropriate height corresponding to an empty storage level 982 on the cart 980 so that the user can slide the storage bin 16 thereon. Once is the cart 980 is full, it can be transferred to a vehicle for transport to another location, such as a store or distributor.

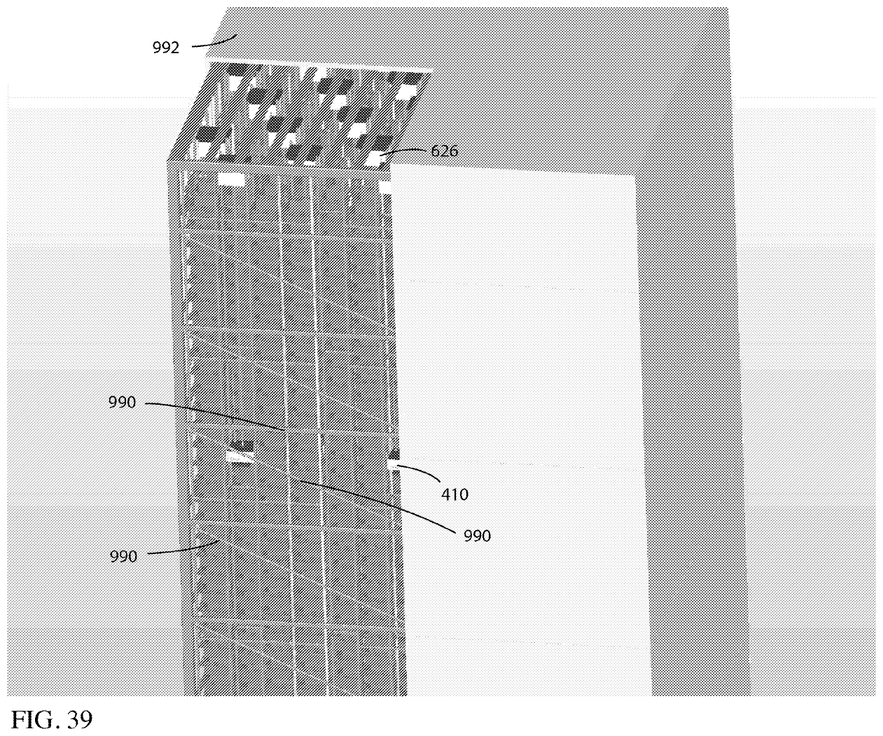

As can also be seen in FIGS. 38 and 39 of the drawings, the logistics tower 2 also includes an outer frame 990 that supports the arrangement of vertical storage cell columns 418. Furthermore, the outer frame 990 and vertical storage cell columns 418 situated therein may be enclosed by a housing or protective covering 992.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

1. A delivery drone comprising: an airframe;
a drive module joined to the airframe, the drive module having a housing, the housing of the drive module defining an internal cavity;
at least one storage module joined to one of the airframe and the drive module, the at least one storage module having a housing, the housing of the storage module defining an internal cavity;
at least one motor joined to the airframe,
at least one rotor operatively coupled to the at least one motor;
drive circuitry in electrical communication with the at least one motor;
at least one battery in electrical communication with the drive circuitry and the at least one motor; and
at least one computer in electrical communication with the drive circuitry, the at least one battery and the at least one motor;
wherein the drive circuitry, the at least one battery and the at least one computer are at least partially situated within the internal cavity of the drive module.

2. A delivery drone as defined by claim 1, wherein the airframe comprises:
an outer frame, the outer frame defining an interior portion of the airframe;
a central hub disposed in the interior portion of the airframe; and
at least two support arms, each support arm of the at least two support arms extending radially outwardly from the central hub to the outer frame and joining the central hub and the outer frame.

3. A delivery drone as defined by claim 2, wherein the at least two support arms and the outer frame together define a plurality of engine compartments;
wherein the at least one motor includes a plurality of motors; and
wherein each motor of the plurality of motors is at least partially situated in a respective engine compartment of the plurality of engine compartments.

4. A delivery drone as defined by claim 3, wherein the plurality of motors includes four motors;
wherein the at least two support arms include four support arms; wherein the plurality of engine compartments include four engine compartments, the four engine compartments being defined by the four support arms and the outer frame; and
wherein each motor of the four motors is at least partially situated in a respective engine compartment of the four engine compartments.

5. A delivery drone as defined by claim 1, wherein the airframe comprises:
a top side;
a bottom side disposed opposite the top side; and
at least one rotor guard, the at least one rotor guard being formed on at least one of the top side and the bottom side of the airframe and extending at least partially thereacross, the at least one rotor guard at least partially covering the at least one rotor of the at least one motor.

6. A delivery drone as defined by claim 1, which further comprises:
a docking hub situated on the airframe, the docking hub including a top end, a bottom end situated opposite the top end and a side wall extending between the top end and the bottom end.

7. A delivery drone as defined by claim 6, which further comprises:
a camera array situated on the docking hub, the camera array being in electrical communication with the at least one computer.

8. A delivery drone as defined by claim 7, wherein the camera array is situated on the side wall of the docking hub and extends at least partially thereon.

9. A delivery drone as defined by claim 6, wherein the docking hub further comprises:
a docking magnet situated on the top end thereof.

10. A delivery drone as defined by claim 6, wherein the docking hub further comprises:
a charging connector, the charging connector being in electrical communication with at least one of the at least one battery and the at least one computer, the charging connector being situated on the top end of the docking hub.

11. A delivery drone as defined by claim 1, wherein the at least one storage module further comprises:
a drawer, the drawer being received by an opening formed in the housing of the at least one storage module, the drawer being movable between an extended position, in which the drawer projects outwardly from the housing of the at least one storage module, and a retracted position, in which the drawer is fully received by the opening formed in the housing of the at least one storage module.

12. A delivery drone as defined by claim 11, wherein the drawer further comprises:
a closed bottom end, an open top end and a side wall extending therebetween, the closed bottom end, open top end and side wall defining an internal cavity; and
a door situated in the closed bottom end that is selectively movable between at least a first position and a second position, wherein in the first position, the door is open to the internal cavity defined by the housing of the at least one storage module, and wherein in the second position, the door is closed to the internal cavity defined by the housing of the at least one storage module.

13. A delivery drone as defined by claim 1, wherein the at least one storage module further comprises:
a drawer, the drawer being received by an opening formed in the housing of the at least one storage module and being removable therefrom.

14. A drone port comprising:
a delivery shaft, the delivery shaft having a top end, a bottom end disposed opposite the top end and a side wall extending between the top end and the bottom end, the side wall defining an internal cavity;
a drone docking platform situated at the top end of the delivery shaft, the drone docking platform having a top section, an oppositely disposed bottom section situated on the top end of the delivery shaft and a plurality of support legs, the support legs extending between and interconnecting the top section and the bottom section, the top section and the bottom section being separated from one another and defining a space therebetween into which a delivery drone may travel and dock, the bottom section having an opening formed therein that is in alignment and communication with the internal cavity of the delivery shaft; and
at least one delivery compartment situated at the bottom end of the delivery shaft.

15. A drone port as defined by claim 14, which further comprises:
a parcel lift system, the parcel lift system being at least partially situated in the internal cavity of the delivery shaft, the parcel lift system including a parcel retrieval platform and at least one actuator operatively coupled thereto to effect movement of the parcel retrieval platform in the internal cavity of the delivery shaft;
wherein the parcel retrieval platform is selectively movable by the at least one actuator in the internal cavity of the delivery shaft between the at least one delivery compartment and the drone docking platform.

16. A drone port as defined by claim 14, wherein the delivery shaft forms a portion of a commercial or residential structure having a roof and an interior space, the delivery shaft at least partially extending through the roof of the commercial or residential structure and into the interior space thereof, wherein the drone docking platform is situated above the roof, and wherein the at least one delivery compartment is situated within the interior space of the residential or commercial structure.

17. A drone port as defined by claim 14, wherein the delivery shaft is situated in proximity to a commercial or residential structure having a side wall and an opening formed through the side wall and an interior space, the delivery shaft being mounted to the side wall of the residential or commercial structure, wherein the delivery compartment is formed as a cutout through the thickness of the side wall of the delivery shaft in proximity to the bottom end thereof, wherein the cutout is aligned with the opening formed through the side wall of the residential or commercial structure such that the internal cavity of the delivery shaft is in communication with the interior space of the residential or commercial structure.

18.-23. (canceled)

24. A logistics tower comprising:
at least one vertical storage cell column having a first end and an oppositely disposed second end, the at least one vertical storage cell column including a plurality of storage modules and an elevator shaft, the elevator shaft extending through the at least one vertical storage cell column between the first and second ends thereof, each storage module of the plurality of storage modules being situated adjacent to the elevator shaft;
at least one vertical retrieval system, the at least one vertical retrieval system including a primary winch and a robotic bin handler, the primary winch being in operative communication with the robotic bin handler to effect vertical movement of the robotic bin handler in the elevator shaft of the at least one vertical storage cell column;
at least a first horizontal shuttle system, the first horizontal shuttle system including a horizontal shuttle grid, the first horizontal shuttle system being situated below the at least one vertical storage cell column and the at least one vertical retrieval system; and
at least one tower drone port for facilitating entry of one or more delivery drones into the elevator shaft of the logistics tower, the at least one tower drone port being mounted to the elevator shaft.

25. (canceled)

26. A delivery drone system for transporting goods between locations, which comprises:
at least one delivery drone, the at least one delivery drone having an airframe; a drive module joined to the airframe, the drive module having a housing, the housing of the drive module defining an internal cavity; at least one storage module joined to one of the airframe and the drive module, the storage module having a housing, the housing of the at least one storage module defining an internal cavity; at least one motor joined to the airframe; at least one rotor operatively coupled to the at least one motor; drive circuitry in electrical communication with the at least one motor; at least one battery in electrical communication with the drive circuitry and the at least one motor; and at least one computer in electrical communication with the drive circuitry, the at least one battery and the at least one motor, wherein the drive circuitry, the at least one battery and the at least one computer are at least partially situated within the internal cavity of the drive module;
at least one drone port, the at least one drone port including a delivery shaft, the delivery shaft having a top end, a bottom end disposed opposite the top end and a side wall extending between the top end and the bottom end, the side wall defining an internal cavity; a drone docking platform situated at the top end of the delivery shaft, the drone docking platform having a top section, an oppositely disposed bottom section situated on the top end of the delivery shaft and a plurality of support legs, the plurality of support legs extending between and interconnecting the top section and the bottom section, the top section and the bottom section being separated from one another and defining a space therebetween into which the at least one delivery drone may travel and dock, the bottom section having an opening formed therein that is in alignment and communication with the internal cavity of the delivery shaft; and at least one delivery compartment situated at the bottom end of the delivery shaft; and
at least one logistics tower, the at one logistics tower having:
at least one vertical storage cell column having a first end and an oppositely disposed second end, the at least one vertical storage cell column including a plurality of storage modules and an elevator shaft, the elevator shaft extending through the at least one vertical storage cell column between the first and second ends thereof, each storage module of the plurality of storage modules being situated adjacent to the elevator shaft;
at least one vertical retrieval system, the at least one vertical retrieval system including a primary winch and a robotic bin handler, the primary winch being in operative communication with the robotic bin handler to effect vertical movement of the robotic bin handler in the elevator shaft of the at least one vertical storage cell column;
at least a first horizontal shuttle system, the first horizontal shuttle system including a horizontal shuttle grid, the first horizontal shuttle system being situated below the at least one vertical storage cell column and the at least one vertical retrieval system;
and at least one tower drone port for facilitating entry of the at least one delivery drone into the elevator shaft of the logistics tower, the at least one tower drone port being mounted to the elevator shaft;
wherein the at least one drone port is situated at a residential or commercial property; and
wherein the at least one delivery drone is selectively navigable between and dockable with the at least one drone port and the at least one logistics tower.

27. (canceled)
